(19) United States
(12) Patent Application Publication
(10) Pub. No.: US 2006/0173693 A1
(43) Pub. Date: Aug. 3, 2006

(54) Computerized trading system and methods useful therefor

(76) Inventors: Matan Arazi, Los Angeles, CA (US); Guy Setton, London (GB)

Correspondence Address: DARBY & DARBY P.C., P. O. BOX 5257, NEW YORK, NY, 10150-5257, US

(21) Appl. No.: 10/510,669

(22) PCT Filed: Apr. 8, 2003
(86) PCT No.: PCT/IL03/00296

§ 371 Date: Nov. 28, 2005

Related U.S. Application Data
(60) Provisional application No. 60/371,454, filed on Apr. 9, 2002.

(51) Int. Cl. G06Q 99/00; G06Q 10/00

(52) U.S. Cl. 705/1; 705/2

(57) ABSTRACT

A computerized trading system including a price information cache including a multiplicity of price information items originating from more than one transaction queries posed by more than one trader from among a population of traders, each of the price information items having a cached life cycle, and a trading query processor operative to receive trading queries from the population of traders and to employ the price information cache in responding thereto.

### REFERENCE TO CO-PENDING APPLICATION

This application claims priority from U.S. Provisional Patent Application Ser. No. 60/371,454, filed Apr. 9, 2002 and entitled MERCALINK SOFTWARE REQUIREMENTS SPECIFICATION.

### FIELD OF THE INVENTION

The present invention relates to apparatus and methods for computerized trading.

### BACKGROUND OF THE INVENTION

Computerized trading systems and related technologies are described at the following World Wide Web addresses:

Research.ibm.com/absolute/ and omg.org/docs/formal/00-05-02.pdf

The disclosures of all publications mentioned in the specification and of the publications cited therein are hereby incorporated by reference.

### SUMMARY OF THE INVENTION

The present invention seeks to provide improved apparatus and methods for computerized trading.

The present specification and claims use the following terminology:

| Term | Definition |
|---|---|
| Trader | One who is in business of buying and selling |
| | commodities (goods) for profit, or the exchange |
| | of one commodity for another. |
| General Trading | A business enterprise of traders. There are two |
| Companies | main types of general trading companies: those |
| | who sell goods on their own account and those |
| | who arrange sales and purchases for others for |
| | a commission or fee. They trade in all markets |
| | whether it is for raw materials and manufactured |
| | goods, durable or non-durable, consumer or non- |
| | consumer items. |
| Counterparty | A general trading company engages with other |
| | business enterprises in the regular course of |
| | its business, including its suppliers, customers |
| | and other service providers such as finance |
| | institutions, insurance companies and shipping |
| | operations. |
| Request | When a trader or counterparty expresses a desire |
| | and/or an interest to engage in business. |
| Offer | When a trader or counterparty puts forward a |
| | proposal for a deal and waits for its rejection |
| | or acceptance. |
| Transaction/ | An agreement between two or more parties, |
| Contract | especially one that is written and enforceable |
| | by law. |
| Long Position | When a trader purchases goods for storage to |
| | sell at a later date for a greater profit. |
| Short Position | When a trader sells goods that he/she does not |
| | own yet but expects to obtain them at a later |
| | date for a lower price than what is achievable |
| | in the present. He/she has sold a contract to |
| | establish a market position and has not yet |
| | closed out this position through an offsetting |
| | purchase; the opposite of a long position. |
| Pricing Chain | A computation sheet which the trader uses to |
| | estimate his/her cost of sales, pricing and |
| | profit/loss. |
| Call-off | Exercising a contract by ordering goods which |
| (inbound/ | have been bought or sold and allocated to the |
| outbound) | contract awaiting delivery |
| Claims | When a trader or counterparty declares that |
| | there is a noncompliance issue with a contract |
| | due to some fault with the goods that have |
| | been delivered or any other problem with the |
| | fulfillment of the deal, which is in conflict |
| | with the agreement's terms and conditions. |
| Market Price | The last reported/known price at which a |
| | commodity was traded. |
| Validity Term | The conditions and timeframe under which an |
| (Subject to | offer is effective and, if valid until a |
| final confir- | specific date and time, then legally enforce- |
| mation or Valid | able as well. |
| Until dd/mm/yy | |
| hh:mm) | |
| INCO Terms | To provide a common terminology for inter- |
| | national shipping and trading, to minimize |
| | misunderstandings, the International Chamber |
| | of Commerce developed a set of terms, known |
| | as INCO terms. The purpose of INCO terms is |
| | to provide a set of international rules for |
| | the interpretation of the most commonly used |
| | trade terms in foreign trade. Thus, the |
| | uncertainties of different interpretations of |
| | such terms in different countries can be |
| | avoided or at least reduced to a considerable |
| | degree. The scope of INCO terms is limited to |
| | matters relating to the rights and obligations |
| | of the parties to the contract of sale with |
| | respect to the delivery of goods. INCO terms |
| | deal with a number of identified obligations |
| | imposed on the parties and the distribution of |
| | risk between the parties. In total 13 INCO |
| | terms have been defined which are grouped into |
| | four basically different categories, applicable |
| | for sea and inland waterway transport or for |
| | all modes of transport. |
| Product Grade | A widely accepted quality classification of a |
| | product by the market to minimize misunder- |
| | standings between parties and match expectations. |
| ETA/ETD | Estimated Time of Arrival - when goods purchased |
| | or sold are expected to arrive at a target des- |
| | tination; Estimated Time of Departure - when |
| | goods purchase or sold are expected to be shipped |
| | to a target destination. |
| Forex | Foreign exchange currencies. |
| Stop Status | When a general trading company has restricted |
| | trading with a counterparty for any number of |
| | reasons such as a failure to pay outstanding |
| | debts, a fear that it is on the verge of bank- |
| | ruptcy, or an unresolved legal dispute. |

There is thus provided in accordance with a preferred embodiment of the present invention a computerized trading system including a price information cache including a multiplicity of price information items originating from more than one transaction queries posed by more than one trader from among a population of traders, each of the price information items having a cached life cycle, and a trading query processor operative to receive trading queries from the population of traders and to employ the price information cache in responding thereto.

In accordance with another preferred embodiment of the present invention, the trading query processor is operative to send subqueries which relate to price information items not available in the price information cache.

Preferably, the cached life cycle includes an indication of time-points defining at least one time periods. Additionally, the cached life cycle includes an indication of time-points defining a plurality of time periods.

In accordance with yet another preferred embodiment of the present invention the at least one cached life cycle includes a cached time period in which an associated price information item is valid, a cached time period in which an associated price information is invalid and a cached time period in which an associated price information may be valid and may not be valid.

There is further provided in accordance with yet another preferred embodiment of the present invention a computerized trading system including a price information cache including a multiplicity of price information items originating from more than one transaction queries posed by more than one trader from among a population of traders and a trading query processor operative to receive trading queries from the population of traders and to process the trading queries not necessarily in FIFO order in order to enhance the efficiency of responding thereto.

Preferably, similar trading queries are grouped together. Alternatively or additionally, the trading queries include at least one query to a human-operated workstation. Additionally or alternatively, the trading queries include at least one query to an automatic computer-based information provider.

There is yet further provided in accordance with still another preferred embodiment of the present invention a computerized trading system including a shared price information cache subsystem including a multiplicity of price information items originating from more than one transaction queries posed by more than one trader from among a population of competing traders and a shared price information updating subsystem operative to update the shared price information cache subsystem based on information received in the context of a query and similarities between that query and other queries.

There is even further provided in accordance with another preferred embodiment of the present invention a computerized trading system including a price information cache including a multiplicity of price information items originating from more than one transaction queries posed by more than one trader from among a population of traders and a trading query processor operative to receive trading queries from the population of traders and to employ the price information cache in responding thereto, the trading query processor employing inquiry templates built on earlier inquiries and information received in response thereto.

Preferably, the templates are selected based on similarities between inquiry templates built on earlier inquiries and a current inquiry. Additionally, templates are displayed in an order depending on extent of similarity to a current inquiry.

In accordance with another preferred embodiment of the present invention the trading query processor is operative to identify in the inquiry templates built on earlier inquiries, information irrelevant to the current inquiry, to generate a reproduction of the inquiry template and to delete therefrom the information.

There is also provided in accordance with yet another preferred embodiment of the present invention a computerized transaction analysis method including accessing at least one relevant previous transaction, wherein relevance is a function of at least one user-defined parameter defining a proposed transaction, analyzing at least one parameter of the at least one relevant previous transaction, the at least one parameter being selected to match the at least one user-defined parameter and generating at least one recommendations for the proposed transaction including an evaluation of the suitability of each of the at least one recommendations in view of at least one user-defined parameter.

Preferably, the step of generating includes generating at least one recommendation by combining a plurality of relevant previous transactions. Alternatively or additionally, the step of generating includes adjusting for at least one parameter external to all relevant previous transactions under consideration.

There is further provided in accordance with still another preferred embodiment of the present invention a computerized trading system including a price information cache including a multiplicity of price information items originating from more than one transaction queries posed by more than one trader from among a population of traders, each of the price information items having a cached life cycle and a trading query processor operative to receive trading queries from the population of traders including accessing the price information cache to respond as fully as possible to each trading query and sending out subqueries which relate to price information items not present in the price information cache.

There is even further provided in accordance with another preferred embodiment of the present invention a computerized trading system including a price information cache including a multiplicity of price information items originating from more than one transaction queries posed by more than one trader from among a population of traders and a trading query processor operative to receive a sequence of trading queries from the population of traders and to amalgamate at least one pair of queries from among the sequence of trading queries in order to enhance the efficiency of responding thereto.

There is still further provided in accordance with yet another preferred embodiment of the present invention a computerized trading method including providing a price information cache including a multiplicity of price information items originating from more than one transaction queries posed by more than one trader from among a population of traders, each of the price information items having a cached life cycle, receiving trading queries from the population of traders and employing the price information cache in responding to the trading queries received.

There is also provided in accordance with another preferred embodiment of the present invention a computerized trading method including providing a price information cache including a multiplicity of price information items originating from more than one transaction queries posed by more than one trader from among a population of traders, receiving trading queries from the population of traders and processing the trading queries received not necessarily in FIFO order in order to enhance the efficiency of responding thereto.

There is further provided in accordance with yet another preferred embodiment of the present invention a computerized trading method including providing a shared price information cache subsystem including a multiplicity of price information items originating from more than one transaction queries posed by more than one trader from among a population of competing traders and updating the shared price information cache subsystem based on information received in the context of a query and similarities between that query and other queries.

There is even further provided in accordance with still another preferred embodiment of the present invention a computerized trading method including providing a price information cache including a multiplicity of price information items originating from more than one transaction queries posed by more than one trader from among a population of traders, receiving trading queries from the population of traders, employing the price information cache in responding to the trading queries received and employing inquiry templates built on earlier inquiries and information received in response to the trading queries received.

There is yet further provided in accordance with another preferred embodiment of the present invention a computerized transaction analysis system including a processor operative to access at least one relevant previous transaction, wherein relevance is a function of at least one user-defined parameter defining a proposed transaction and a transaction analyzer operative to analyze at least one parameter of the at least one relevant previous transaction, the at least one parameter being selected to match the at least one user-defined parameter and to generate at least one recommendations for the proposed transaction including an evaluation of the suitability of each of the at least one recommendations in view of at least one user-defined parameter.

There is still further provided in accordance with yet another preferred embodiment of the present invention a computerized trading method including providing a price information cache including a multiplicity of price information items originating from more than one transaction queries posed by more than one trader from among a population of traders, each of the price information items having a cached life cycle, receiving trading queries from the population of traders, accessing the price information cache to respond as fully as possible to each trading query and sending out subqueries which relate to price information items not present in the price information cache.

There is also provided in accordance with still another preferred embodiment of the present invention a computerized trading method including providing a price information cache including a multiplicity of price information items originating from more than one transaction queries posed by more than one trader from among a population of traders, receiving a sequence of trading queries from the population of traders and amalgamating at least one pair of queries from among the sequence of trading queries in order to enhance the efficiency of responding thereto.

The price information cache may for example include Tables L VIII and XIV. The price information items having cached life cycles may comprise ProductID, BasePrice and ComputedPrice in Table I; ProdID, ProdMarketPrice and ProdAveragePrice in Table VIII and ProdID, Quantity and CurrentStockPrice in Table XIV. All of the above may be referenced by the price information cache by means of a pointer to the actual location of the data item, which is queried by “Computation Handlers” of type “TABLE LOOKUP”. The pointer is stored in the data record for each type of item cached, e.g. the Parameter field of Table XX.

The trading query processor may for example comprise the PRICING CHAIN BUILDER 3000, which may for example be queried by the TRANSACTION BUILDER as well, particularly in the process of generating recommendations, when the recommendations are accepted as transactions by the user.

### BRIEF DESCRIPTION OF THE DRAWINGS

The present invention will be understood and appreciated from the following detailed description, taken in conjunction with the drawings in which:

FIG. 1 is a simplified functional block diagram of a commodity trading system constructed and operative in accordance with a preferred embodiment of the present invention;

FIG. 2 is a simplified flowchart illustration of a preferred method of operation for the queue manager 1000 of FIG. 1;

FIG. 3 is a simplified flowchart illustration of a preferred method for implementing step 1004 of FIG. 2;

FIG. 4 is a simplified flowchart illustration of a preferred method for implementing step 1010 of FIG. 3;

FIG. 5 is a simplified flowchart illustration of a preferred method for implementing step 1024 of FIG. 4;

FIG. 6 is a simplified flowchart illustration of a preferred method for implementing step 1011 of FIG. 3;

FIG. 7 is a simplified flowchart illustration of a preferred method for implementing step 1041 of FIG. 6;

FIG. 8 is a simplified flowchart illustration of a preferred method for implementing step 1044 of FIG. 6;

FIG. 9 is a simplified flowchart illustration of a preferred method for implementing step 1012 of FIG. 3;

FIG. 10 is a simplified flowchart illustration of a preferred method for implementing step 1071 of FIG. 9;

FIG. 11 is a simplified flowchart illustration of a preferred method for implementing step 1013 of FIG. 3;

FIG. 12 is a simplified flowchart illustration of a preferred process for user-triggered or periodic resorting and amalgamation of a selected queue in the queue manager 1000 of FIG. 1;

FIG. 13 is a simplified flowchart illustration of a preferred method for implementing step 1003 of FIG. 2;

FIG. 14 is a simplified flowchart illustration of a preferred method for implementing step 1136 of FIG. 13;

FIG. 15 is a diagram of a full cycle of operations by which the queue manager 1000 determines the various dependencies of items within a queue;

FIG. 16 is a simplified flowchart illustration of a preferred method of operation for the physical commodity transaction builder 2000 of FIG. 1;

FIG. 17 is a simplified flowchart illustration of a preferred method for implementing step 2001 of FIG. 16;

FIG. 18 is a simplified flowchart illustration of a preferred method for implementing step 2010 of FIG. 17;

FIG. 19 is a simplified flowchart illustration of a preferred method for implementing step 2020 of FIG. 18;

FIG. 20 is a simplified flowchart illustration of a preferred method for implementing step 2021 of FIG. 18;

FIG. 21 is a simplified flowchart illustration of a preferred method for implementing step 2023 of FIG. 18;

FIG. 22 is a simplified flowchart illustration of a preferred method for implementing step 2061 of FIG. 21;

FIG. 23 is a simplified flowchart illustration of a preferred method for implementing step 2062 of FIG. 21;

FIG. 24 is a simplified flowchart illustration of a preferred method for implementing step 2093 of FIG. 23;

FIG. 25 is a simplified flowchart illustration of a preferred method for implementing step 2092 of FIG. 23;

FIG. 26 is a simplified flowchart illustration of a preferred method for implementing step 2116 of FIG. 25;

FIG. 27 is a simplified flowchart illustration of a preferred method for implementing step 2063 of FIG. 21;

FIG. 28 is a simplified flowchart illustration of a preferred method for implementing step 2065 of FIG. 21;

FIG. 29 is a simplified flowchart illustration of a preferred method of operation for the price chain builder 3000 of FIG. 1;

FIG. 30 is a simplified flowchart illustration of a preferred method for implementing step 3003 of FIG. 29;

FIG. 31 is a simplified flowchart illustration of a preferred method for implementing step 3012 of FIG. 30;

FIG. 32 is a simplified flowchart illustration of a preferred method for implementing step 3013 of FIG. 30;

FIG. 33 is a simplified flowchart illustration of a preferred method for implementing step 3014 of FIG. 30;

FIG. 34 is a simplified flowchart illustration of a preferred method for implementing step 3044 of FIG. 33;

FIG. 35 is a simplified flowchart illustration of a preferred method for implementing step 3045 of FIG. 33;

FIG. 36 is a simplified flowchart illustration of a preferred method for implementing step 3041 of FIG. 33;

FIG. 37 is a simplified flowchart illustration of a preferred method for implementing step 3055 of FIG. 34;

FIG. 38 is a simplified flowchart illustration of a preferred method for implementing step 3058 of FIG. 34;

FIG. 39 is a simplified flowchart illustration of a preferred method of operation for the notification handler 4000 of FIG. 1;

FIG. 40 is a simplified flowchart illustration of a preferred method for implementing step 4001 of FIG. 39;

FIG. 41 is a simplified flowchart illustration of a preferred method for implementing step 4011 of FIG. 40;

FIG. 42 is a simplified flowchart illustration of a preferred method for implementing step 4015 of FIG. 40;

FIG. 43 is a simplified flowchart illustration of a preferred method for implementing step 4016 of FIG. 40;

FIG. 44 is a simplified flowchart illustration of a preferred method of operation of the data expiration handler 5000 of FIG. 1, depicting the operations executed when the expiration criteria for a data element is queried or updated;

FIG. 45 is a simplified flowchart illustration of a preferred method for implementing step 5001 of FIG. 44 in which a potentially expired data element is queried;

FIG. 46 is a simplified flowchart illustration of a preferred method for implementing step 5011 of FIG. 45;

FIG. 47 is a simplified flowchart illustration of a preferred method for implementing step 5016 of FIG. 45;

FIG. 48 is a simplified flowchart illustration of a preferred method for implementing step 5003 of FIG. 44;

FIG. 49 is a simplified screenshot depicting a possible display presented to a user in step 3026 of FIG. 31, showing a sorted list of pricing chains that are similar to selected parameters;

FIG. 50 is a simplified screenshot depicting a possible display presented to a user in step 3036 of FIG. 31, showing all processors currently attached to a first example of a pricing chain, with the values of each processor;

FIG. 51 is a simplified screenshot depicting a possible display presented to a user in step 3036 of FIG. 31, showing all processors currently attached to a second example of a pricing chain, with the values of each processor;

FIG. 52 is a simplified screenshot depicting a possible display presented to a user in step 3036 of FIG. 31, showing all processors currently attached to a third example of a pricing chain, with the values of each processor;

FIG. 53 is a simplified screenshot depicting a possible display of information regarding a transaction as handled by an external application such as Microsoft Great Plains or SAP, wherein the information may be used to seed the transaction table;

FIG. 54 is a simplified screenshot depicting a possible display presented to a user in step 1001 of FIG. 2, showing all queue items currently existing in a selected queue and allowing a user, or other process, to select a desired queue item in order to perform a selected action;

FIG. 55 is a simplified screenshot depicting a possible display presented to a user in step 1003 of FIG. 2, showing a queue item with a user prompt for action on the queue item;

FIG. 56 is a simplified screenshot depicting a possible display presented to a user in step 2020 of FIG. 18, showing possible parameters pertaining to a recommendation request for which the user may set a desired weighting;

FIG. 57 is a simplified screenshot depicting a possible display presented to a user in step 2024 of FIG. 18, showing possible outcomes of a recommendation process and allowing a user to accept, recompute, or reject the system's recommendations;

FIG. 58 is a simplified screenshot depicting a possible display presented to a user in step 1001 of FIG. 2, showing all queue items currently existing in a selected queue before the amalgamation process of FIG. 9 has been executed;

FIG. 59 is a simplified screenshot depicting a possible display presented to a user during the amalgamation process of FIG. 9;

FIG. 60 is a simplified screenshot depicting a possible display presented to a user during the amalgamation process of FIG. 9;

FIG. 61 is a simplified screenshot depicting a possible display presented to a user after the amalgamation process of FIG. 9 has been executed;

FIG. 62 is a simplified screenshot depicting a possible display of database fields pertaining to the definitions of users in the Users Table, Table II of the database 200;

FIG. 63 is a simplified screenshot depicting a possible display presented to a user by an external application such as Microsoft SQL Server Enterprise Manager allowing the user to edit values of a selected record within a selected table of a selected database;

FIGS. 64A-64E, taken together, are a pictorial illustration of a trader using a computerized trading system constructed and operative in accordance with a preferred embodiment of the present invention in which price information items including expiry information therewithin are automatically converted into a system format for storage in the system;

FIG. 65A is a pictorial illustration of four transactions stored in a computerized trading system constructed and operative in accordance with a preferred embodiment of the present invention, the transactions being in various states of implementation;

FIG. 65B is a pictorial illustration of an event, affecting three of the four transactions in FIG. 65A;

FIG. 65C is a pictorial illustration showing the effect of the event of FIG. 65B on the transactions of FIG. 65A, as automatically implemented by the computerized trading system storing the transactions of FIG. 65A;

FIG. 66 is a pictorial illustration of traders and facilitative information providing departments, which may interact via a computerized trading system constructed and operative in accordance with a preferred embodiment of the present invention;

FIG. 67A is a pictorial illustration of email messages being generated by a first trader, Ann, in FIG. 66;

FIG. 67B is a pictorial illustration of email messages being generated by a second trader, Bill, in FIG. 66;

FIG. 67C is a pictorial illustration of email messages being generated by a third trader, Carrie, in FIG. 66;

FIG. 67D is a pictorial illustration of email messages being generated by a fourth trader, Dave, in FIG. 66;

FIG. 68A is a pictorial illustration of a computerized email queue generated from those email messages in FIGS. 67A-67D which are addressed to the logistics department in FIG. 66;

FIG. 68B is a pictorial illustration of a computerized email queue generated from those email messages in FIGS. 67A-67D which are addressed to the shipping and handling department in FIG. 66;

FIG. 69A is a pictorial illustration of the computerized email queue of FIG. 68A, resorted and amalgamated; and

FIG. 69B is a pictorial illustration of the computerized email queue of FIG. 68B, resorted and amalgamated.

### DETAILED DESCRIPTION OF PREFERRED EMBODIMENTS

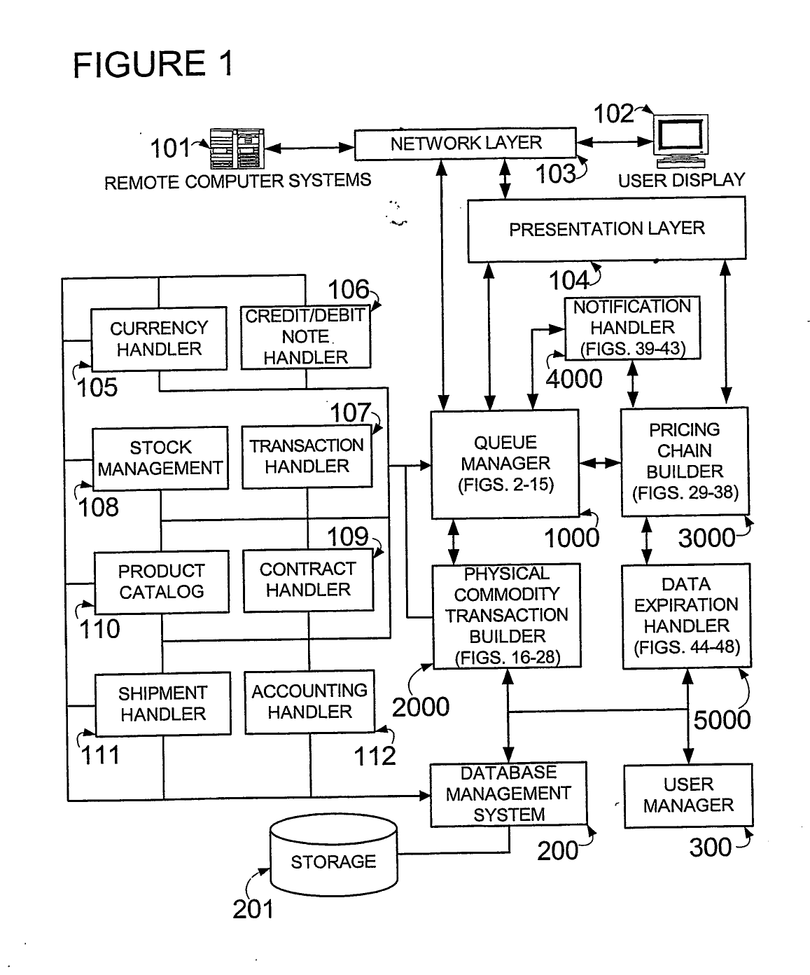

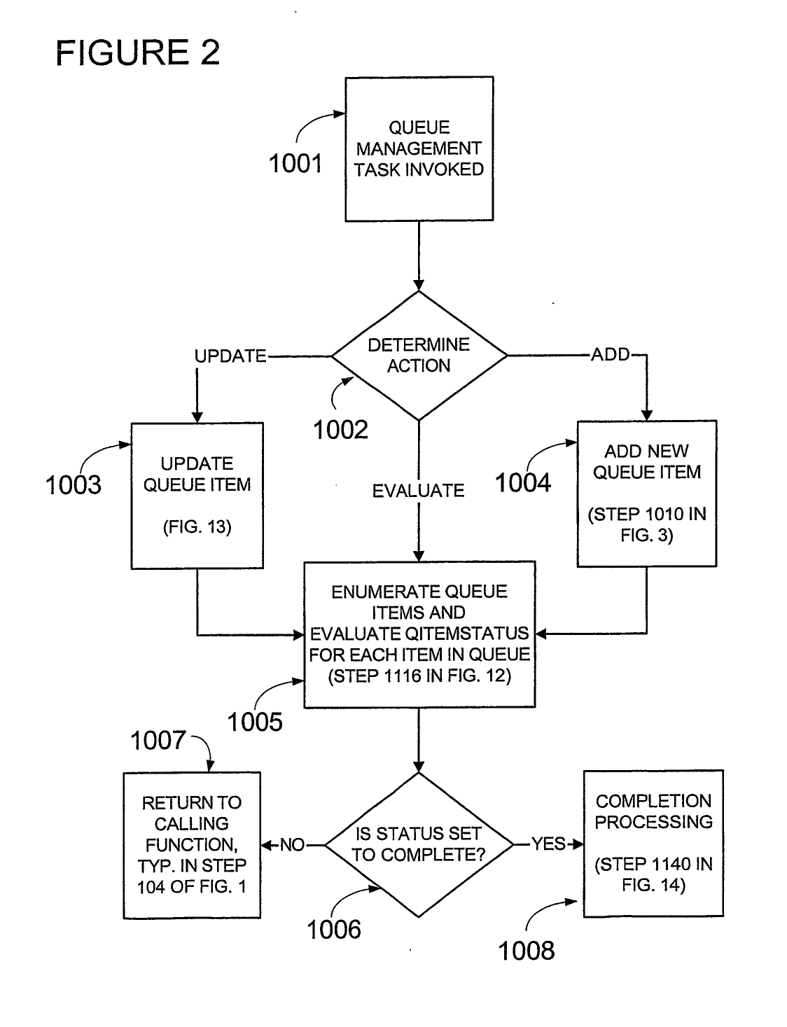

Reference is now made to FIG. 1, which is a simplified functional block diagram of a commodity trading system constructed and operative in accordance with a preferred embodiment of the present invention.

As seen in FIG. 1, the commodity trading system is embodied in a commodity trading software tool. The commodity trading system includes a plurality of computer systems 101 connected via a computer networking protocol (such as TCP/IP). Computer systems 101 may be a remote computer system.

A user typically accesses the commodity trading system through a local computer system, which includes a user display 102. The user's local computer system is connected to the commodity trading system via a network layer 103 including a computerized data transportation mechanism, such as TCP/IP or a local data bus. The commodity trading system also preferably includes a presentation layer 104, such as HTML, typically executed within a program contained within an operating system, such as Web Server, that interfaces with the network layer, trading system's components, and database.

The commodity trading system preferably includes a currency handler 105, which preferably handles foreign currency exchanges and bookings. A preferred embodiment of currency handler 105 is that implemented by the LV Purchase Ledger, produced by Lakeview Computers plc, Banks House, Banks Lane, Bexleyheath, Kent DA6 7BH, United Kingdom.

The commodity trading system preferably includes a credit and debit note handler 106, which preferably handles the issuance and fulfillment of credit and debit notes. A preferred embodiment of credit and debit note handler 106 is that implemented by the LV Sales Ledger, produced by Lakeview Computers plc, Banks House, Banks Lane, Bexleyheath, Kent DA6 7BH, United Kingdom.

In accordance with a preferred embodiment of the present invention, the commodity trading system also includes a transaction handler 107, which preferably handles communications of offers and requests, such as that implemented by the Contract Administration module produced by Kit Software Ltd, Tay House, Riverview Business Park, Friarton Road, Perth PH2 8DG, United Kingdom.

The commodity trading system also preferably includes a stock management module 108, for tracking stock levels, such as that implemented by the LV Stock Control module, produced by Lakeview Computers plc, Banks House, Banks Lane, Bexleyheath, Kent DA6 7BH, United Kingdom.

The commodity trading system further includes a contract handler 109, for handling and tracking contracts. A preferred embodiment of contract handler 109 is that implemented by the Contract Execution module, produced by Kit Software Ltd, Tay House, Riverview Business Park, Friarton Road, Perth PH2 8DG, United Kingdom.

In accordance with a preferred embodiment of the present invention, the commodity trading system also includes a product catalog 110, for tracking the various products available for buy or sell orders, such as that implemented by the LV Stock Control module, produced by Lakeview Computers plc, Banks House, Banks Lane, Bexleyheath, Kent DA6 7BH, United Kingdom.

The commodity trading system also preferably includes a shipment handler 111 for tracking incoming and outgoing shipments. A preferred embodiment of shipment handler 111 is that implemented by the LV Stock Control module, produced by Lakeview Computers plc, Banks House, Banks Lane, Bexleyheath, Kent DA6 7BH, United Kingdom.

The commodity trading system also preferably includes an accounting handler 112 comprising a general ledger for financial accounting, such as that implemented by the LV Nominal Ledger module, produced by Lakeview Computers plc, Banks House, Banks Lane, Bexleyheath, Kent DA6 7BH, United Kingdom.

In accordance with a preferred embodiment of the present invention the commodity trading system also preferably includes a database management system 200, preferably Oracle 8i produced by Oracle Corporation, 500 Oracle Parkway, Redwood Shores Calif. 94065, United States of America.

The commodity trading system also includes a storage device 201, typically a magnetic hard disk drive. Storage device 201 holds tables suitable for implementing the methods and apparatus described herein. Storage device 201 may hold the following Tables I-XXXIV:

Table I holds information about the transactions in the system.

TABLE I
Transaction Table

| Field Name | Field Type | Field Description |
|---|---|---|
| TranID | Number | Unique transaction ID |
| TranType | Number | Transaction Type, 1 = Buy, 2 = Sell |
| TranOwner | Number | User or Role ID owning transaction |
| ProductGroupID | Number | Reference to Product Group ID |
| ProductID | Number | Reference to Product ID |
| Quantity | Number | Product Quantity |
| UOM_ID | Number | Reference to UnitID |
| IncoTerm | Text | INCO Term of Transaction |
| IncoTermLocation | Text | INCO Location of Transaction |
| BasePrice | Number | Base Price of Transaction |
| CurrencyID | Number | Reference to CurrencyID |
| ComputedPrice | Number | Result of Pricing Chain computation |
| ChainStatus | Number | Status of Pricing Chain; 0 = none, |
| | | 1 = incomplete, 2 = complete |
| CounterPartyID | Number | Reference to CounterPartyID |
| ShipmentID | Number | Reference to ShipmentID |
| StorageID | Number | Reference to StorageID |
| TransactionStatus | Number | Status of Transaction, 0 = Started, |
| | | 1 = in progress, 2 = complete, |
| | | 3 = withdrawn |
| CreateDate | Date/Time | Transaction creation date |
| UpdateDate | Date/Time | Transaction update date |

Table II holds information about the users that access the system.

TABLE II
Users

| Field Name | Field Type | Field Description |
|---|---|---|
| UserID | Number | Unique User ID |
| UserName | Text | Name of User |

Table III holds information about the link (mapping) of Users to Notification Types.

TABLE III
User Notifications Map

| Field Name | Field Type | Field Description |
|---|---|---|
| UserID | Number | Reference to UserID |
| NotificationTypeID | Number | Reference to DeliveryTypeID |
| NotificationTypeValue | Text | Value of notification type, e.g. email |
| | | address, cell phone number, etc. |
| NotificationPriority | Number | Priority or preference number of |
| | | Notification type for this user |

Table IV contains information about the various kinds of notifications that are supported by the system.

TABLE IV
Notification Types

| Field Name | Field Type | Field Description |
|---|---|---|
| NotificationTypeID | Number | Unique ID of notification type |
| Notification Title | Text | Text of title of notification |
| AssignedRole | Number | Reference to user or role ID that is |
| | | to receive this type of notification |

Table V contains the actual data for the notifications that exist in the system.

TABLE V
Notifications

| Field Name | Field Type | Field Description |
|---|---|---|
| NotificationID | Number | Unique Notification ID |
| NotificationTypeID | Number | Reference to NotificationType |
| CreateDate | Date/Time | Time and date when notification was |
| | | created |
| AssignedRole | Number | Role ID that is assigned to handle |
| | | notifications of this type |
| UpdateDate | Date/Time | Time and date when notification was |
| | | last updates |
| QueueID | Number | Reference to QueueID where |
| | | notification shall be inserted |

Table VI holds information about the various roles of users that exist in the system.

TABLE VI
Roles

| Field Name | Field Type | Field Description |
|---|---|---|
| RoleID | Number | Unique Role ID |
| RoleName | Text | Name of Role |

Table VII contains the link (mapping) of which users belong to which role.

TABLE VII
Role Users Map

| Field Name | Field Type | Field Description |
|---|---|---|
| RoleID | Number | Reference to RoleID |
| UserID | Number | Reference to UserID |

Table VIII contains information about the various products that exist in the system.

TABLE VIII
Products

| Field Name | Field Type | Field Description |
|---|---|---|
| ProdID | Number | Unique Product ID |
| ProdName | Text | Name of Product |
| ProdDescription | Text | Description of Product |
| ProdMarketPrice | Number | Current Market Price of Product |
| ProdAveragePrice | Number | Average price per UOM of all stocks |
| | | of this product |
| ProdQtyLevel | Number | Total quantity of all stocks of this |
| | | product |

Table IX contains information about the product groups that exist in the system. Similar products are grouped together into product groups and share certain attributes.

TABLE IX
Product Group

| Field Name | Field Type | Field Description |
|---|---|---|
| ProdGrpID | Number | Unique Product Group ID |
| ProdGrpName | Text | Name of Product Group |
| ProdGrpUOM | Number | Reference to Unit of Measure ID |

Table X contains the definition of the various Units of Measure used in the system.

TABLE X
UOMS

| Field Name | Field Type | Field Description |
|---|---|---|
| UnitID | Number | Unique Unit of Measure ID |
| UnitName | Text | Unit of measure name |
| UnitBase | Number | Reference to Unit of Measure ID |
| BaseUnitMultiplier | Number | Multiplier of Base Unit |

Table XI contains definitions of the various currencies that are used in the system.

TABLE XI
Currency

| Field Name | Field Type | Field Description |
|---|---|---|
| CurrencyID | Number | Unique Currency ID |
| CurrencyName | Text | Currency Name |
| CurrencyConversionRate | Number | Currency Exchange rate to base |
| | | currency |

Table XII contains information about the various counter-parties (trading partners) that are contained in the system.

TABLE XII
Counter Party

| Field Name | Field Type | Field Description |
|---|---|---|
| CounterPartyID | Number | Unique CounterParty ID |
| CPName | Text | CounterParty Name |

Table XIII holds information about shipments of products between the trading house and the counter-parties.

TABLE XIII
Shipment

| Field Name | Field Type | Field Description |
|---|---|---|
| ShipmentID | Number | Unique Shipment ID |
| ShippingCompanyID | Number | Reference to ShippingCompany |
| TransportationType | Number | Transportation Type, 1 = Surface, |
| | | 2 = Air, 3 = Ground |
| Origin | Text | Origin of the shipment |
| Destination | Text | Destination of the shipment |
| ShipmentBillNumber | Text | Contains the shipment bill number as |
| | | assigned by the shipping company |

Table XIV contains information about the various stocks of multiple products that exist in the system.

TABLE XIV
Stocks

| Field Name | Field Type | Field Description |
|---|---|---|
| ProdGrpID | Number | Reference to Product Group ID |
| ProdID | Number | Reference to Product ID |
| CounterPartyID | Number | Reference to CounterPartyID |
| Quantity | Number | Product Quantity |
| UOM_ID | Number | Reference to UnitID |
| ShipmentID | Number | Reference to ShipmentID |
| StorageID | Number | Reference to StorageID |
| CreateDate | Date/Time | Stock creation date |
| UpdateDate | Date/Time | Stock update date |
| CurrentStockPrice | Number | Current Price of stock, may be |
| | | modified to reflect incurred storage |
| | | costs |

Table XV contains information about the particular locations that stocks are stored.

TABLE XV
Storage ID

| Field Name | Field Type | Field Description |
|---|---|---|
| StorageID | Number | Unique Storage ID |
| StorageCompanyID | Number | Reference to StorageCompany |
| StorageRotationNumber | Text | Text of location reference |
| | | (Rotation Number) as assigned |
| | | by storage company to the |
| | | particular stock. |

Table XVI contains the definition of various shipment companies that are defined in the system.

TABLE XVI
Shipment Company

| Field Name | Field Type | Field Description |
|---|---|---|
| ShipmentCompanyID | Number | Unique ShipmentCompany ID |
| ShipmentCompanyName | Text | Name of Shipment Company |

Table XVII contains the pricing chains that are available for use by users of the system.

TABLE XVII
Pricing Chains

| Field Name | Field Type | Field Description |
|---|---|---|
| PricingChainID | Number | Unique Pricing Chain ID |
| TransactionID | Number | Reference to Transaction ID |
| PricingChainStatus | Number | Status, 1 = incomplete, 2 = complete |
| ProdGrpID | Number | Reference to Product Group ID |
| ProdID | Number | Reference to Product ID |
| ProdQty | Number | Quantity of product |
| UOM_ID | Number | Reference to UnitID |
| IncoTerm | Text | INCO Term of Transaction |
| IncoTermLocation | Text | INCO Location of Transaction |
| Starting Price | Number | Initial price used to seed top |
| | | of chain |
| ProdAvgPrice | Number | Average price of existing stocks |
| | | of this item |
| ChainOwner | Number | Reference to UserID that owns this |
| | | pricing chain |
| CurrentComputedPrice | Number | The currently computed price as |
| | | determined by evaluating all |
| | | processors of this chain. |

Table XVIII contains the link between pricing chains and the processors within each pricing chain.

TABLE XVIII
PricingChainProcs

| Field Name | Field Type | Field Description |
|---|---|---|
| PricingChainID | Number | Reference to Pricing Chain ID |
| ProcessorID | Number | Reference to Processor ID |
| ProcessorOrder | Number | Order of Processor within Chain |
| ProcessorValue | Number | Value of Processor |
| ProcessorStatus | Number | Status of Processor, 0 = empty, |
| | | 1 = valid, 2 = lazy, 3 = strict |
| ProcessorCompStatus | Number | Computation status, 0 = do not |
| | | include in chain computation, 1 = do |
| | | include |

Table XIX contains the list of processors available to users for linking into pricing chains.

TABLE XIX
Processors

| Field Name | Field Type | Field Description |
|---|---|---|
| ProcessorID | Number | A Processor is a specific instance of a |
| | | computation handler that is assigned to |
| | | a particular chain |
| ProcessorTitle | Text | Title of processor |
| ProcessorType | Number | 0 = Constant Modifier, 1 = Table |
| | | Lookup, 2 = Expression |
| CompHandlerID | Number | Reference to CompHandler ID |

Table XX contains information about the various computation handlers that are available for use as templates for processors within the system.

TABLE XX
CompHandlers

| Field Name | Field Type | Field Description |
|---|---|---|
| CompHandlerID | Number | Unique Computation Handler ID |
| CompHandlerTitle | Text | Title of Computation Handler |
| CompHandlerType | Number | 0 = Constant Modifier (CM), |
| | | 1 = Table Lookup (TL), |
| | | 2 = Basic Function (BF) |
| AssignedRole | Number | Role assigned to service updates |
| | | for this computation handler |
| ExpirationType | Number | Expiration type of computation |
| | | hander; 0 = no expiration, |
| | | 1 = lazy, 2 = strict |
| ExpirationStatus | Number | 0 = valid, 1 = lazy, |
| | | 2 = strict |
| LazyExpirationDate | Date/Time | Date and time at which lazy |
| | | expiration may become effective |
| | | for this computation handler. |
| LazyExpirationDuration | Number | Duration, in seconds, for |
| | | which an update to this |
| | | computation handler may cause |
| | | it to be treated as lazy |
| | | expiration. |
| StrictExpirationDate | Date/Time | Date and time at which |
| | | strict expiration may become |
| | | effective for this computation |
| | | handler. |
| StrictExpirationDuration | Number | Duration, in seconds, for |
| | | which an update to this |
| | | computation handler may cause |
| | | it to be treated as strict |
| | | expiration. |
| CurrentValue | Number | Current value of computation |
| | | handler |
| Parameter | Text | n/a in case of CM; table, |
| | | field and column reference |
| | | in case of TL; function to |
| | | be evaluated in case of BF |
| Modifier | Number | The numerical value used in |
| | | the expression to modify |
| | | the input value of the |
| | | computation handler |
| Operator | Text | The mathematical operator |
| | | applied to the modifier value. |

Table XXI contains the expiration data for the items in the system that are monitored by the data expiration handler.

TABLE XXI
Data Expiration

| Field Name | Field Type | Field Description |
|---|---|---|
| ExpirationID | Number | Unique Expiration ID |
| ExpirationType | Number | Type of expiration; 0 = lazy, |
| | | 1 = strict |
| ExpirationStatus | Number | Expiration status; 0 = valid, |
| | | 1 = lazy, 2 = strict |
| ExpirationCreateDate | Date/Time | Date and time when expiration |
| | | record was created |
| ExpirationUpdateDate | Date/Time | Date and time when expiration |
| | | record was last updated |
| LazyExpirationDate | Date/Time | Date and time at which lazy |
| | | expiration may become effective |
| | | for this computation handler. |
| LazyExpirationDuration | Number | Duration, in seconds, for |
| | | which an update to this |
| | | computation handler may cause |
| | | it to be treated as lazy |
| | | expiration. |
| StrictExpirationDate | Date/Time | Date and time at which |
| | | strict expiration may become |
| | | effective for this |
| | | computation handler. |
| StrictExpirationDuration | Number | Duration, in seconds, for |
| | | which an update to this |
| | | computation handler may cause |
| | | it to be treated as strict |
| | | expiration. |
| NotificationTarget | Number | Reference to RoleID or UserID |
| | | for expiration notification |

Table XXII contains the definitions of the various queues available in the system.

TABLE XXII
Queue

| | Field | |
|---|---|---|
| Field Name | Type | Field Description |
| QueueID | Number | Unique QueueID |
| Qname | Text | Name of Queue |
| QBusinessLogicPriorityProc | Text | Reference to external |
| | | business logic procedure |
| | | that sets priority for |
| | | items in this queue |
| QbusinessLogicAmalgamationProc | Text | Reference to external |
| | | business logic procedure |
| | | that amalgamates items |
| | | in this queue |
| QextProcRef | Text | Reference to external |
| | | procedure operative on |
| | | this queue |
| QextCompProcRef | Text | Reference to external |
| | | procedure to be called |
| | | when a queue item in |
| | | this queue is completed |
| DefaultPriority | Number | Default priority value |
| | | of items in the queue |

Table XXIII contains the queue items and their links to the queues in the system.

TABLE XXIII
QueueItem

| Field Name | Field Type | Field Description |
|---|---|---|
| QueueItemID | Number | Reference to QueueItemID |
| QueueID | Number | Reference to QueueID |
| QitemTitle | Text | Title of QueueItem |
| QitemBody | Text | Body of QueueItem |
| QitemLinkRef | Text | Optional link value |
| | | to external |
| | | database/table/row/column |
| QitemAssignee | Number | Reference to User or |
| | | Role that queue item |
| | | is assigned to |
| QitemPrompt | Text | Prompt Text for queue |
| | | item query |
| QitemPromptVariable | Number | Structure for queue |
| | | variables |
| QitemValue | Number | Value input by queue |
| | | item assignee |
| QitemValueLoc | Text | Reference to |
| | | database/table/row/column |
| | | where QueueItem Value is |
| | | to be written to |
| QitemStatus | Number | Status: 0 = incomplete; |
| | | 1 = viewed; |
| | | 2 = amalgamated; |
| | | 255 = completed |
| QitemPriority | Number | Priority of QueueItem |
| QItemBaseAmalgamationQID | Number | Reference to QueueID to |
| | | be base for this series |
| | | of amalgamation |
| | | operations |
| QitemOrder | Number | Order of queue item |
| | | within the queue. |
| QitemDate | Date/Time | Date and time when |
| | | QueueItem was created |

Table XXIV contains the dependency information for the queues and queue items in the system.

TABLE XXIV
QueueItemDeps

| Field Name | Field Type | Field Description |
|---|---|---|
| BaseQueueItemID | Number | Reference to QueueItemID for base of |
| | | dependency |
| BaseQueueID | Number | Reference to QueueID for base of |
| | | dependency |
| DepQueueItemID | Number | Reference to Dependent QueueItemID |
| DepQueueID | Number | Reference to Dependent QueueID |

Table XXV is the reference to QueueID for base of dependency.

TABLE XXV
QueueDeps

| Field Name | Field Type | Field Description |
|---|---|---|
| BaseQueueID | Number | Unique Base Queue ID |
| DepQueueID | Number | Reference to Dependent QueueID |
| QdepBusinessLogicProc | Text | Reference to external business |
| | | logic procedure that determines |
| | | dependencies for these two queues |

Table XXVI contains the archived (inactive) queue items.

TABLE XXVI
QueueItemArchive

| Field Name | Field Type | Field Description |
|---|---|---|
| QueueItemID | Number | Reference to QueueItemID |
| QueueID | Number | Reference to QueueID |
| QitemTitle | Text | Title of QueueItem |
| QitemBody | Text | Body of QueueItem |
| QitemLinkRef | Text | Optional link value |
| | | to external |
| | | database/table/row/column |
| QitemAssignee | Number | Reference to User or |
| | | Role that queue item is |
| | | assigned to |
| QitemPrompt | Text | Prompt Text for queue |
| | | item query |
| QitemValue | Number | Value input by queue |
| | | item assignee |
| QitemValueLoc | Text | Reference to |
| | | database/table/row/column |
| | | where QueueItem Value is |
| | | to be written to |
| QitemStatus | Number | Status: 0 = incomplete; |
| | | 1 = viewed; |
| | | 2 = amalgamated; |
| | | 255 = completed |
| QitemPriority | Number | Priority of QueueItem |
| QItemBaseAmalgamationQID | Number | Reference to QueueID to |
| | | be base for this series |
| | | of amalgamation operations |
| QitemArchivedDate | Date/Time | Date and time of when |
| | | Queue Item was archived |

Table XXVII contains the definitions of the various weights that are saved for users of the system.

TABLE XXVII
RecWeights

| Field Name | Field Type | Field Description |
|---|---|---|
| WeightID | Number | Unique Weight ID |
| WeightTitle | Text | Name of Weight as displayed |
| WeightType | Number | Type of weight; 1 = user, |
| | | 2 = management, 3 = both |
| RecParameterID | Number | Reference to RecParameterID used as |
| | | the parameter for this weight |

Table XXVIII contains the saved values of the various weights for each user of the system.

TABLE XXVIII
RecWeightsMap

| Field Name | Field Type | Field Description |
|---|---|---|
| WeightID | Number | Reference to Weight ID |
| WeightUserID | Number | Reference to User ID |
| WeightValue | Number | Value of Weight |

Table XXIX is a table of recommendation Types.

TABLE XXIX
RecTypes

| Field Name | Field Type | Field Description |
|---|---|---|
| TypeID | Number | Unique Recommendation Type ID |
| TypeName | Text | Title of Recommendation Type |
| TypeQualifierExp | Text | Expression to Qualify potential |
| | | candidate Transactions for |
| | | recommendation |
| TypeTargetExp | Text | Expression to specify targeted |
| | | result of recommendation |

Table XXX contains the parameters for which weights can be applied to in order to evaluate data and create transaction recommendations.

TABLE XXX
RecParameters

| Field Name | Field Type | Field Description |
|---|---|---|
| RecParameterID | Number | Unique parameter ID |
| RecParameterTitle | Text | Name of parameter as displayed |
| RecParameterSource | Text | Reference to database, table and |
| | | column used for recommendation |
| | | parameter evaluation |
| RecParameterType | Number | Parameter type; 0 = regular, 1 = trend |

Table XXXI contains the threshold minimum and maximum values for parameters that are controlled by thresholds.

TABLE XXXI
RecThresholds

| Field Name | Field Type | Field Description |
|---|---|---|
| ThresholdID | Number | Unique ThresholdID |
| ThresholdName | Text | Name of Threshold |
| ThresholdMin | Number | Low value of threshold |
| ThresholdMax | Number | High value of threshold |
| ThresholdParameterID | Number | Reference to ParameterID |

Table XXXII contains the definitions for parameters that are evaluated as trend parameters by the system.

TABLE XXXII
RecTrends

| Field Name | Field Type | Field Description |
|---|---|---|
| TrendID | Number | Unique Trend ID |
| TrendTitle | Text | Name of Trend as displayed |
| TrendSource | Text | Reference to database, table and |
| | | column used for recommendation |
| | | Trend evaluation |
| SamplingPeriod | Number | Number of seconds in sampling period |

Table XXXIII contains the references to the external programs that handle the actual delivery of a notification to the user. Examples include programs to send notifications via SMTP (email), SMS, or Facsimile.

TABLE XXXIII
UserNotificationDelivery

| Field Name | Field Type | Field Description |
|---|---|---|
| DeliveryTypeID | Number | Unique NotificationType ID |
| DeliveryHandlerProgram | Number | Reference to external program to |
| | | deliver notification to user |

Table XXXIV contains the mapping between product groups defined in Table IX and products, defined in Table VIII.

TABLE XXXIV
ProductGroupMap

| Field Name | Field Type | Field Description |
|---|---|---|
| ProdGrpID | Number | Reference to Product Group ID |
| ProdID | Number | Reference to Product ID |

The commodity trading system also preferably includes a user manager 300, comprising a module for managing users, groups and the relationships between them, such as that provided by Active Directory, produced by Microsoft Corporation, One Microsoft Way, Redmond, Wash. 98052, United States of America.

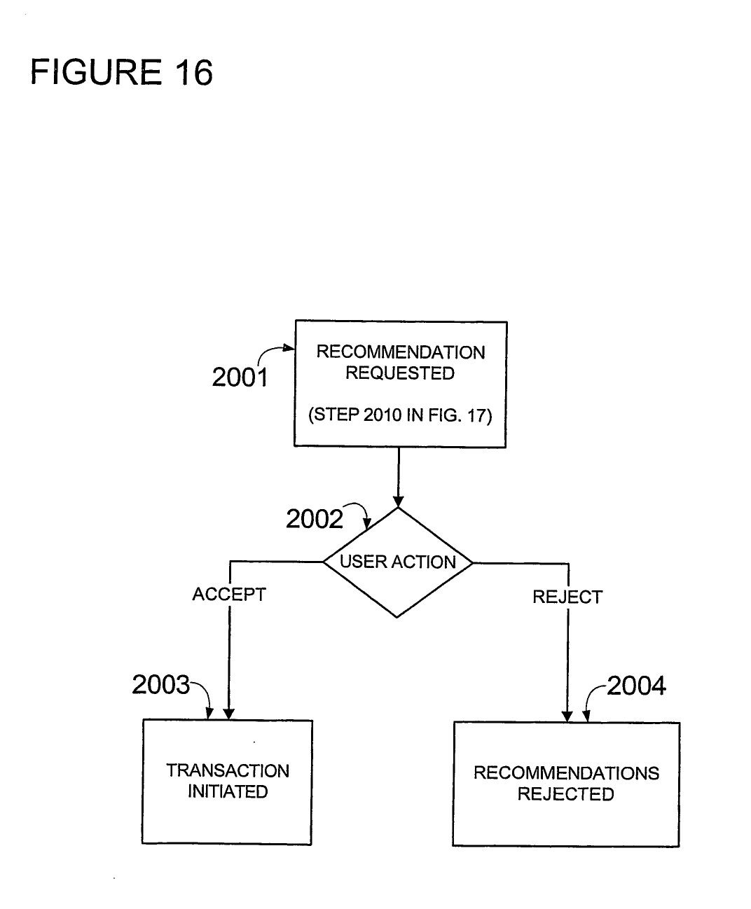

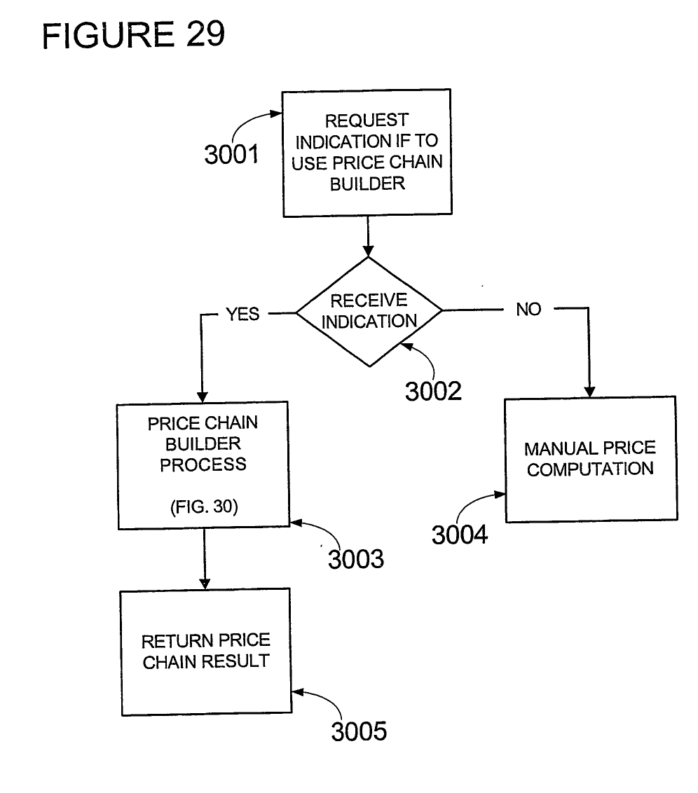

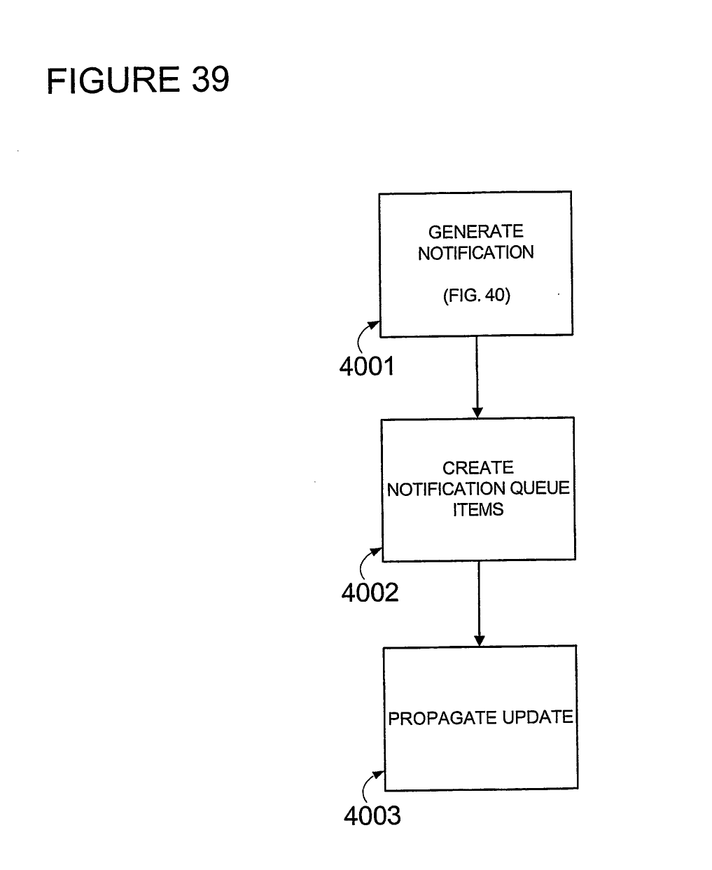

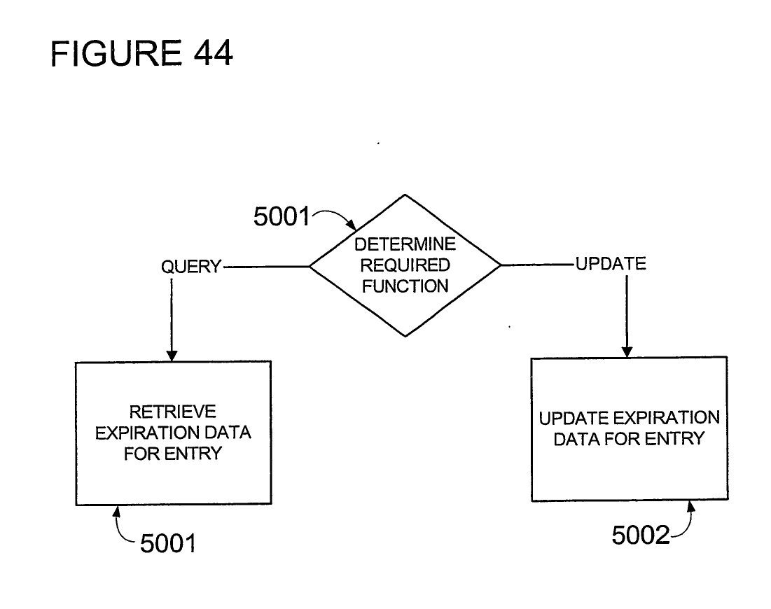

The commodity trading system also preferably includes a queue manager 1000, described further hereinbelow with reference to FIGS. 2-15, a physical commodity transaction builder 2000, described further hereinbelow with reference to FIGS. 16-28, a pricing chain builder 3000, described further hereinbelow with reference to FIGS. 29-38, a notification handler 4000, described further hereinbelow with reference to FIGS. 39-43 and a data expiration handler 5000, described further hereinbelow with reference to FIGS. 44-48.

The queue manager 1000 manages a plurality of interrelated queues which typically exist in the system, each including a sequence of items waiting in order for electronic action. The queues are interrelated in the sense that priorities and requirements in one queue are affected by the management of at least one other queue. For example, the fact that certain goods are being shipped at one time rather than another may affect the priorities and requirements for storing those goods at their shipping source and/or at their shipping destination.

The queue manager 1000 preferably includes flexible business logic defining, for each queue, how the queue is to behave, including:

a. rules for resorting, reprioritizing, collating and/or amalgamating items in the queue, so as to optimize business operation; and, optionally

b. rules for providing notification of queue information between queues. Provision of notification is preferably handled by notification handler 4000.

Optimization may result from any of several factors including:

a. reduced workload due to batch processing;

b. reduced cost due to earning bulk rates by amalgamating several related small orders (e.g. shipping orders) into a smaller number of larger orders; and

c. reduced costs due to scheduling which optimally exploits timing factors.

The queues managed by the queue manager 1000 may, for example, include a transaction queue, a storage queue, a shipment queue, a currency exchange queue, a credit/debit note queue, and an invoice queue.

The transaction queue is a list of transactions, in various states of completion, which are waiting to be advanced by any of a plurality of human or computerized operators, such as, but not limited to, traders. Each transaction or transaction type optionally has a life cycle defined for it, which comprises a definition of which stages need to be completed or defined in order to complete the transaction and for each such stage, what needs to be done, when, and by whom. Alternatively, a transaction may not have a life cycle which defines the stages thereof. In this case, the system may require the trader, at each stage, to define the next stage, including what needs to be done to complete the stage, by whom, and when. The queue manager then routes the partly completed transaction to the various appropriate role-players. If a particular stage is completed, and the next stage is not defined either by the transaction's life cycle or previously by the responsible trader, the transaction typically enters the trader's queue and the trader is prompted to define the next stage.

The shipment queue is a list of orders that need to be shipped. An “order” is a given amount of a given stock of a given commodity that is being traded. The shipment queue is typically closely interrelated to the storage queue, which is a list of orders that need to be stored. In both of these queues, preferably, an amalgamation function is provided which stores bulk rates and proposes amalgamations of multiple orders in a queue in order to benefit from bulk rates.

The currency exchange queue is a list of currency exchange tasks, each including a currency amount which, for the purpose of a particular transaction, needs to be converted into another currency. Optionally, another, typically daily exchange task is updating the currency exchange rates in accordance with a suitable exchange rate data source which preferably communicates electronically with the system of the present invention.

The credit/debit note queue is a list of notes (credit or debit), which are issued by or for the trading house and are typically processed in FIFO order. Alternatively, the queues might be optimized to operate in a non-FIFO order, e.g. by collating and/or amalgamating such that all debit notes to a particular party are either issued sequentially or are amalgamated into a single debit note including all charges in the queue.

The physical commodity transaction builder 2000 generates a recommendation for a suitable transaction, responsive to a trader's query, which the trader chooses to complete or not to complete.

A query is a trader's request to the physical commodity transaction builder, to recommend a transaction answering to specific basic requirements. Preferably, the query also includes weighting of various relevant parameters. Preferably, different parameters are predefined or dynamically defined for different queries or types of queries and the trader is prompted to specify weights for the relevant parameters responsive to his presentation of the initial query specifying only the query's basic requirements.

Optionally, weightings of additional parameters may be provided by a role-player other than the trader, such as a management executive. The system may store overriding rules determining the relative importance attached to the trader's weightings vis-à-vis the management executive's weightings. The management executive's weightings may or may not be included in the trader's view of the system. A particular feature of a preferred embodiment of the present invention is that the trader may, if desired, remain entirely unaware of the fact that the application takes into account weightings other than his own.

The basic requirements of a query always includes direction, buying or selling, preferably specified in TranType field of Table I, and typically includes a subset of the following basic transaction parameters:

a. counterparty (specified in CounterPartyID field of Table I by reference to Table XII);

b. product (specified in ProductID field of Table I by reference to Table VIII);

c. quantity (specified in Quantity field of Table I); and

d. price at which product can be sold, for a sale transaction, or bought, for a purchase transaction (specified in BasePrice and ComputedPrice fields of Table I).

The basic requirements sometimes include additional parameters, e.g. present location of the order, or attributes of the product, such as grade.

The recommendation generated by the physical commodity transaction builder typically includes the complementary subset to the query defining subset of basic transaction parameters, and sometimes, additional transaction parameters. For example, if a query comprises a request for a recommendation to liquidate (sell) 100 tons (quantity) of wheat (product) in Colorado (additional parameter: present location of the order), the recommendation generated by the transaction builder 2000 may comprise at least a recommended counterparty, and the price at which the counterparty would likely be willing to close the transaction. It is appreciated that the basic requirement/s of the query typically include a subset of the above basic parameters.

One possible counterparty parameter is a “past performance” parameter. This parameter may store markup tolerance. For example, a high-end retailer may tolerate higher markups because it, and its suppliers, needs to expect a higher return rate. A retailer with rapid turnover may tolerate higher markups because of its need to have a constant, fast-flowing supply of goods.

The pricing chain builder 3000 is typically operative to:

a. Interface with a trader who wishes to build a pricing chain from scratch or based on an existing pricing chain stored in the system.

b. Analyze all pricing chains available in the pricing chain library and rank the applicability of each to a transaction to be completed. For example, for a transaction to be completed involving surface freight of 100 tons of wheat from California to London, the pricing chain library might rank the following existing pricing chains as relatively applicable:

i. Sale of 200 tons of wheat from Oregon to Dublin, shipped surface;

ii. Purchase of 75 tons of sorghum from Argentina to Barcelona; and

iii. Sale of 100 tons of barley from California to Germany.

c. Update fields, typically cost fields, in all relevant existing pricing chains when new information, typically new cost information, is provided to the system. Updating each field typically includes storing an expiry date until which the update remains valid.

d. Prompt the notification handler to obtain updates for stored price chain information which is about to expire or has expired.

The data expiration handler 5000 is preferably operative to look at a system-defined or system-manager-defined or dynamically defined set of parameters stored in the system which may expire. The parameters are preferably stored in the Parameter field of Table XX with the CompHandlerType field set to 1 (Table Lookup). The value of the Parameter field is a pointer to any location in the database that contains the actual data value which is to be controlled by data expiration handler 5000. Examples of such data items may include:

Currency exchange rates stored in CurrencyConversionRate field of Table XI;

Product Market prices stored in ProdMarketPrice field of Table VIII; and

Product stock levels stored in field ProdQtyLevel field of Table VIII.

Preferably, a strict expiration period and an additional grace period are defined for each expiring parameter. During the strict expiration period, the system knows absolutely that its data is valid. During the additional grace period, also termed herein the period of “LAZY EXPIRATION”, the system anticipates, based on previous computerized or human knowledge, that the data is still likely to be valid. Typically, during the grace period, notifications are generated prompting relevant system components to update the data, however, transactions are allowed to proceed based on the existing data. After the grace period has elapsed, transactions are typically no longer allowed to proceed based on the existing data and urgent notifications are generated to prompt for new data. Typically, the system is operative to automatically hold up transactions based on data whose grace period has elapsed and to automatically release the same transactions as soon as the relevant data has been updated.

A particular feature of a preferred embodiment of the present invention is that the workflow of a trading company is defined in a computerized system in terms of interacting queues. The computerized system provides computerized management of multiple interacting or interrelated queues. The types of queues which are managed by the queue manager 1000 of FIG. 1 and the functional unit from which each queue originates may include the following:

Currency Bookings (Currency Handler 105);

Currency Exchange Rate Updates (Currency Handler 105);

Creation, processing and updates of Credit/Debit notes (Credit and Debit note handler 106);

Transaction handling—Offer/request dispatch (Transaction Handler 107);

Stock levels management (Stock Management Module 108);

Creation, processing and updates of contracts notes (Contract Handler 109);

Creation, processing and updates of product information (Product Catalog 110);

Shipment information tracking and processing (Shipment Handler 111); and

Financial accounting (Accounting Handler 112).

Queues are preferably flexibly defined and tailored per implementation.

Reference is now made to FIG. 2, which is a simplified flowchart illustration of a preferred method of operation for the queue manager 1000, which coordinates information in the commodity trading system of FIG. 1.

Queue manager 1000 is typically operative to perform queue maintenance, such as amalgamating and sorting queue items. Queue manager 1000 may also be operative to generate new queue items from dependencies or may accept new queue entries. New queue entries may be provided from an outside application or another sub-system within the commodity trading system, such as the notification handler 4000.

As seen in FIG. 2, in step 1001, queue manager 1000 may be invoked when a new queue item is generated. New queue items may be provided by a source internal to the trading system or an external application that the trading system is inter-operating with, such as handlers 105-112 of FIG. 1. The queue manager may further be invoked by user action from presentation layer 104 of FIG. 1 or by a programmatic process.

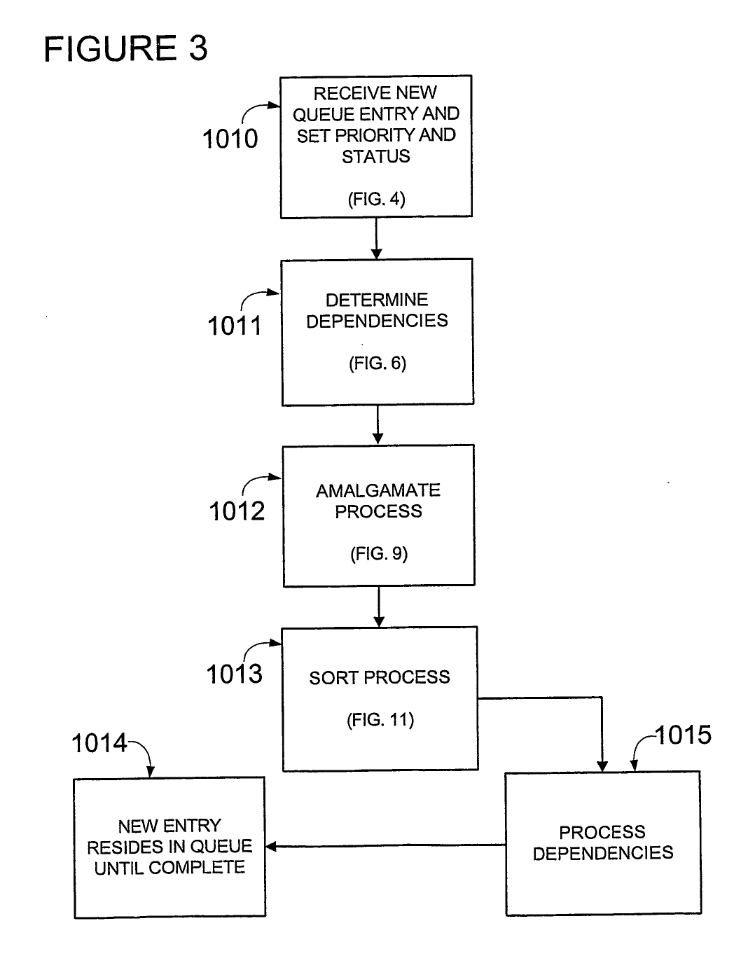

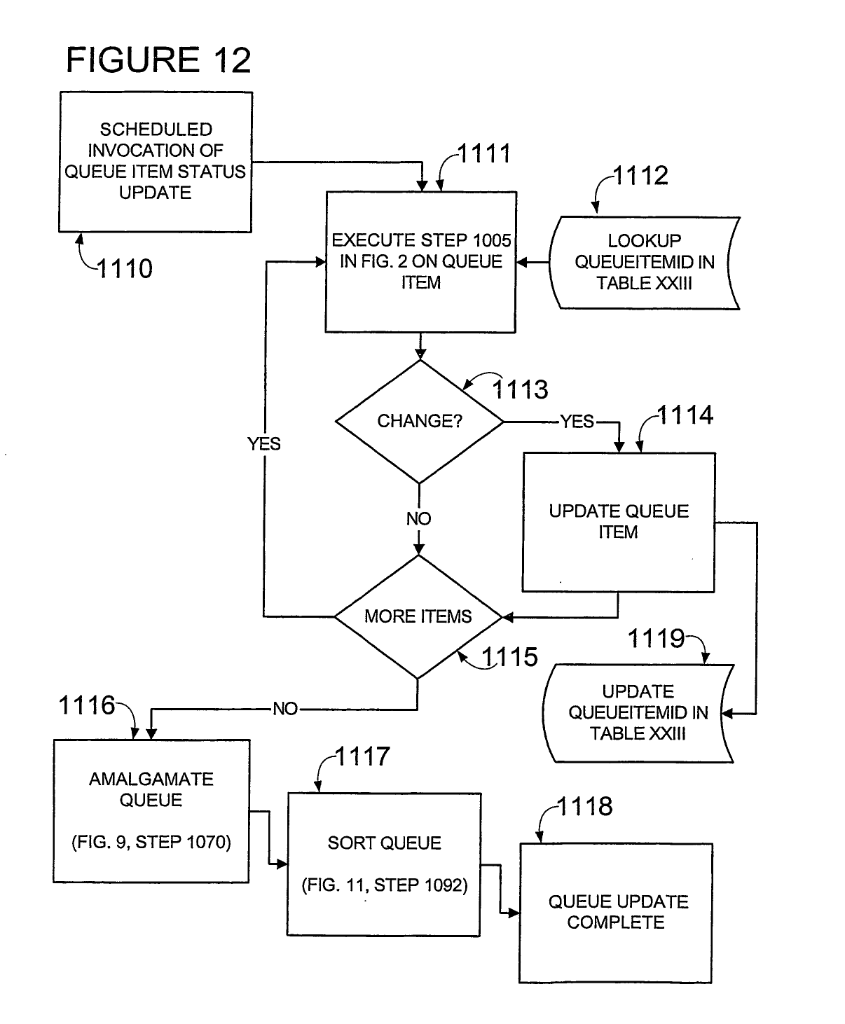

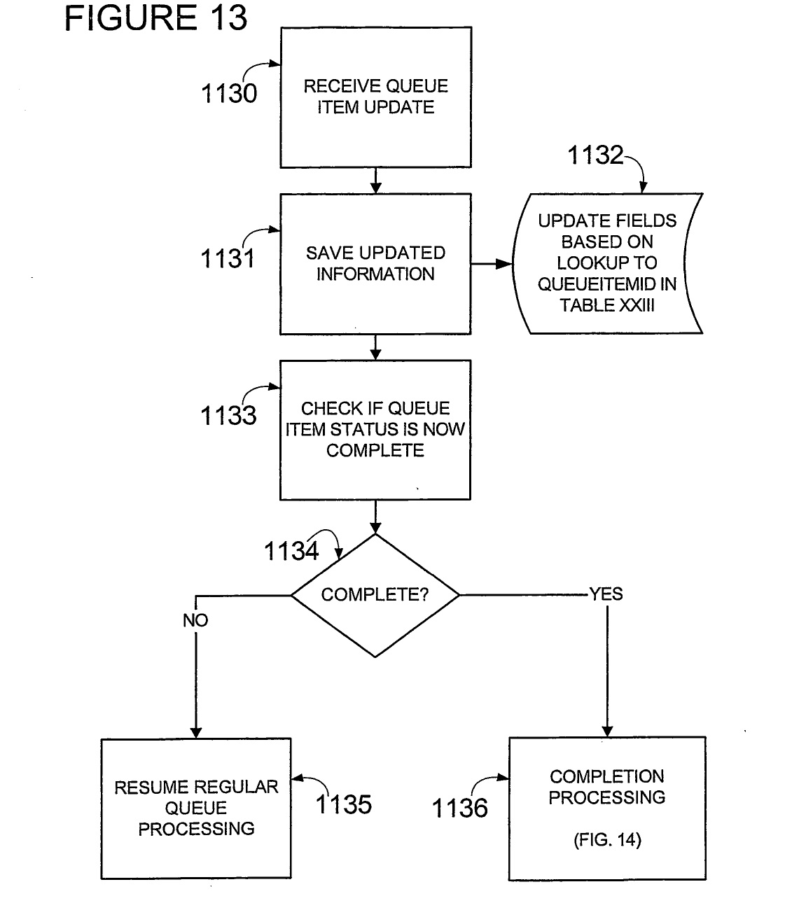

In step 1002, the appropriate action is determined, based on a parameter sent by the calling process. Step 1003 shows a queue update operation being performed, as described hereinbelow with reference to step 1130 in FIG. 13. Step 1004 shows a queue add operation being performed, as described hereinbelow with reference to step 1010 in FIG. 3.

In step 1005, if a queue evaluation is selected, and after either step 1003 or step 1004 are executed, the queue is re-evaluated for sorting order and amalgamation opportunities, as depicted in step 1116 of FIG. 12.

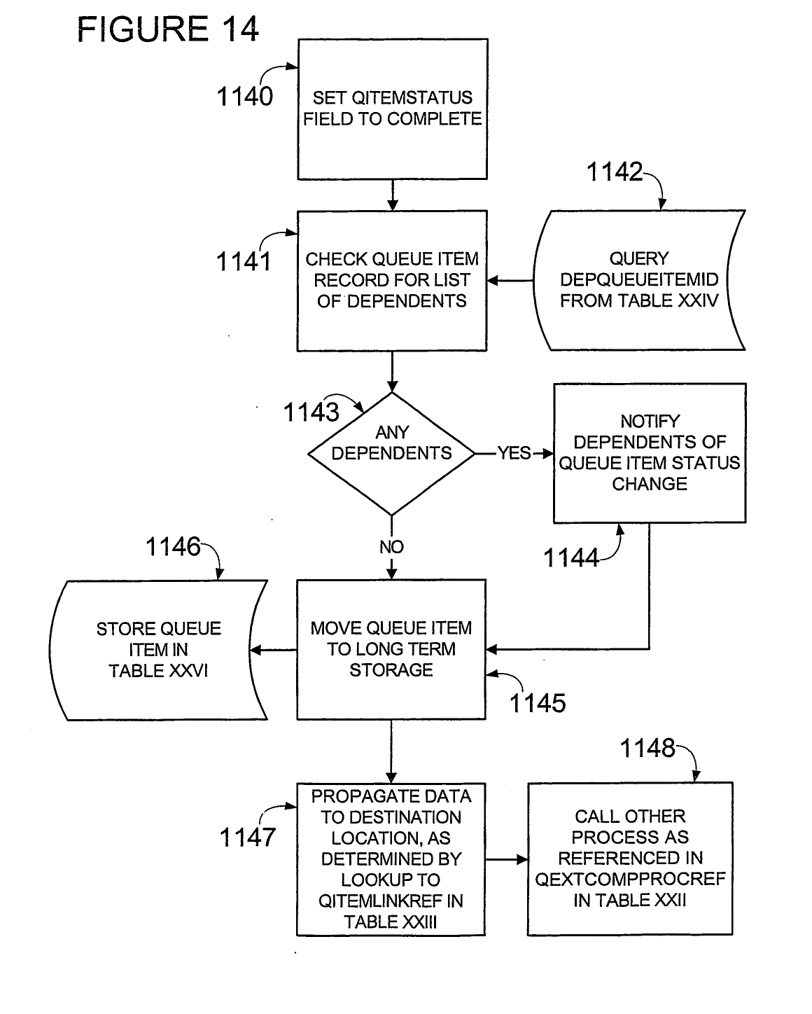

Step 1006 checks to see if the queue item has status set to complete. If the status is not set to complete, the process continues by executing step 1007, which returns processing to the process that invoked the queue manager 1000. If the status of the queue item is set to complete, the process continues in step 1008 by performing completion processing, as described hereinbelow with reference to step 1140 of FIG. 14.

Upon completion, queue manager 1000 ceases processing until it is called again.

Reference is now made to FIG. 3, which is a simplified flowchart illustration of a preferred method for implementing a queue add operation, as shown in step 1004 of FIG. 2. FIG. 3 shows the processing steps that may be executed when a new entry is submitted to a queue. If the entry produces dependencies they may be processed after the original entry is processed in its own queue. The dependencies created may be treated as new entries by the queues to which they are submitted.

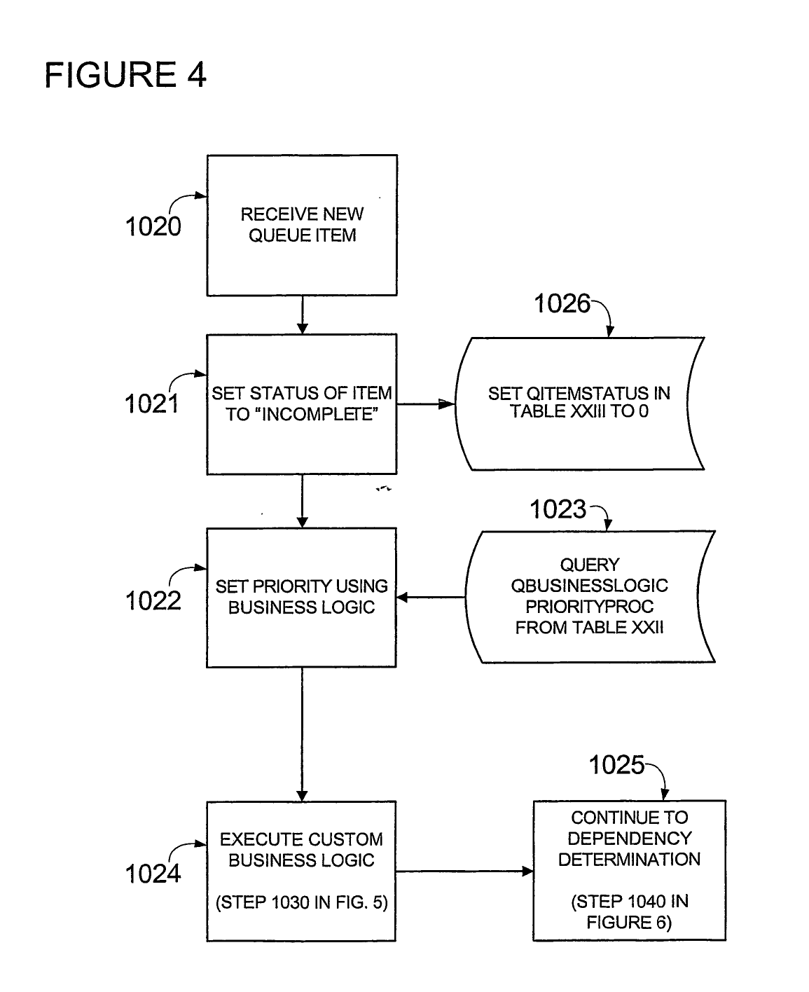

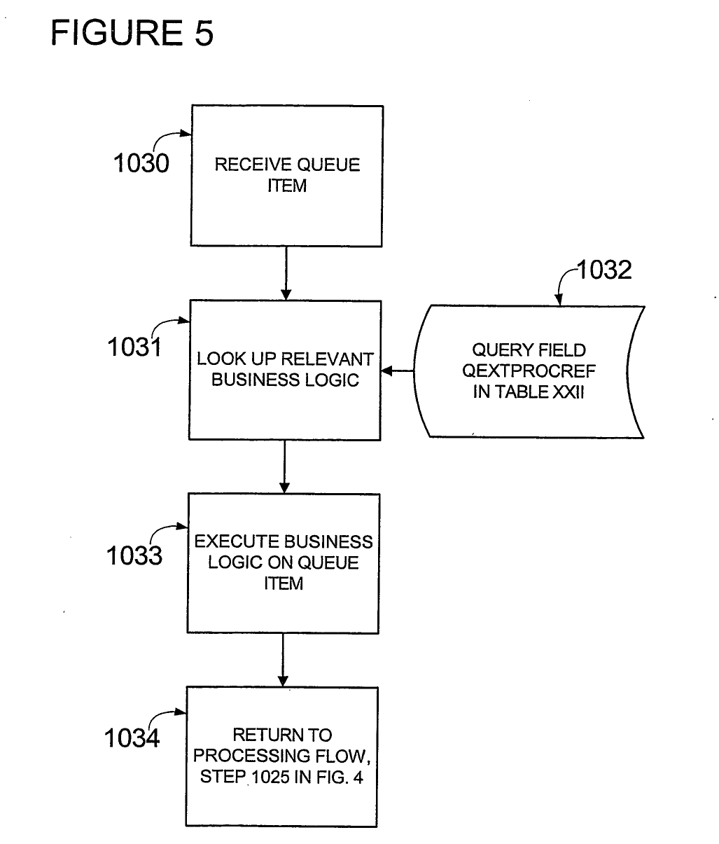

As seen in step 1010, upon receiving a new queue entry, the new queue entry is assigned a priority and status, as described hereinbelow with reference to FIG. 4. The status and priority are used for sorting the queue, as described hereinbelow. They are subject to change over time as the item resides in the queue.

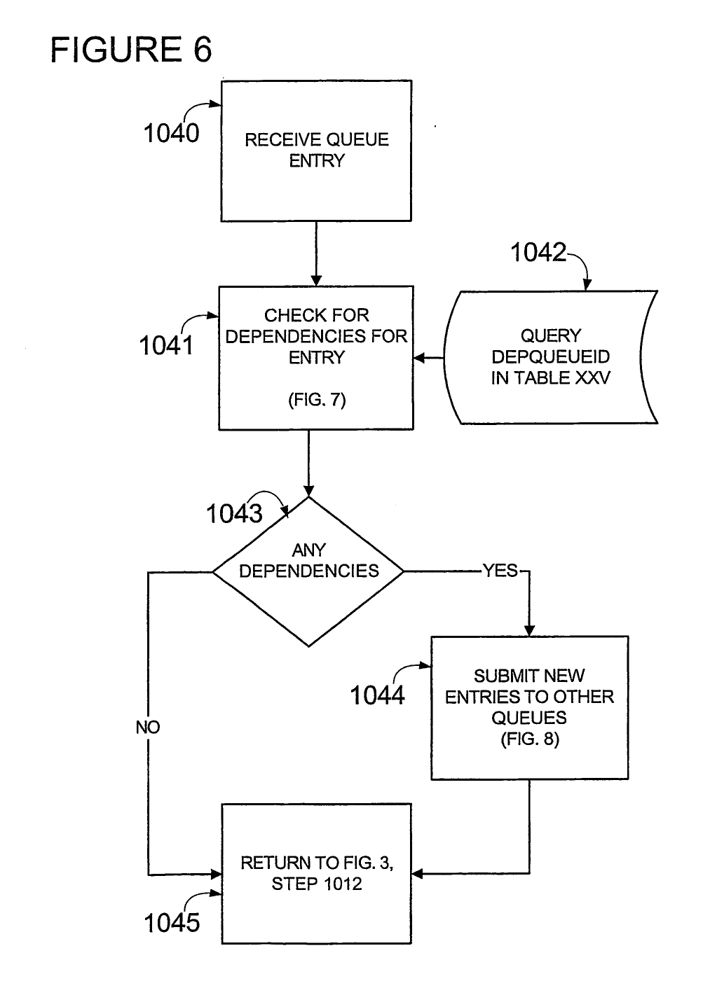

In step 1011, the queue manager 1000 then determines any dependencies of the new queue entry, as detailed in FIG. 6, beginning with step 1040. As seen in step 1011, once the item is submitted to a queue it may not be possible to process the item without dealing with supporting items in other queues first. The item currently being processed is considered to be dependent on those items, so they are referred to as dependencies. The dependencies may already exist, in which case a link may be established, or they may need to be created, in which case the queue manager 1000 may create them. The dependencies are processed after the current queue has been fully processed, as seen in step 1015.

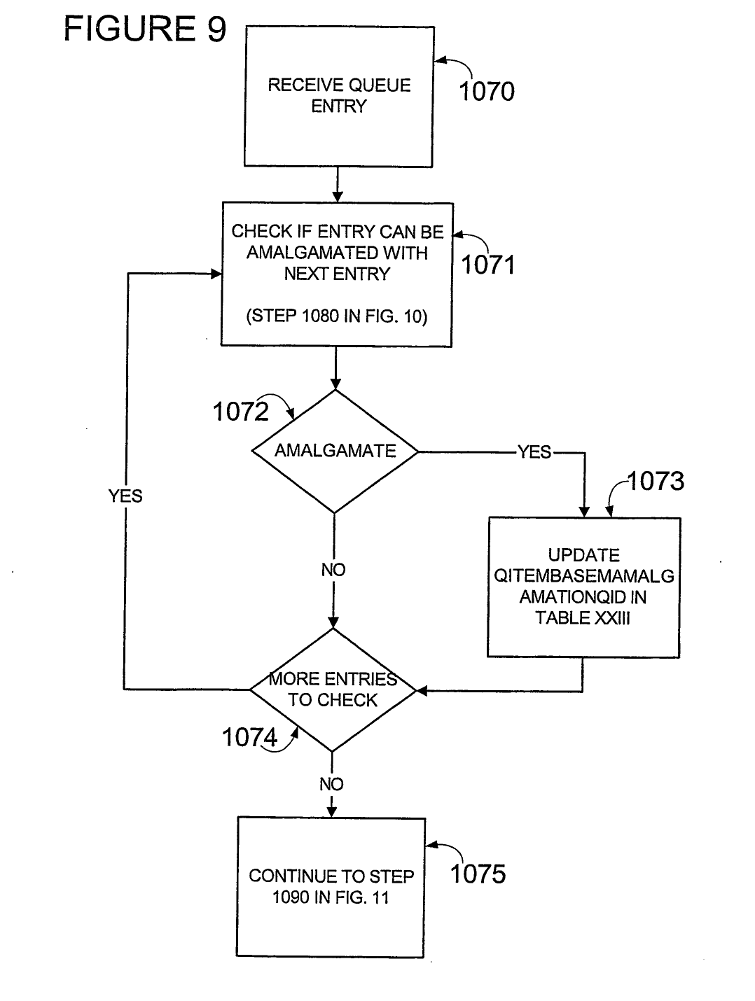

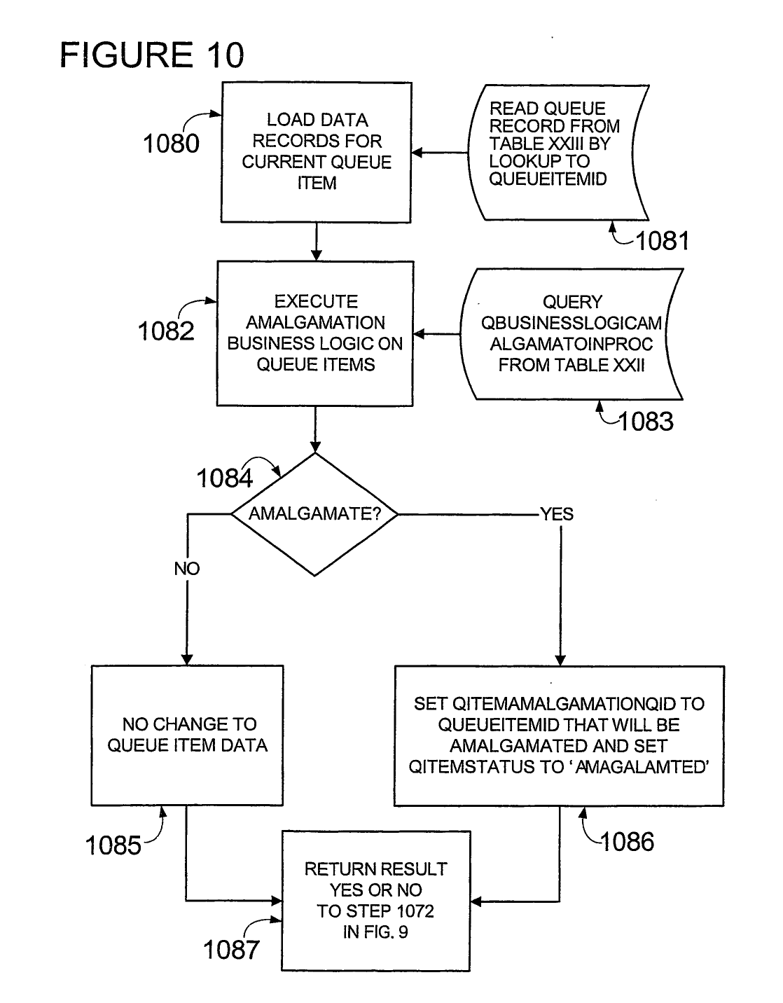

In step 1012, the queue manager 1000 preferably attempts to amalgamate a newly received item with one already resident in the queue. The goal is to identify opportunities for more efficient use of resources. The queue manager 1000 uses pre-programmed business logic, as shown hereinbelow in FIG. 9, to determine whether amalgamation of any pair or set of items may lead to greater efficiency. Amalgamated items cease to be distinct items in the queue since they are all amalgamated into a root queue item. The amalgamation process in described hereinbelow with reference to FIGS. 9 and 10.

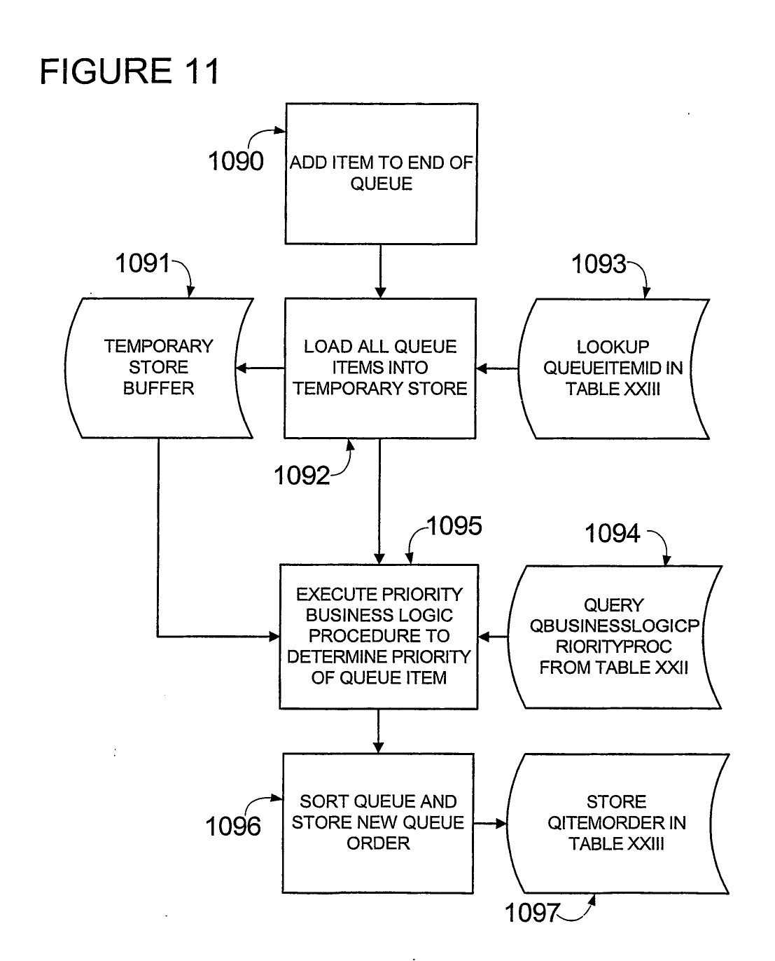

In step 1013, the display order for items in a queue is determined by a sorting process, preferably utilizing a business logic based process, as described hereinbelow with reference to FIG. 11. The sort process preferably uses the priority assigned as described hereinabove, as one important factor in ordering the items in a queue. The business logic programming preferably specifies what other factors are taken into consideration and how the sorting process proceeds.

As seen in step 1014, upon completion of the sorting process, the queue has been updated with the new queue entry. The new queue entry preferably resides in the queue until it reaches a status of “complete.” The entry may typically be re-ordered, as described hereinabove, multiple times while in the queue and also may be amalgamated, as described hereinabove, with an incoming queue item.

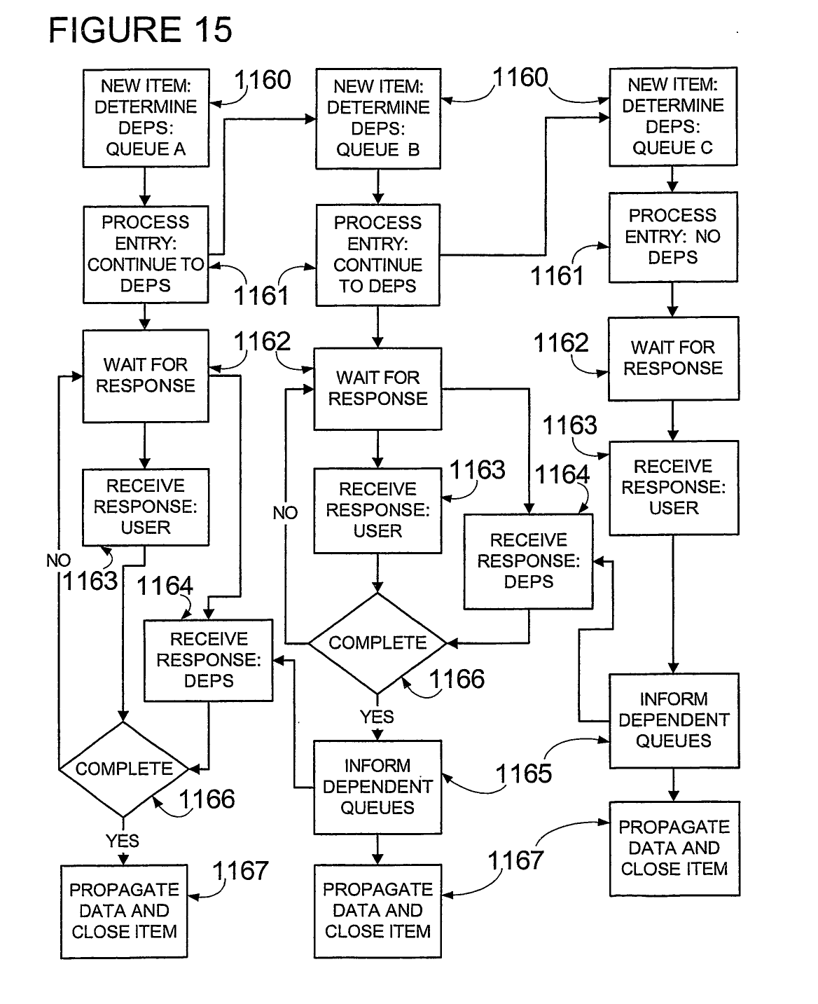

Upon completion of the processing of the new queue item, any dependencies that it may have may then be processed as seen in step 1015. Each newly created dependency may be treated as a new item in its queue. Thus, the queue manager 1000 is invoked for each newly created dependency and the entire process described hereinabove may be executed multiple times. An example of such multiple execution of queue manager 1000 is described hereinbelow with reference to FIG. 15.

Reference is now made to FIG. 4, which is a simplified flowchart illustration of a preferred method for assigning a priority and status to a new queue entry, as shown in step 1010 of FIG. 3.

When a new item is submitted to a queue it is assigned a status and a priority. The status of the item is either “incomplete”, when it first enters the queue, or “complete”, when it has been satisfied. The priority indicates how urgent the new queue item is. This value can change as the item remains in the queue. The business logic may optionally control the priority value, or it may be controlled via other external means.

As seen in step 1020, the process starts with the receipt of a new queue item. A new item is typically received from an external source or from the queue manager 1000. Queue items coming from the queue manager typically have been generated as a dependency to an item that has already been processed.

In step 1021, the new item submitted has its status set to “incomplete.” In order for its status to change to complete it must be “satisfied” as must its dependencies.

In step 1022, the new item submitted has its priority set. The business logic applicable to setting the priority of items within the selected type of queue item is loaded and executed. The business logic may determine a priority for the queue item, which may be used to place it appropriately in the queue. A preferred method for determining the priority in described in step 1023, where the business logic repository contains references to the external business logic processes that determine the priority of items in a queue. It is queried by lookup on the QbusinessLogicPriorityProc field in Table XXII, which matches the relevant external business logic process to the selected queue.

In step 1024, queue manager 1000 executes customized business logic, which is described hereinbelow with reference to step 1030 in FIG. 5. In step 1025, queue manager 1000 continues to the dependency determination step, described hereinbelow with reference to step 1040 of FIG. 6.

Step 1026 shows a preferred table implementation of step 1021 hereinabove, by setting the value of the QitemStatus field in Table XXIII to 0.

Reference is now made to FIG. 5, which is a simplified flowchart illustration of a preferred method for implementing custom business logic, as shown in step 1024 of FIG. 4. The business logic allows the individual queues managed by queue manager 1000 to be configured in a way that can satisfy the needs of a given process or organization. As seen in FIG. 5, in step 1030, the queue manager 1000 receives a pointer, typically QueueID from Table XXII, to the queue that may be used to look up the appropriate business logic in the business logic repository. The queue manager 1000 also, preferably, receives the pointers to the queue items, typically QueueItemID from Table XXIII, that may be processed by the business logic.

In step 1031, the process requiring business logic preferably invokes the lookup procedure to retrieve the appropriate business logic. As seen in step 1032, the external processes database contains references to external processes, expressions or functions that may apply business logic to items in the queue. Preferably, the specific record identifying which business logic to be used is retrieved from the QExtProcRef field in Table XXII by using the lookup key received in step 1030.

In step 1033, the procedure found in the lookup table is executed, following which, in step 1034, the resulting values produced by applying the business logic on the queue item received in step 1030 are returned to the process that invoked the custom business logic process, typically by continuing to step 1025 of FIG. 4, which may be a preferred order of execution.

Reference is now made to FIG. 6, which is a simplified flowchart illustration of a preferred method for implementing step 1011 of FIG. 3.

Depending on the queue, when a new queue item is submitted it may trigger the need to create new items in other queues. This situation may arise in a variety of scenarios. To address this issue, the queue manager 1000 preferably checks the dependencies of a new item when it is submitted. Queue manager 1000 is also preferably operative to automatically generate any necessary new entries to the respective queues of the dependencies.

As seen in FIG. 6, in step 1040, a new entry is received for dependency processing, typically from step 1025.

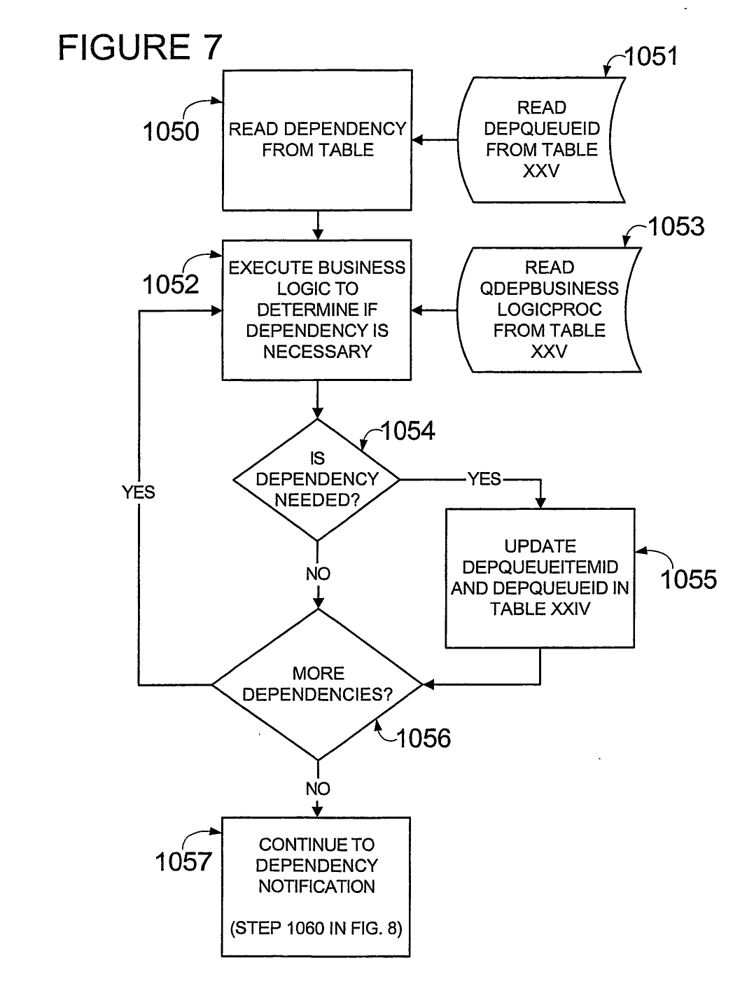

In step 1041, queue manager 1000 determines the dependencies of the item, as described hereinbelow in reference to FIG. 7. In step 1042, the generic inter-queue dependencies for this queue are identified, i.e. those that apply to all items in the queue, typically by performing a query of the DepQueueID field in Table XXV.

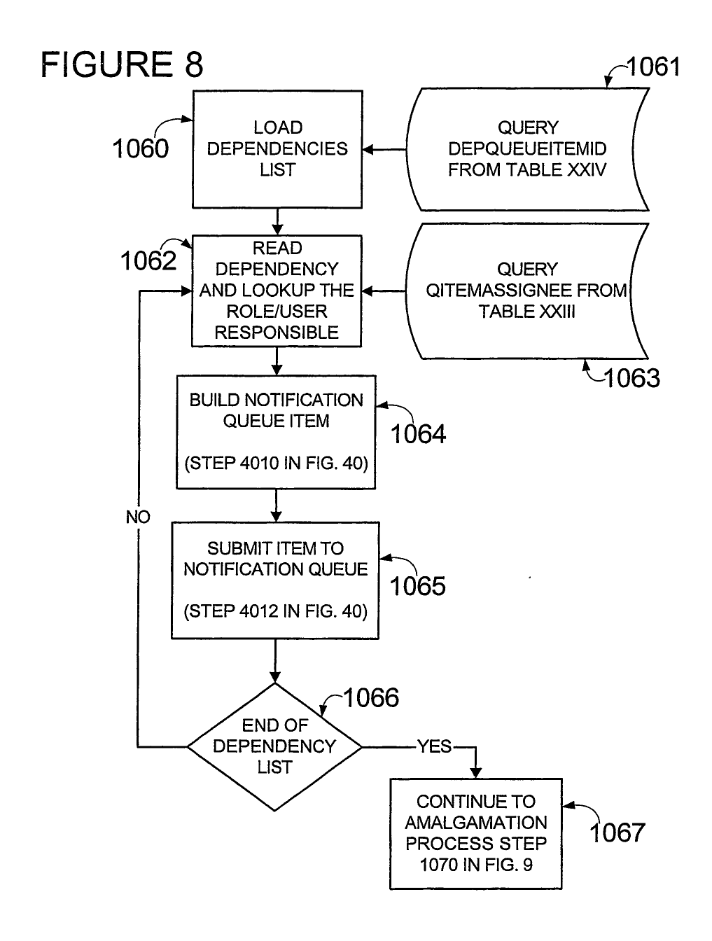

Step 1043 then determines if the database query of step 1042 produced any dependencies. If dependencies exist, the queue manager 1000 then proceeds to step 1044, and submits the dependencies to the necessary queues by invoking step 1060 of FIG. 8 as applicable for each queue. The process then continues to the dependency notification process, described hereinbelow with reference to FIG. 8. If no dependencies exist, the process then returns, in step 1045, to step 1012 of FIG. 3.

Reference is now made to FIG. 7, which is a simplified flowchart illustration of a preferred method for implementing step 1041 of FIG. 6.

As seen in FIG. 6, in step 1050, queue manager 1000 reads the standard dependencies for the queue type it is operating on from the dependency table. These are the dependencies that apply to the current queue item, all things being equal.

In a preferred embodiment of the present invention, the standard dependencies for all queue types are stored in Table XXV. As seen in step 1051, the queue manager 1000 reads the DepQueueID field from Table XXV to determine the queues that this queue is dependent on.

In step 1052, the business logic preferably determines, on a case-by-case basis, which of the dependencies are needed. The applicable business logic to be used for dependency determination is read from the database by step 1053, preferably by reading the QDepBusinessLogicProc field from Table XXV. Upon execution of the applicable business logic, queue manager 1000 determines if the dependency currently under consideration is necessary for the queue item or not, and returns a flag indicating if dependencies exist, and if so, the queue items which the current item is dependent upon.

As seen in step 1054, if the dependency flag is set to ‘yes’ the queue manager 1000 then preferably executes step 1055. In step 1055, a reference is preferably created to link the dependency to the current queue item, by inserting an entry in Table XXIV, typically by updating the DepQueueItemID and DepQueueID fields, that links both dependent entries. The dependency may be processed once the processing of the current queue item is complete.

As seen in step 1056, queue manager 1000 then checks to see if there are additional dependencies. When there are additional dependencies to be processed, the queue manager proceeds to repeat steps 1052 through 1055, as necessary. When all dependencies have been checked, queue manager 1000 proceeds as shown in step 1057, to the dependency notification process, described hereinbelow with reference to step 1060 of FIG. 8.

Reference is now made to FIG. 8, which is a simplified flowchart illustration of a preferred method for implementing step 1044 of FIG. 6.

As seen in FIG. 8, in step 1060 the list of dependencies for which notifications may be generated are loaded, typically, as seen in step 1061, by a lookup against the DepQueueItemID field in Table XXIV.

As seen in step 1062, each dependency may produce a queue item that is typically addressed by a designated role or user. Table XXIII preferably maintains a map that contains the role or user responsible for each type of dependency that may be generated by the queue manager. The appropriate role or user is preferably determined, as seen in step 1063, by executing a query on the QItemAssignee field of Table XXIII to determine the assignee for the selected queue type and dependency. The assignee may be an D or the user or role assigned to handle entries of the selected queue.

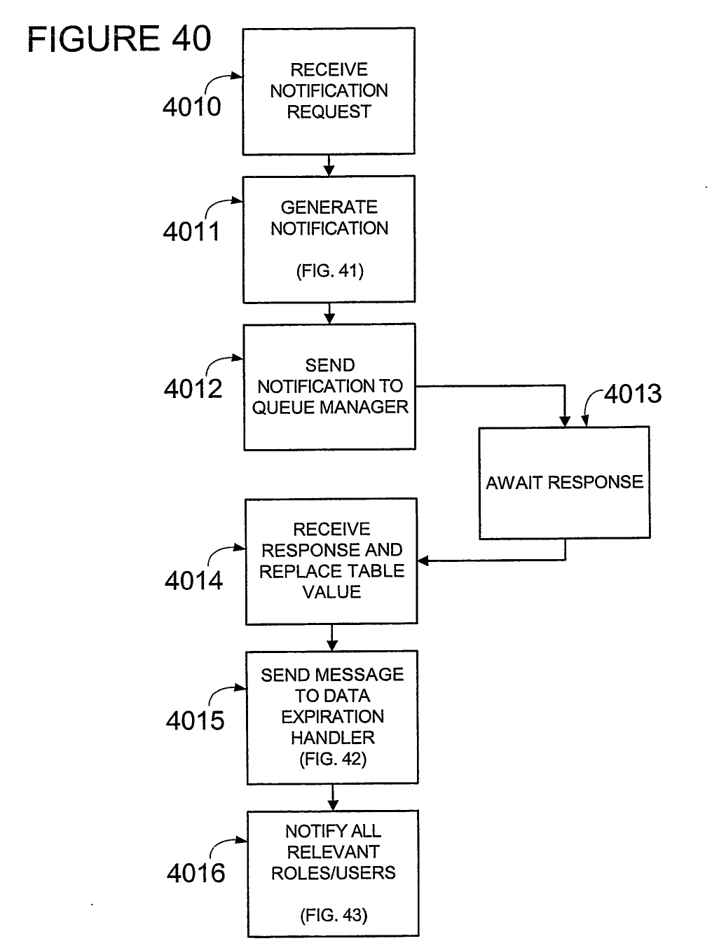

As seen in step 1064, a notification queue item is generated. The notification queue item typically contains information to tell the role or user responsible for the dependency what input is needed. The notification queue item has a link to its creator, so that the creator may know once it has been fulfilled. The notification queue item is described hereinbelow with reference to the processing beginning at step 4010 of FIG. 40.

In step 1065, after the notification queue item has been created, it is submitted to the notification queue for processing after the current queue has been fully updated. As seen in step 1066, the queue manager 1000 then checks to see if there are more dependencies to be processed. If yes, the dependency notification process continues by repeating steps 1062-1065. When all the dependencies have been dealt with, the queue manager 1000 proceeds, as shown in step 1067, to the amalgamation process, described hereinbelow with reference to step 1070 of FIG. 9.

Reference is now made to FIG. 9, which is a simplified flowchart illustration of a preferred method for implementing step 1012 of FIG. 3.

As described hereinabove, the commodity trading system of the present invention looks for possibilities of amalgamating items in queues. The goal is to identify opportunities for increased efficiency.

In step 1070, a new queue entry is received from the dependency processing stage. In step 1071, an amalgamation check for the new queue item, as described hereinbelow with reference to steps 1080 onward of FIG. 10, is preferably performed against the next existing queue item. As seen in step 1072, if an amalgamation opportunity is identified, the entry is marked for amalgamation, as seen in step 1073, preferably by updating the QItemBaseAmalgamationQID field in Table XXIII with the QueueItemID of the queue item with which amalgamation may occur. This amalgamation process thereby allows multiple queue items to be amalgamated into a single queue item.

As seen in step 1074, the queue manager 1000 then checks to see if there are more entries to check for amalgamation. If more entries exist, the queue manager then repeats steps 1071-1073 for the next queue entry to be checked for amalgamation. When all of the entries have been checked, the queue manager 1000 proceeds, as shown in step 1075, to the prioritization process, described hereinbelow with reference to step 1090 of FIG. 11.

As part of the process described hereinabove, the items that were marked for amalgamation are preferably labeled to show this new state. Amalgamated items may be further amalgamated with other items in the future.

Reference is now made to FIG. 10, which is a simplified flowchart illustration of a preferred method for implementing step 1071 of FIG. 9.

The amalgamation process evaluates each item in a queue using references to external processes for evaluation. These processes preferably may be customized for each individual embodiment, and may be written in any suitable programming language, such as SQL or Java. FIG. 10 illustrates the logic used to determine whether or not a queue item is a candidate for amalgamation with other similar queue items.

In step 1080, the item record for the current queue item being considered, typically one of the existing queue items, is loaded, preferably, as seen in step 1081, by performing a lookup against QueueItemID field in Table XXIII.

As seen in step 1082, the queue manager then applies the business logic, typically, as seen in step 1083, by querying and executing the QbusinessLogicAmalgamationProc field in table XXII, to determine if the current queue item should be amalgamated with the new queue item.

As seen in step 1084, if the amalgamation is determined not to be appropriate the result is set to ‘no’ in step 1085. If the amalgamation is determined to be appropriate, then, as seen in step 1086, the database is updated, preferably by setting the QItemStatus field to ‘amalgamated’ and by setting the QItemAmalgamationQID field to the QueueItemID of the base queue item ID with which the queue item was amalgamated. Additionally, as seen in step 1087, the amalgamation result for the two items is returned to the amalgamation process, described hereinabove with reference to step 1072 in FIG. 9.

Reference is now made to FIG. 11, which is a simplified flowchart illustration of a preferred method for implementing a sorting process, as shown in step 1013 of FIG. 3. The sorting process orders the items in a queue, governed by pre-programmed business logic.

As seen in step 1090, a new queue item is inserted in the queue at an arbitrary position, typically at the end of the queue. In step 1091, queue manager 1000 creates a temporary storage buffer and in step 1092, all queue items are loaded into the temporary storage buffer for the purpose of sorting. As seen in step 1093, information pertaining to the queue items, which is stored in Table XXIII, is preferably retrieved by a lookup against the QueueItemID field.

In step 1094, the business logic for sorting the particular queue is preferably retrieved from the QBusinessLogicPriorityProc field of Table XXII. In step 1095, the referenced external business logic process for sorting is executed. In step 1096, following the sorting of the queue, the order of the queue items is stored, typically in the QItemOrder field of Table XXIII, as seen in step 1097.

Reference is now made to FIG. 12, which is a simplified flowchart illustration of a preferred process for user-triggered or periodic resorting and amalgamation of a selected queue in the queue manager 1000 of FIG. 1. Queue manager 1000 typically updates the queues on a periodic basis. This preferably allows for changes of priority of queue items, resorting, and new amalgamations, where appropriate.

As seen in step 1110, a source external to the commodity trading system, such as the operating system, typically generates a signal on a periodic basis to triggers the update process for the queues. In step 1111, the next queue item is read and checked to see if its status has changed (as is described in step 1005 of FIG. 2), preferably by retrieving the QueueItemID field from Table XXIII, as seen in step 1112.

In step 1113, branching occurs based on the status change result. In step 1114, the queue item is updated as appropriate. For example, the status may change.

In step 1115, if more items remain to be checked a loop back occurs to handle the next item. If no items remain to be updated, then the process proceeds to amalgamation.

Step 1116 executes the amalgamation process, shown in FIG. 9 and beginning at step 1070 therein, on the current queue.

Step 1117, executes the sorting process, shown in FIG. 11 (beginning at step 1092), on the current queue. In step 1118, the update is complete and the queue manager 1000 returns to regular processing.

Step 1119 stores the updated Queue Item's data in Table XXIII using the QueueItemID field as the lookup field.

Reference is now made to FIG. 13, which is a simplified flowchart illustration of a preferred method for implementing step 1003 of FIG. 2. When an update is received from an external source the queue manager 1000 propagates the information to storage and if possible completes processing of the queue item.

In step 1130, queue manager 1000 receives updated information. In step 1131, the information is stored in the database, as seen in step 1132. Queue items are stored in Table XXIII and are updated based on the queue item's key stored in QueueItemID of that table. In step 1133, if the item has no dependencies or if the item's dependencies have been satisfied then the item may be considered complete.

In step 1134, branching occurs depending of whether the queue item has reached completion. In step 1135, if the queue item is not yet considered complete because its dependencies have not yet been satisfied, then it remains in the queue. In step 1136, if the queue item has been completely updated then the queue manager 1000 proceeds to the completion process, which is depicted in FIG. 14.

Reference is now made to FIG. 14, which is a simplified flowchart illustration of a preferred method for implementing step 1136 of FIG. 13.

In step 1140, queue manager 1000 sets the status of the queue item to complete. In step 1141, a check is done to see if any items in other queues are dependent on this queue item. This check involves loading the queue record and looking at its dependent fields to see if any other queue items are dependent on it.

In step 1142, Table XXIV stores the mapping of all dependent queue items, which are retrieved from the DepQueueItemID field in that table.

In step 1143, branch based on whether there are any dependents to be informed of the queue item's change in status. Step 1144 informs the queue items that are dependent on the current queue item that its status has changed to complete. This may allow their status to reach complete, also.

Step 1145 moves the queue item from its current queue to long-term storage. The queue item may remain there indefinitely.

In step 1146, all completed queue items are moved from Table XXIII to Table XXVI. In step 1147, the update information is propagated to the location referenced by QItemLinkRef field in the in Table XXIII. This is the location, in the various system databases or external data sources, where the data for which the queue item was responsible for resides. In step 1148, the external process which is referenced by QEXRCOMPPROCREF in Table XXII is invoked, thereby optionally taking additional action as defined.

Reference is now made to FIG. 15, which is a diagram of a full cycle of operations by which the queue manager 1000 determines the various dependencies of items within a queue. This diagram shows the order of dependency processing. Two queue items are depicted having dependencies and the third does not.

In step 1160, a new item is received by the queue. After assigning a priority and status to the new queue item the queue manager 1000 determines if the item has any dependencies.

In step 1161, if the item has dependencies then they are processed after the original item. As seen in step 1162, once the item has been processed it resides in its queue waiting to receive a response.

In step 1163, after some time the queue item may receive a response. This response may allow the item to be completed if it has no dependencies or if its dependencies have also been completed.

In step 1164, if the queue item has one or more dependencies then it may have to wait for them to be completed before it can be completed. When the item receives an indication that its dependencies have been completed a check is made to see if the item has now been completed.

As seen in step 1165, once a dependency has been completed an indication of this occurrence may be propagated back to its creator.

In step 1166, if the item and its dependencies have all received the appropriate responses then the item can be considered complete. In this case the procedure continues to completion. Otherwise, the item continues to reside in its queue until the necessary information is supplied.

In step 1167, the data received from the user is propagated to its appropriate storage location and the queue item is moved to long-term storage.

Reference is now made to FIG. 16, which is a simplified flowchart illustration of a preferred method of operation for the physical commodity transaction builder 2000 of FIG. 1. The physical commodity transaction builder 2000 (PCTB) allows the user to request the system to generate a plurality of recommended potential transaction that would fall within certain specifications. The recommended potential transactions are created by analyzing historical data and user specifications and computing hypothetical transactions that fall within the requested parameters and would be most advantageous for the user to pursue.

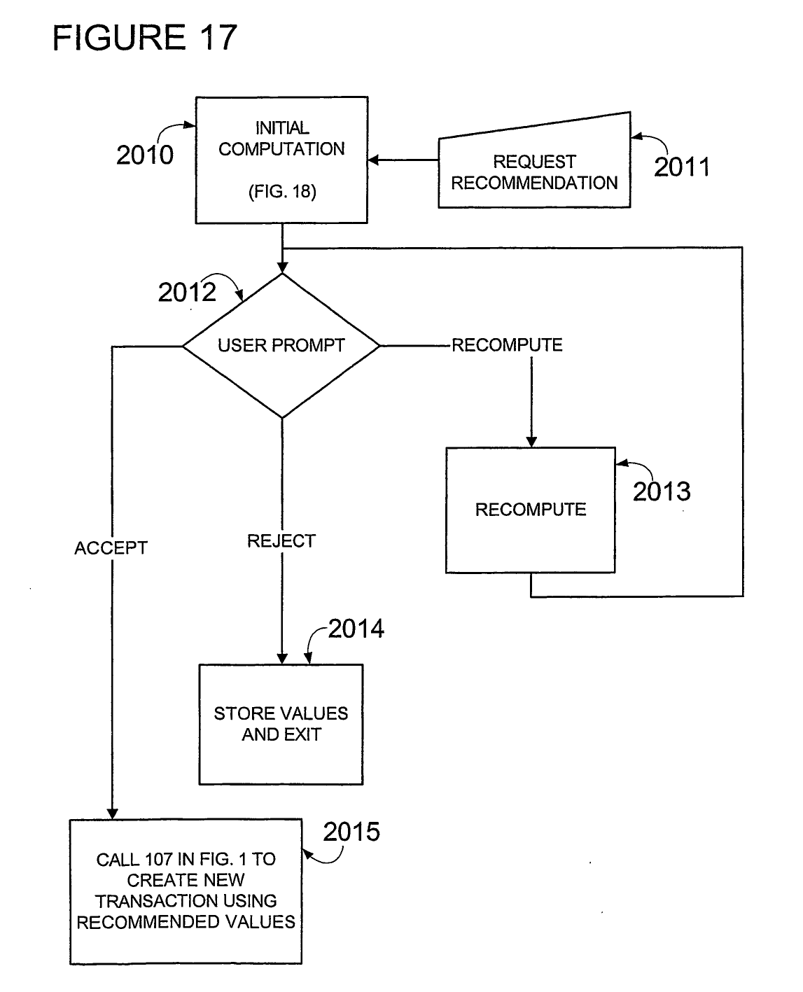

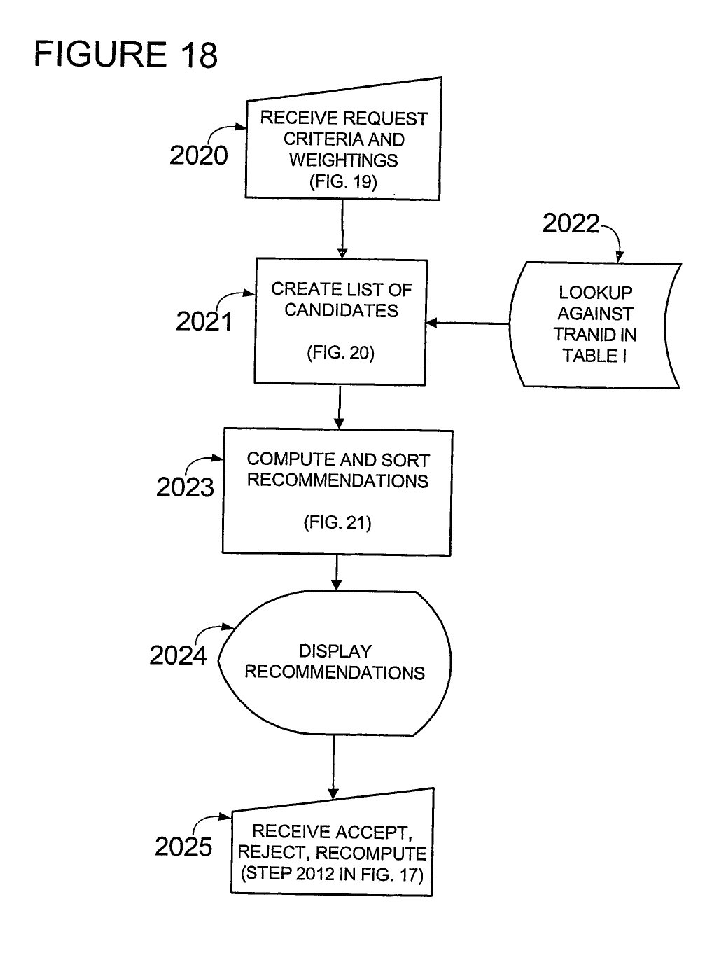

In step 2001, a recommendation for a potential transaction is requested by invoking the PCTB 2000, thereby executing step 2010 of FIG. 17. In step 2002, the result of PCTB 2000 being invoked may either be the creation of a new transaction or the rejection of all suggested transactions. In step 2003, if one of the recommendations generated by the system merits further exploration it can be used as a basis for creating a new transaction. In that case, a new transaction is opened once the recommendation process has been completed. In step 2004, if all the recommendations generated by the PCTB 2000 fail to satisfy the needs of the trading system operator, then they can be rejected once the process is complete.

Reference is now made to FIG. 17, which is a simplified flowchart illustration of a preferred method for implementing step 2001 of FIG. 16. This diagram shows the overall flow of the PCTB 2000. Recomputation can be performed as many times as is necessary to yield a useful result, with each recomputation optionally preceded by a modification of the biasing parameters. The eventual outcome may be either the creation of a new transaction or rejection of all recommendations.

In step 2010, the initial computation is executed using the initial set of weightings, as outlined in FIG. 18, step 2020 and onwards. The result can be accepted as the basis for a transaction. Alternatively, the weightings can be adjusted and a recomputation performed. Otherwise, the result can be rejected entirely.

In step 2011, the computation process is initiated by an external stimulus. In step 2012, depending on the appropriateness of the initial computation the next step is to accept, reject or recompute the result.

In step 2013, the recomputation is the same as the initial computation process with the weightings adjusted. In step 2014, in the event that all computation results are inappropriate then they can all be rejected. The Trading system may record the settings that were used to use as starting values the next time the PCTB 2000 is invoked.

In step 2015, if one of the recommendations is useful it can be used as the basis for a transaction invoked by the transaction handler 107 in FIG. 1. In that case, the settings are stored for use the next time the PCTB 2000 is invoked.

Reference is now made to FIG. 18, which is a simplified flowchart illustration of a preferred method for implementing step 2010 of FIG. 17. FIG. 18 shows the basic flow for generating a recommendation. The request is computed using a series of weightings supplied to it from an external input, such as a user interface or an external program.

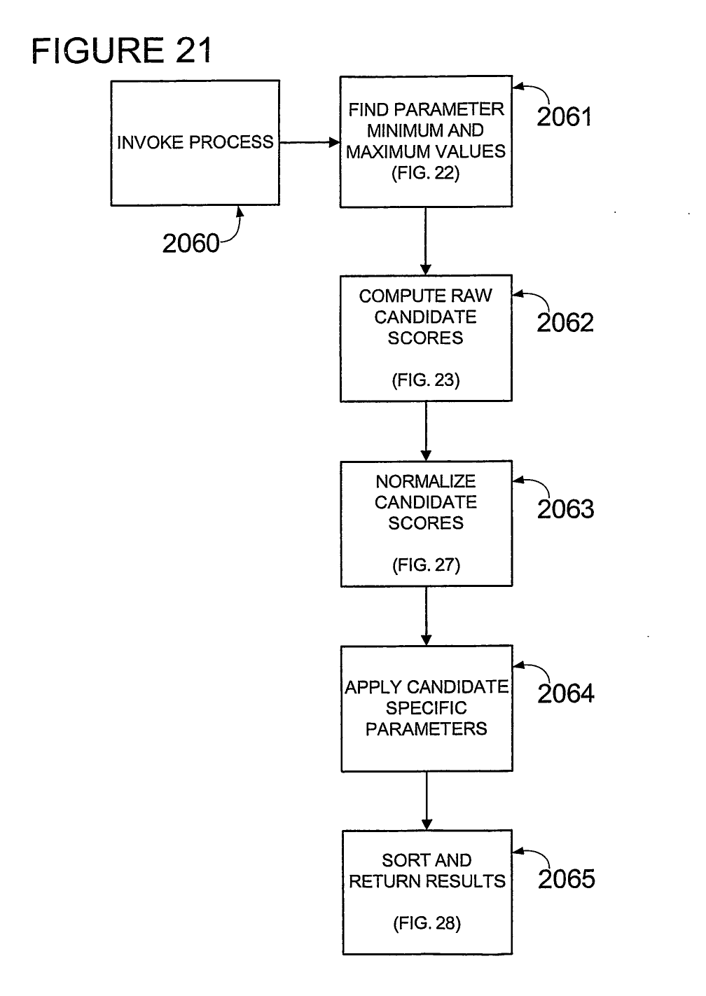

In step 2020, PCTB 2000 receives the specified weightings and other criteria for processing a recommendation. In step 2021, using the information received, the PCTB 2000 creates a list of candidates for the recommendation, as outlined in step 2040 of FIG. 20. In step 2022, Table I contains the information from all transactions the trading system has executed, and is referenced by a lookup on the TranID field. In step 2023, the candidates are processed to generate scores for each of them. These scores are determined by applying the weightings as well as by applying computations to specific parameters, based on the process depicted in FIG. 21, commencing at step 2061. The scores are sorted for presentation.

In step 2024, the recommendations are displayed by the trading system. In step 2025, there are three possibilities. The recommendations can all be rejected or one can be accepted or a recomputation can be performed.

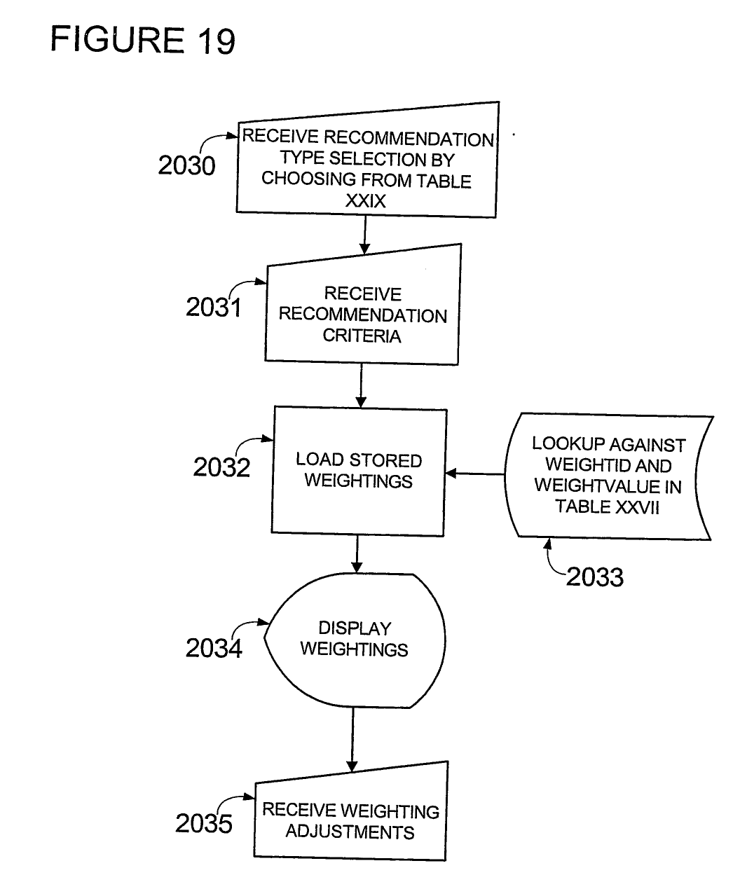

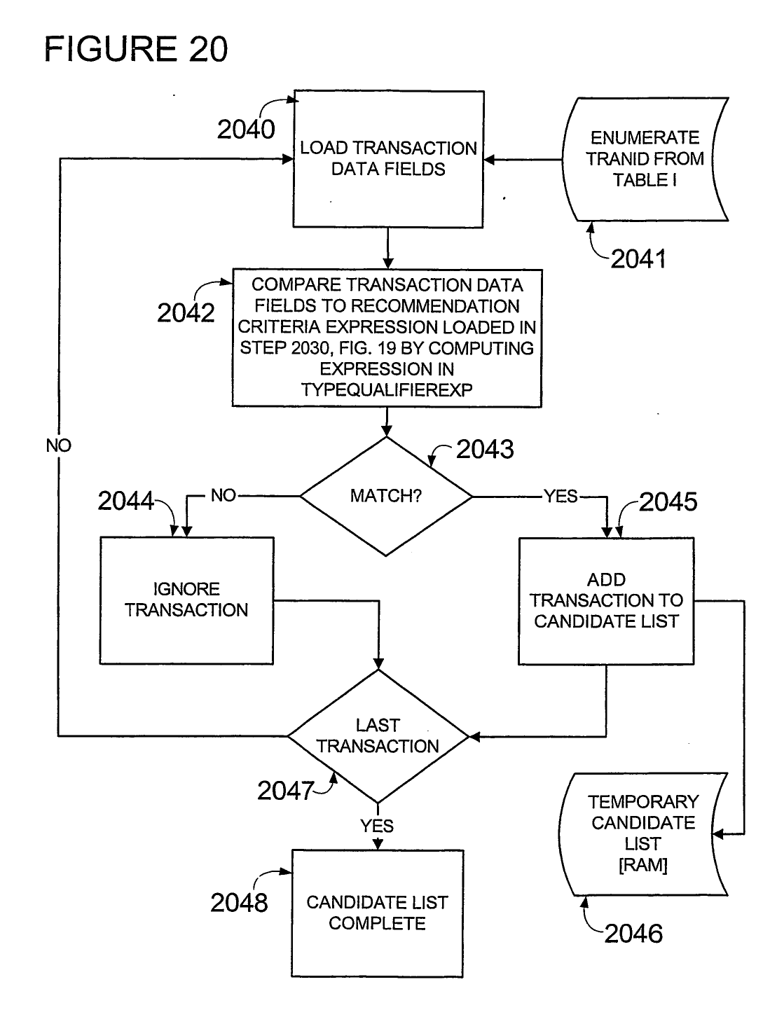

Reference is now made to FIG. 19, which is a simplified flowchart illustration of a preferred method for implementing step 2020 of FIG. 18. Many types of recommendations can be generated depending on the criteria supplied. The type of recommendation chosen determines the set of weightings that may be used. The weightings allow the Trading system to produce the recommendation that may be the most appropriate for the purposes of the system user.

In step 2030, multiple types of recommendation can be generated, as selected by the user, or external process, from amongst the set of options returned by a query against TypeID in Table XXIX. Each such recommendation type has a different set of parameters that are taken into consideration. In step 2031, specific criteria are specified to ensure that the recommendation meets produces the desired result. The recommendation type selected in step 2030 is used as a lookup key against TypeTargetExp in Table XXIX to determine which type of recommendation to produce.

In step 2032, the last set of weightings used for recommendation computation is loaded from the table and the values for the specific user are loaded from Table XXVII by enumerating WeightID and WeightValue. In step 2033, the user's previous weighting values for stored in the RecWeightsMap database. Every time a recommendation is generated the set of weightings is stored as a reference for the next time the process is invoked. In step 2034, the weightings that were loaded are displayed so that the trading system operator knows the current values. In step 2035, in order to produce the optimal recommendation, the weighting values are adjusted to reflect the most important factors for this iteration of the procedure.

Reference is now made to FIG. 20, which is a simplified flowchart illustration of a preferred method for implementing step 2021 of FIG. 18. In the course of generating a recommendation all the items in the historical data are checked. If an historical transaction meets the criteria it is added to a list of candidates. Only these candidates may be considered for the recommendation computation.

In step 2040, transactions are loaded from Table I and considered one at a time for relevance to the current recommendation being generated. Step 2041 is the store of all the transactions that have been completed using the trading system.

In step 2042, the transaction currently under consideration is matched against the recommendation criteria by comparing each transaction to the expression contained in the TypeQualifierExp field of Table XXVII for the selected recommendation type to determine if the transaction may be used in this iteration of the recommendation generation process.

In step 2043, branching occurs based on the result of the criteria matching operation. In step 2044, if the transaction does not match the recommendation criteria then it is ignored. In step 2045, if the transaction matches the recommendation criteria it is stored in a list of candidates. In step 2046, candidates are stored in a temporary buffer, typically RAM (Random Access Memory) during the recommendation generation process. In step 2047, a check is performed to determine if all stored transactions have been considered for inclusion in the candidate list. If so, then the process continues to the next step. Otherwise the next transaction stored in the historical transaction database in step 2041 is read and considered.

In step 2048, the candidate list has been complete and the process continues to the next step, which is shown in FIG. 21.

Reference is now made to FIG. 21, which is a simplified flowchart illustration of a preferred method for implementing step 2023 of FIG. 18. FIG. 21 shows the flow for computing a recommendation. It is executed each time a new recommendation is generated.

In step 2060, the process starts once the candidate list has been determined. Step 2061 finds the minimum and maximum values for each parameter amongst all candidates. These values may be used in process of computing the raw candidate scores.

Step 2062 computes the raw, non-normalized, scores by applying the “user” and “management” weightings to the candidates' parameters using the values referenced in Table XXX, as selected by a lookup to Table XXVII. Step 2063, normalizes the raw scores so that an easier comparison of the candidates is possible. Step 2064 applies additional specific parameters. These are considered in order to reflect important factors such as the current position of a particular product. In step 2065, the results are sorted in order from highest to lowest.

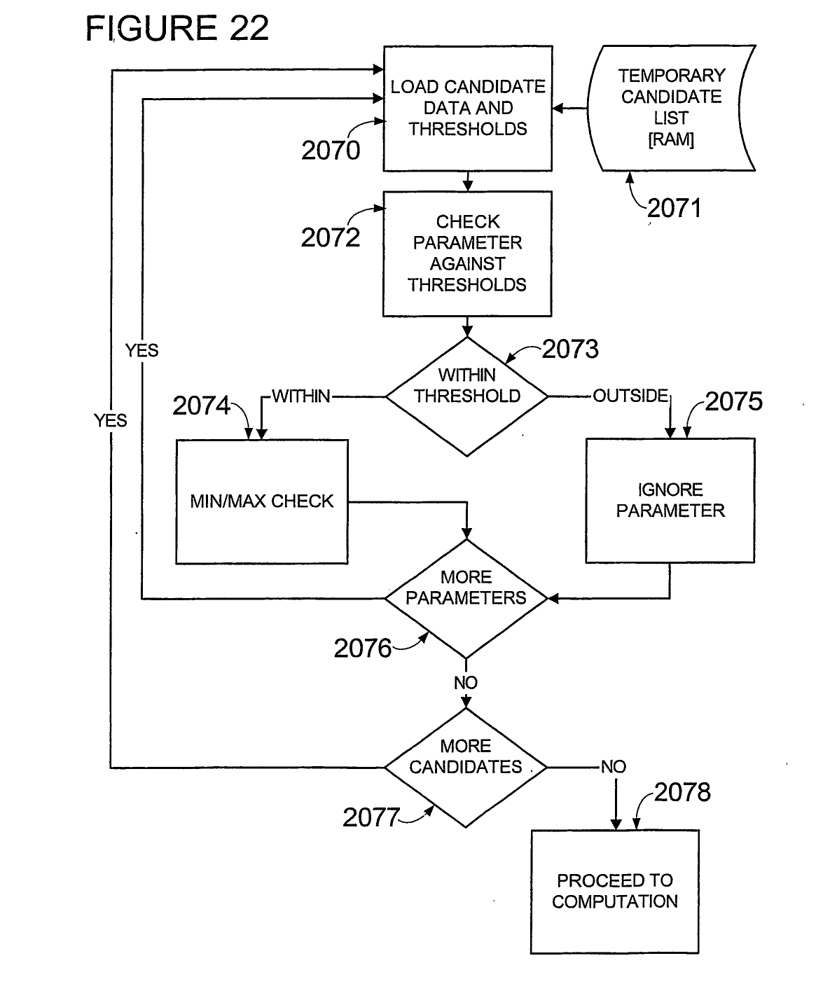

Reference is now made to FIG. 22, which is a simplified flowchart illustration of a preferred method for implementing step 2061 of FIG. 21. In order to normalize the candidates being considered, the Trading system determines the maximum and minimum value for each parameter under consideration. The determination of the maximum and minimum parameter values is done by searching through the list item by item and checking if its parameter values are beyond the maximum values determined to that point. The maximum and minimum values once determined are stored for use in the recommendation computation process.

Step 2070 loads the candidate from temporary storage to check its parameters. Load the thresholds from the thresholds database. In step 2071, the candidates were stored in a temporary buffer in step 2046 in FIG. 20. Thresholds are stored in the RecThresholds database. Step 2072 compares each parameter against the upper and lower threshold values. In step 2073, branching occurs depending on whether the parameter is within or outside threshold values. In step 2074, if the parameter is outside the thresholds it is ignored so as not to distort the computation results. In step 2075, if the parameter is within the thresholds then check if it is a new minimum or maximum. If the parameter value is below the minimum then a new minimum has been found. The parameter value is then stored as the new minimum. Likewise, if the parameter value is above the maximum it becomes the new maximum. In step 2074, minimum and maximum values are held in a temporary storage buffer. Step 2076 checks if the current candidate has any more parameters that have not yet been processed. If so, loop back and process the next parameter. Otherwise, continue to the next step of the process.

Step 2077 checks if there are any more candidates in the candidate list which have not yet been processed. If so loop back and process the next candidate. Otherwise, continue to the next step of the process.

In step 2078, the determination of the minimum and maximum values for each parameter has been completed. The process continues to the computation of the raw scores.

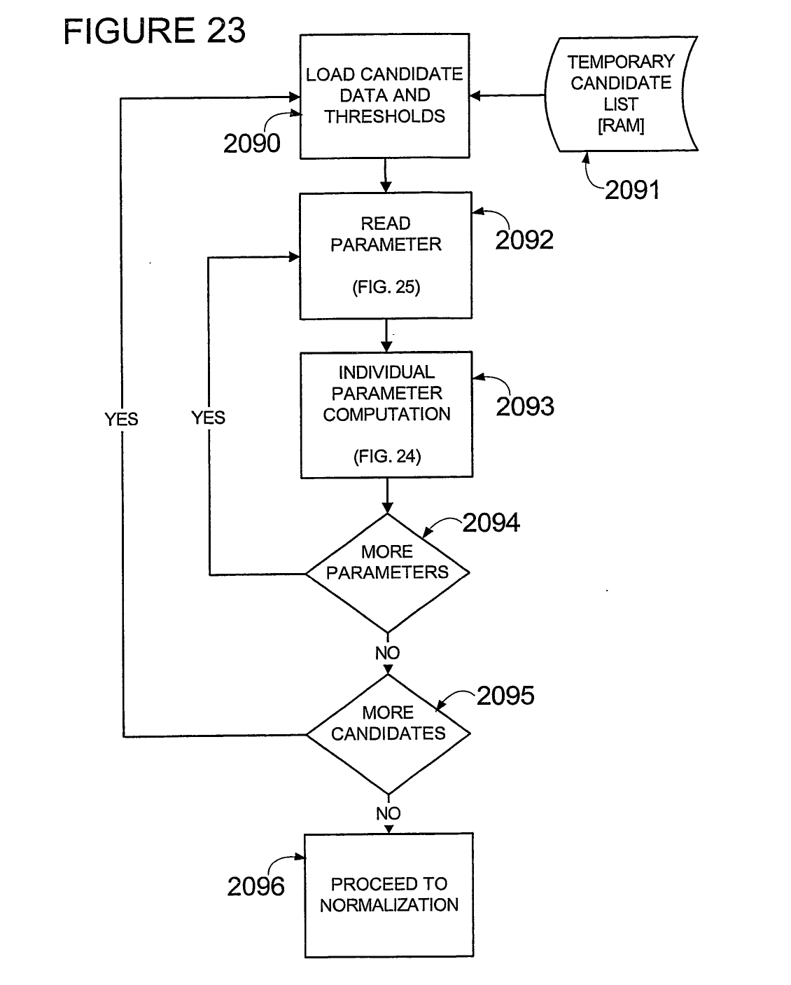

Reference is now made to FIG. 23, which is a simplified flowchart illustration of a preferred method for implementing step 2062 of FIG. 21.

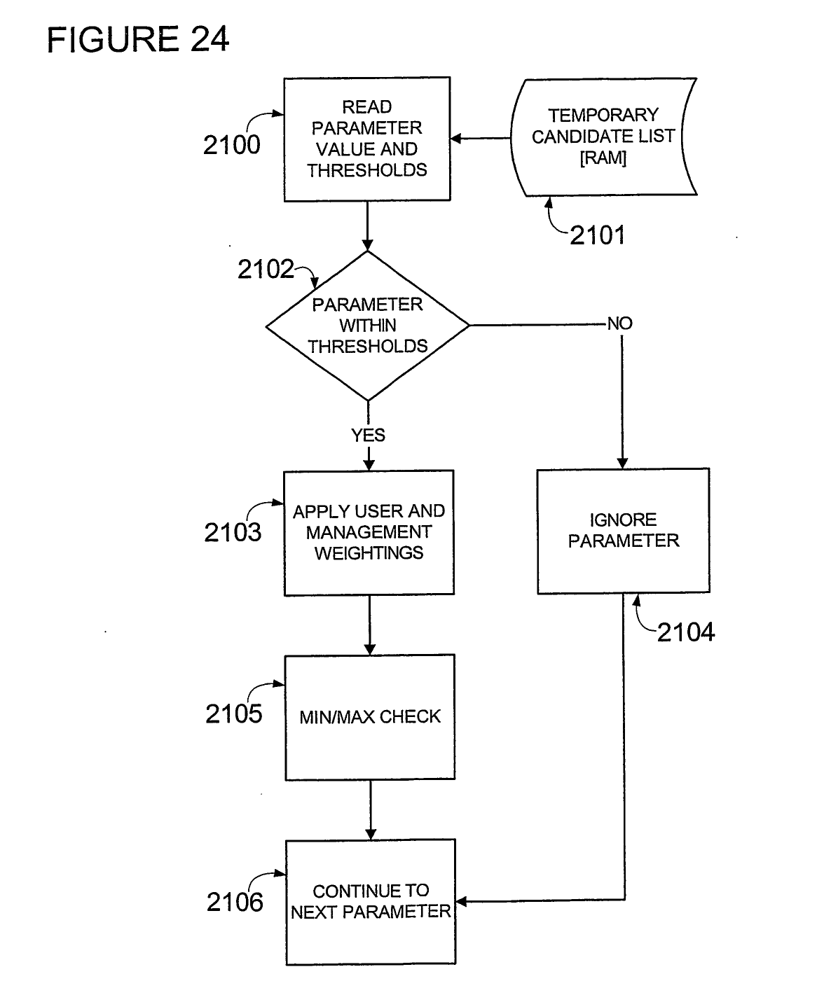

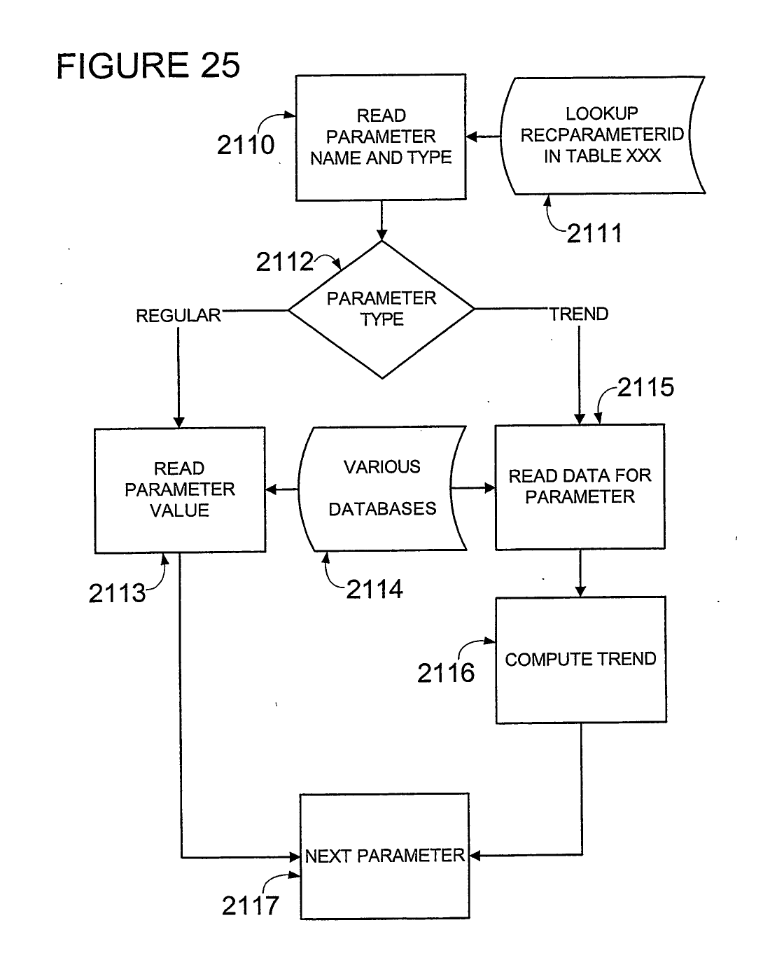

In step 2090, the candidate's data and applicable thresholds are loaded from temporary storage. In step 2091, the candidate list and thresholds were previously loaded into temporary storage, typically RAM (Random Access Memory), to be accessible for this processing stage. In step 2092, the parameter is read from storage. This process differs for regular parameters or trend parameters. FIG. 25 shows the details of this step. In step 2093, the parameter value is processed with the user and management values. The process is shown in FIG. 24.

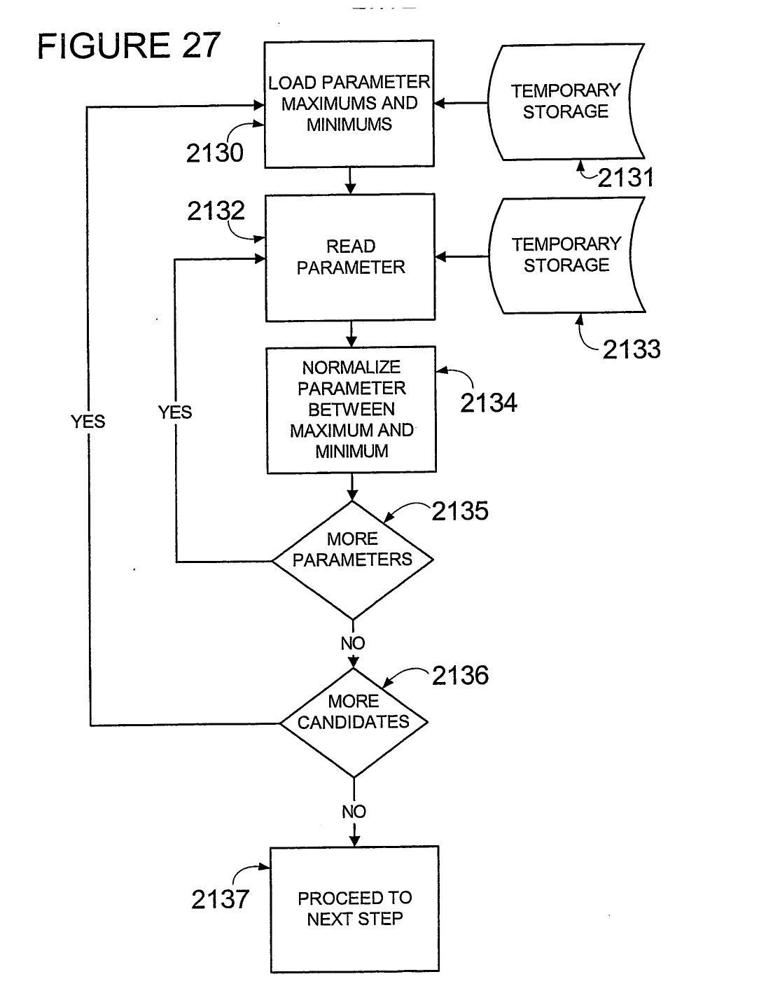

In step 2094, branching occurs depending on whether parameters remain to be computed. If any parameters remain, the process loops back to step 2092. Otherwise, the process proceeds to step 2095. In step 2095, branching occurs depending on whether any candidates remain to be computed. If any candidates remain, the process loops back to step 2090. Otherwise, the PCTB 2000 proceeds to the normalization process shown in FIG. 27, as shown in step 2096.

Reference is now made to FIG. 24, which is a simplified flowchart illustration of a preferred method for implementing step 2093 of FIG. 23. In order to determine which transaction or transactions to recommend the weightings are applied to the set of candidates. This computation preferably results in higher scores for transactions that most closely match the desired outcome.

In step 2100, the parameter under consideration and its applicable thresholds are loaded. In step 2101, the parameters are queried from a temporary storage location, having been loaded during the previous check for minimum and maximum values, shown in FIG. 22. The same is true for the thresholds.

In step 2102, branching occurs based on the result of a comparison between the parameter and the thresholds. If the parameter is within the thresholds it may be used. If not, it may be ignored. In step 2103, a formula is used to compute the result. The first stage of the formula uses the values of the parameter, the previously determined minimum and maximum and the user weighting. This initial result is subsequently used in a formula along with the management weightings to produce the weighted parameter value. As seen in step 2104, if a parameter value is beyond the thresholds it may be ignored. In this case, its contribution to the result is zero. In step 2105, the minimum and maximum check is performed on the weighted parameter value. This check produces a new list of minimums and maximums to be used in the normalization process, which is shown in FIG. 27.

In step 2106, once the parameter currently under consideration has been processed, the PCTB 2000 continues with the next parameter.

Reference is now made to FIG. 25, which is a simplified flowchart illustration of a preferred method for implementing step 2092 of FIG. 23. The PCTB 2000 evaluates an embodiment-specific set of parameters during the recommendation generation process. FIG. 25 illustrates how both single-valued parameters and trend parameters, which are series of identical parameters spanning a certain time period, are handled.

In step 2110, the parameter name and type are read from the parameter storage. In step 2111, a lookup against RecParameterID in Table XXX is performed. In step 2112, depending on the parameter type, two different reading processes may be executed. Branching occurs according to the type of parameter. In step 2113, parameter values are read from the transaction database, any other database in the system or an external data-source. The RecParameterSource field contains a reference to the source of such data. In the case of single-valued parameters, the most recent value is read. In step 2114, single-valued parameters are read directly from the data source referenced in the RecParameterSource field of Table XXX, with the most recent value used. In step 2115, for trend parameters all data values for the specified time period for the parameter are read into memory. In step 2116, a trend computation is performed on the data for the parameter. Once the parameter has been read, step 2117 proceeds to the next step of the process.

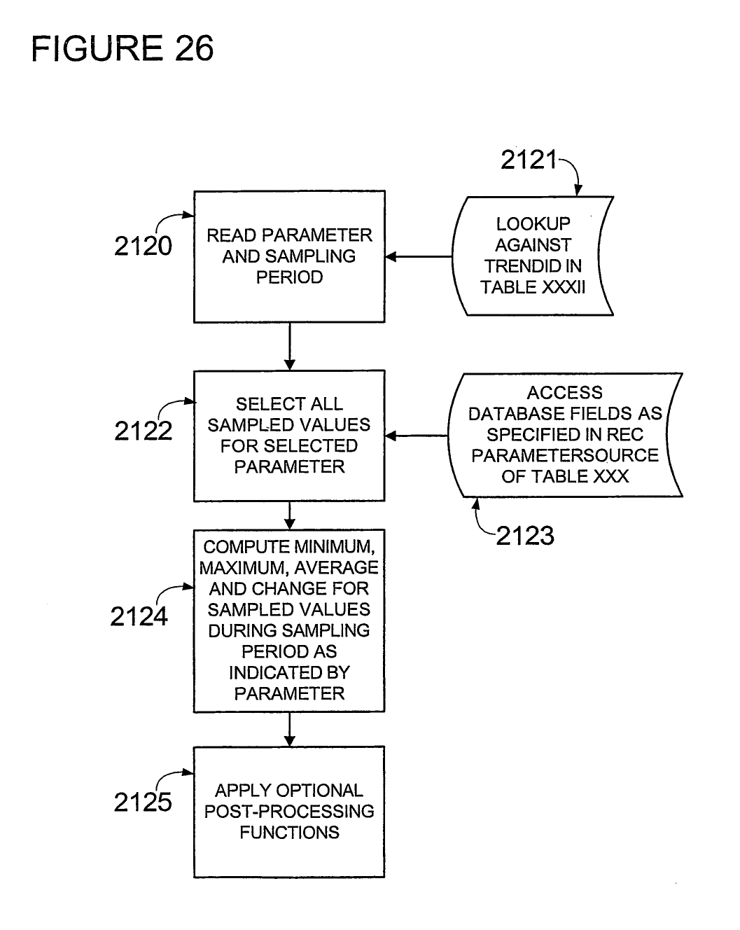

Reference is now made to FIG. 26, which is a simplified flowchart illustration of a preferred method for implementing step 2116 of FIG. 25. Trend parameters allow the use of data sampled over a period of time in the recommendation process.

In step 2120, the parameter to be sampled and the sampling period are read. Step 2121 queries against the TrendID field in Table XXXII. Step 2122 reads data from various database using location references stored in field TrendSource of Table XXXII and loads all the values that fall within the sampling period. As seen in step 2123, any table in any database accessible to the system may be queried. Step 2124 determines the minimum and maximum of the parameters and computes the average and change using standard formulas. Step 2125 returns the result of the trend computation for use as a parameter in the recommendation generation process.

Reference is now made to FIG. 27, which is a simplified flowchart illustration of a preferred method for implementing step 2063 of FIG. 21. FIG. 27 describes the minimum and maximum computations for parameter values.

Step 2130 loads the previously computed minimum and maximum values for each parameter. These may be used to provide the range within which the parameters of each candidate may be normalized. As seen in step 2131, the parameter values were held in temporary storage to be easily accessible and speed up processing. Step 2132 reads the next parameter for the candidate currently being normalized. The process preferably loops through all of this candidate's parameters before proceeding to the next candidate. As seen in step 2133, the weighted parameter values are held in a temporary storage location after being computed in the process depicted in FIG. 24. Step 2134 normalizes the parameter within the range of minimum and maximum using a standard normalization formula. In step 2135, if the candidate has parameters that have yet to be normalized then the process loops back and normalizes the next parameter. This continues until all the parameters of the current candidate have been normalized. As seen in step 2136, once the current candidate's parameters have all been normalized a check is made to see if any candidates remain with parameters needing to be normalized. If so, the next candidate is processed. As seen in step 2137, once all candidates' parameters have been normalized the PCTB 2000 proceeds to the next step in the process.

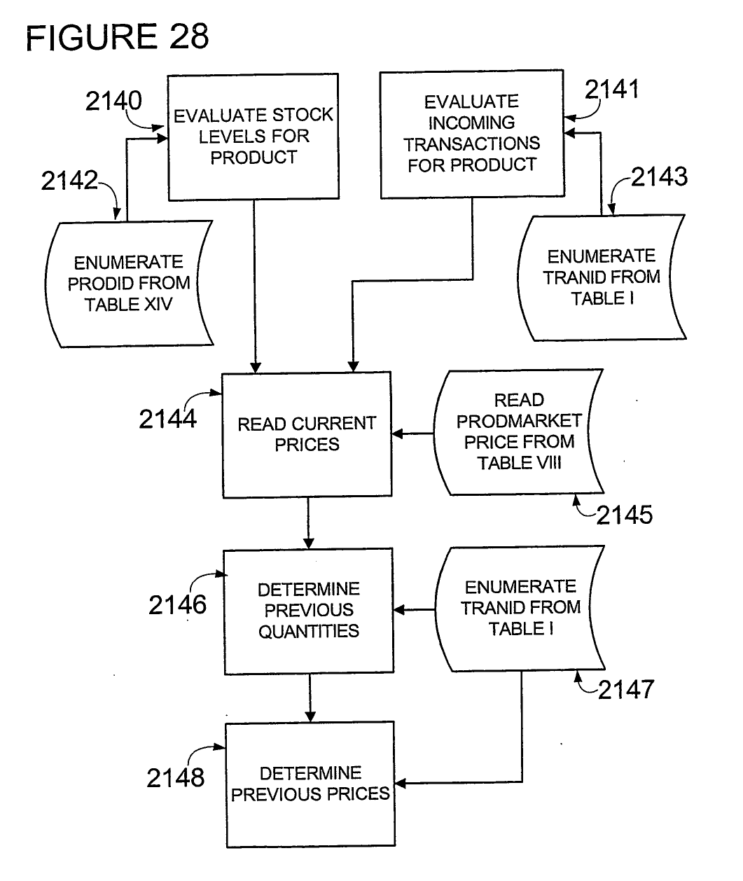

Reference is now made to FIG. 28, which is a simplified flowchart illustration of a preferred method for implementing step 2065 of FIG. 21. The candidate specific parameters are applied to reflect existing conditions that may be very influential in deciding which recommendation is the most appropriate. Such conditions include the current position for a given product and its current market price.

Step 2140 reads the stock levels for the selected. Step 2141 reads the future need for products that must be satisfied. As seen in step 2142, the stock Table XIV contains information for the current quantity on hand of various products. A query against the matching Product ID returns all pertinent stock levels. Step 2143 enumerates all transactions in Table I that match the selected Product ID and whose TransactionStatus field is set to 0 or 1.

Step 2144 reads the current prices to see if any transactions would be particularly favorable or unfavorable at the present time. As seen in step 2145, the market price database stores information on current prices for various products. Table VIII nominally stores this information, which is queried by a lookup against the ProdMarketPrice field, although this information may come from an external source or be updated by a Trading system operator.

Step 2146 determines the past quantities of a product that were involved in transactions. This gives useful information regarding what quantities could be reasonable in the future. As seen in step 2147, the transaction Table I stores information from past transactions. Information stored there includes quantity and price, and is queried by a lookup against the TranID field.

Step 2148 determines the past prices that have been paid for a given product. This can be a helpful guideline to determine reasonable prices for future transactions.

Reference is now made to FIG. 29, which is a simplified flowchart illustration of a preferred method of operation for the price chain builder 3000 of FIG. 1. The price chain builder 3000 is invoked from a transaction process. It facilitates the computation of a price for the transaction.

Once the chain has been fully updated it may be valid, “temporarily” valid, or invalid. This depends on the computation handlers that are being used in the chain. If any computation handlers have passed strict expiry then the overall chain may be invalid. If the chain contains no strict expiries, but one or more lazy expiry, then the result may be “temporarily” valid. If all of the computation handlers are currently valid, then the result may be that the computed result is valid.

In step 3001, the price chain builder 3000 optionally facilitates the creation of price chains for transactions, should the user or other calling process elect to do so. In step 3002, the user, or other calling process, indicates if the pricing chain logic should be applied to the selected transaction. If yes, step 3003 is executed and the result is returned by step 3005.

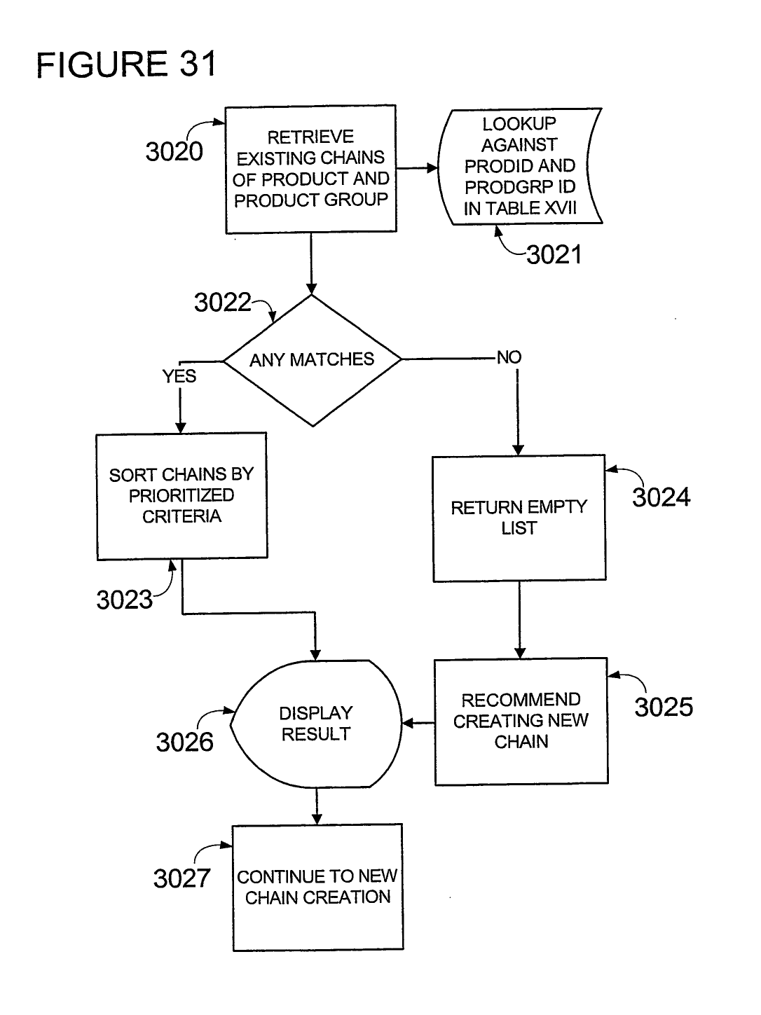

As seen in step 3003, creation of a price chain for a transaction is the principle function of the price chain builder 3000. FIGS. 31 to 35, 37 and 38 show the details of the new price chain creation process.

As seen in step 3004, should the pricing chain not be selected, then no result is returned and a manual computation must be made.

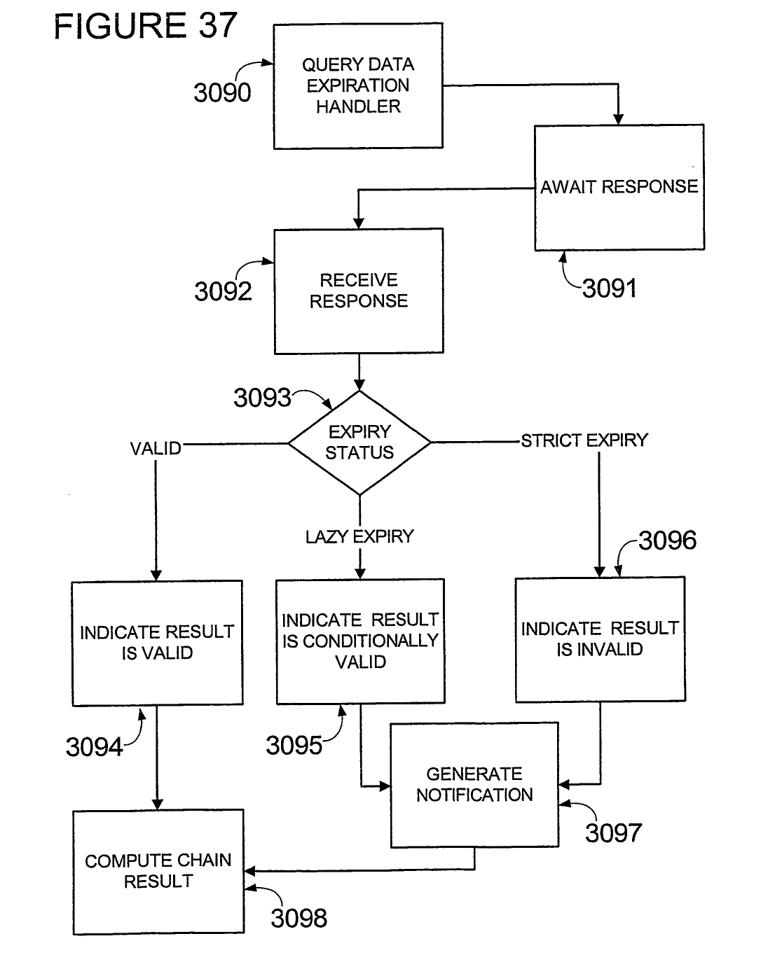

As seen in step 3005, the result of the pricing chain, as determined by step 3098 of FIG. 37, is returned.

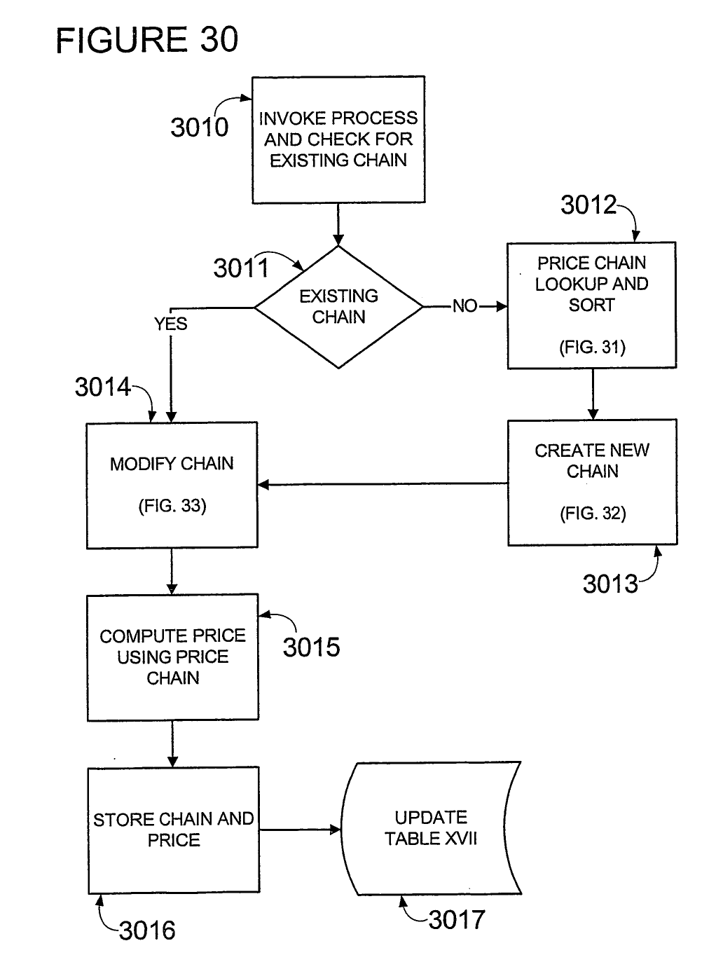

Reference is now made to FIG. 30, which is a simplified flowchart illustration of a preferred method for implementing step 3003 of FIG. 29. The processes of adding a price chain to a transaction or editing the one that is already present differ slightly. In the former case it is necessary to lookup all relevant price chains. A price chain is either selected from this list, to be associated to the transaction, or a completely new price chain is created for the transaction. In the case where a transaction already has a price chain associated with it, then this chain may be accessed automatically, so that it can be modified as needed.

As seen in step 3010, once the process has been invoked from a transaction a check is done to see if there is a price chain already associated with this transaction. In step 3011, depending on the result of the check for a price chain, branching occurs either to create a new price chain if the result is negative, or to modify the existing one if the result is positive.

As seen in step 3012, when creating a new price chain the easiest method is to duplicate a pre-existing price chain. In order to see if this course of action is possible a check is done to see if there are any relevant price chains that have already been created. If so, these are sorted in order of relevance and displayed for the trading system operator. More details of this process are shown in FIG. 31.

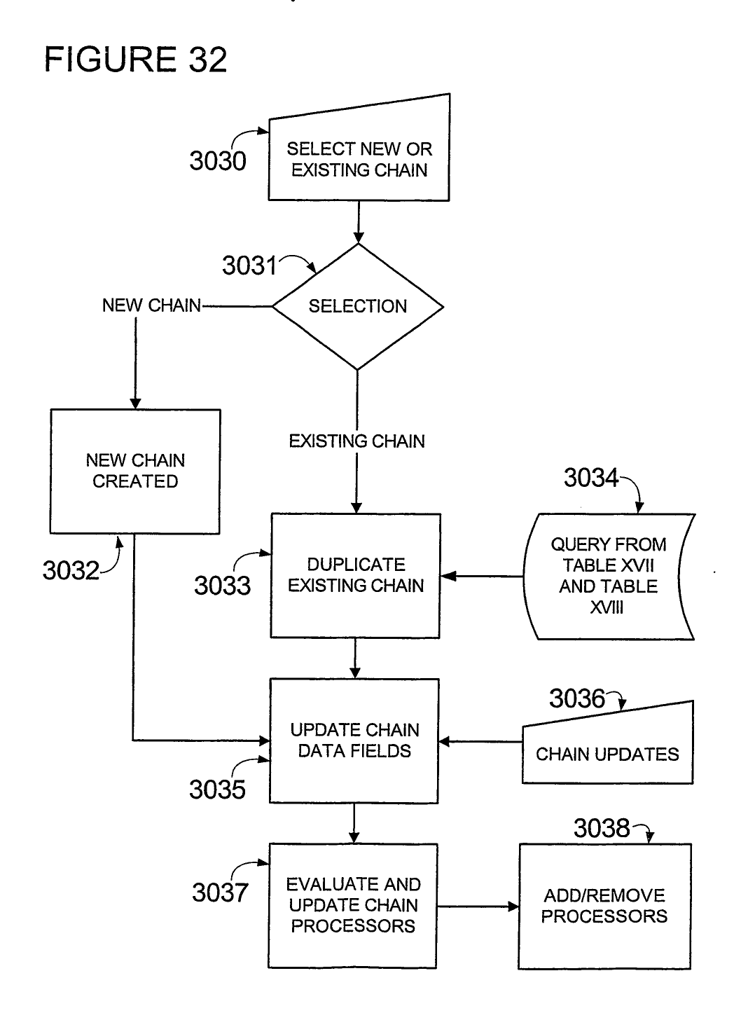

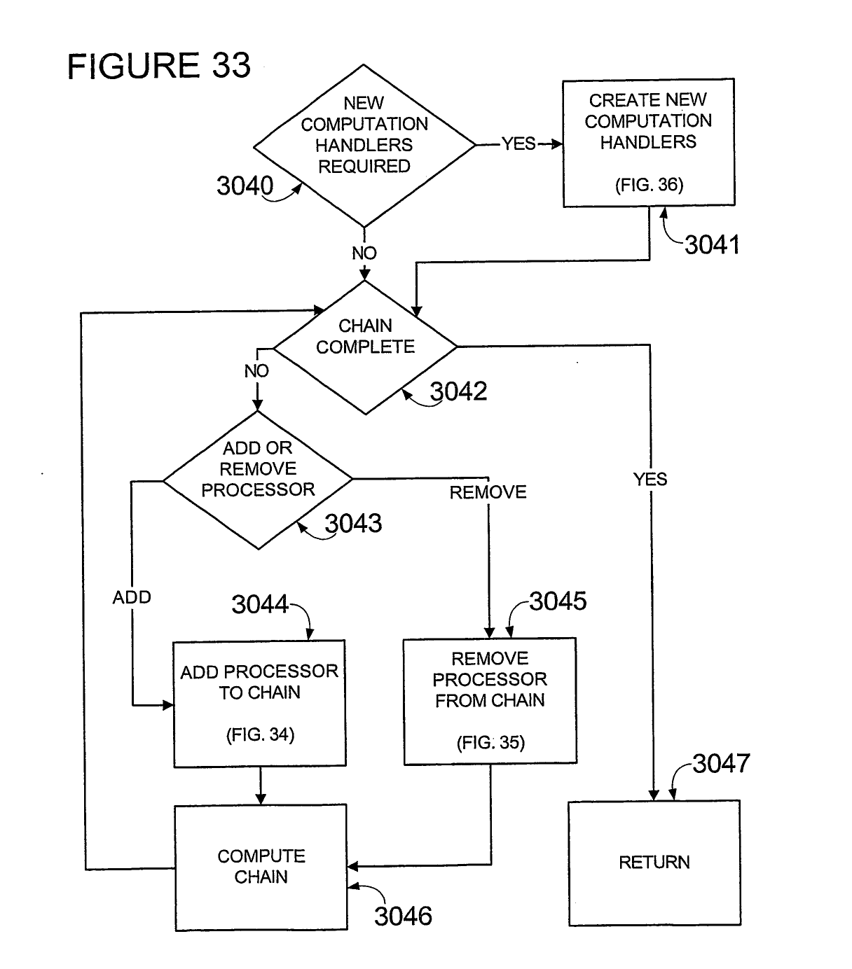

As seen in step 3013, to create a new chain either a pre-existing chain may be duplicated or a new empty chain may be created. This process is shown in greater detail in FIG. 32. As seen in step 3014, a price chain can be modified by either adding or removing processors. More details of this process are shown in FIGS. 33, 34 and 35.

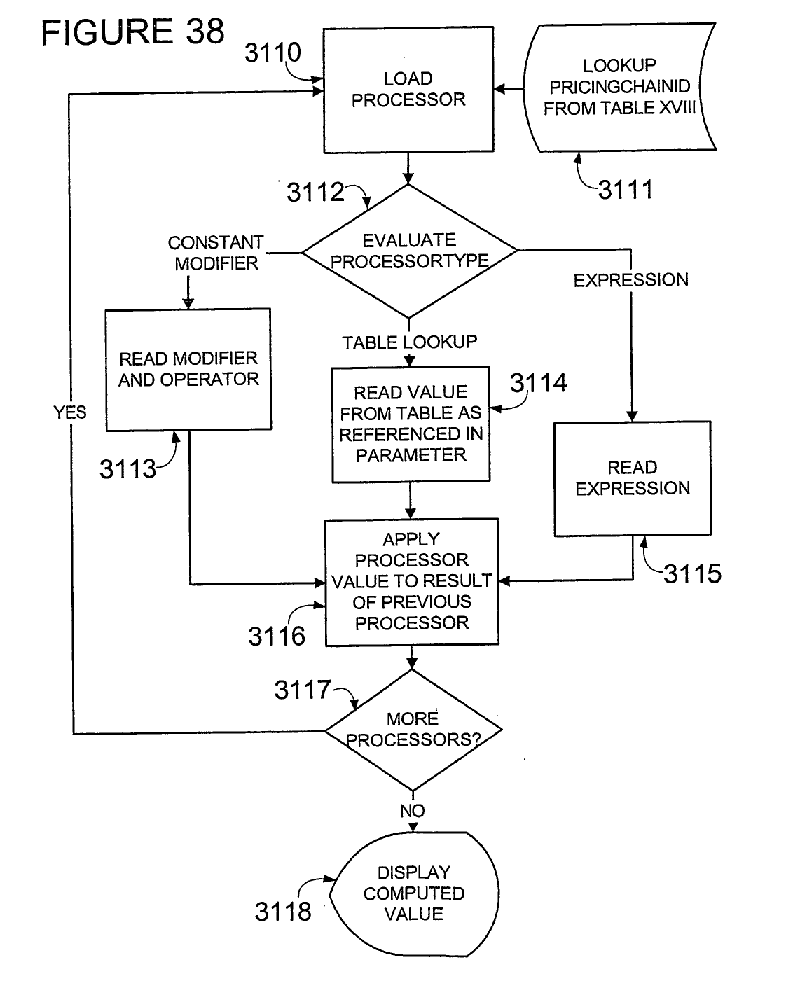

As seen in step 3015, each time a modification is made to the price chain it is recomputed. This process occurs automatically once a modification has been made. The process is shown in more detail in FIG. 38.

As seen in step 3016, once the price chain has been modified as desired and recomputed it may be stored for future reference.

As seen in step 3017, the price chain is stored in Table XVII for future use and updating.

Reference is now made to FIG. 31, which is a simplified flowchart illustration of a preferred method for implementing step 3012 of FIG. 30. All existing price chains are considered during the lookup process, however only the chains that closely match the characteristics of the transaction are displayed. Once the price chains that may be displayed have been chosen, they are sorted according to their likelihood of being relevant.

In step 3020, all stored price chains are retrieved from the price chain table by step 3021 and checked for relevance to the current transaction. If any are relevant they may be sorted and displayed. As seen in step 3021, the price chains that match the selected Product ID and Product Group ID are retrieved from Table XVII.

Step 3022 branches based on whether any suitable price chains were found. In step 3023, the price chains may be sorted based on a set of prioritized criteria. The result may be an ordered list of price chains that can be duplicated for use by the current transaction. In step 3024, if no relevant price chains were found then an empty list results. This case results more often when the trading system is first used, and over time preferably may happen less and less often as more price chains are created. As seen in step 3025, if no relevant price chain was found then a new price chain must be created. The trading system preferably advises the operator that this is the case.

In step 3026, the results of the price chain lookup may be displayed. This preferably shows that either a number of relevant price chains have been found or that none were found. In the case where relevant price chains were found, the price chains may be displayed in the order determined during the sorting procedure.

As seen in step 3027, once the sorting and display processes are complete the trading system proceeds to the creation of a new price chain for the current transaction. FIG. 32 shows more details of this process.

Reference is now made to FIG. 32, which is a simplified flowchart illustration of a preferred method for implementing step 3013 of FIG. 30. The pricing chain builder can duplicate an existing chain and use that as a template for a new chain, thus saving time when similar transactions are attempted by pre-populating the chain with processors that are likely to be useful for the new transaction since the two transactions are similar, and thus so would be their pricing chains.

Step 3030 receives a selection from an operator of the trading system. This selection may be either to create a new empty price chain or to create a new chain by duplicating a pre-existing price chain. Step 3031 branches based on the selection specified. As seen in step 3032, if the creation of a new price chain is selected this new price chain may be associated with the current transaction. The new price chain may be empty except for a terminator, which is a placeholder that marks the end of the price chain. As seen in step 3033, if a pre-existing price chain is chosen then it may be duplicated as a new price chain and associated with the current transaction. The price chain processors are loaded from the price chain Table XVII by step 3034, and new data is written to that table as well as Table XVIII.

As seen in step 3034, the information for all existing price chains is stored in Table XVII, with the attached processors for each chain stored in Table XVIII. The duplicate pricing chain may be stored in Table XVIII with a new unique ED, and associated with the current transaction ID, and duplicate processors may be created and stored in Table XVIII.

As seen in step 3035, updates to the chain are received from an external source, such as a user interface. This data is then written to the TransactionID, PricingChainStatus, ProdGrpID, ProdID, ProdQty, UOM_ID, IncoTerm, IncoTermLocation, Starting Price, ProdAvgPrice, ChainOwner fields of the newly created chain record in Table XVII.

As seen in step 3036, optionally, the updated information may be read from an external input, such as a user interface. In step 3037, all processors linked to the new chain are loaded with values and evaluated as per the process depicted in FIG. 38.

As seen in step 3038, once the new chain has been created it can be modified by adding or removing processors. More details of these operations are shown in FIGS. 33, 34 and 35. An empty chain cannot have any of its processors removed.

Reference is now made to FIG. 33, which is a simplified flowchart illustration of a preferred method for implementing step 3014 of FIG. 30. If new computation handlers are necessary, the process depicted in FIG. 33 is executed. A processor is a specific instance of a computation handler with a specific value, expiration date, and other attributes. Multiple processors that are linked to multiple chains all share the same value, such that a single update is then reflected in multiple chains. The same does NOT hold true for computation handlers, which are the templates from which processors are created.

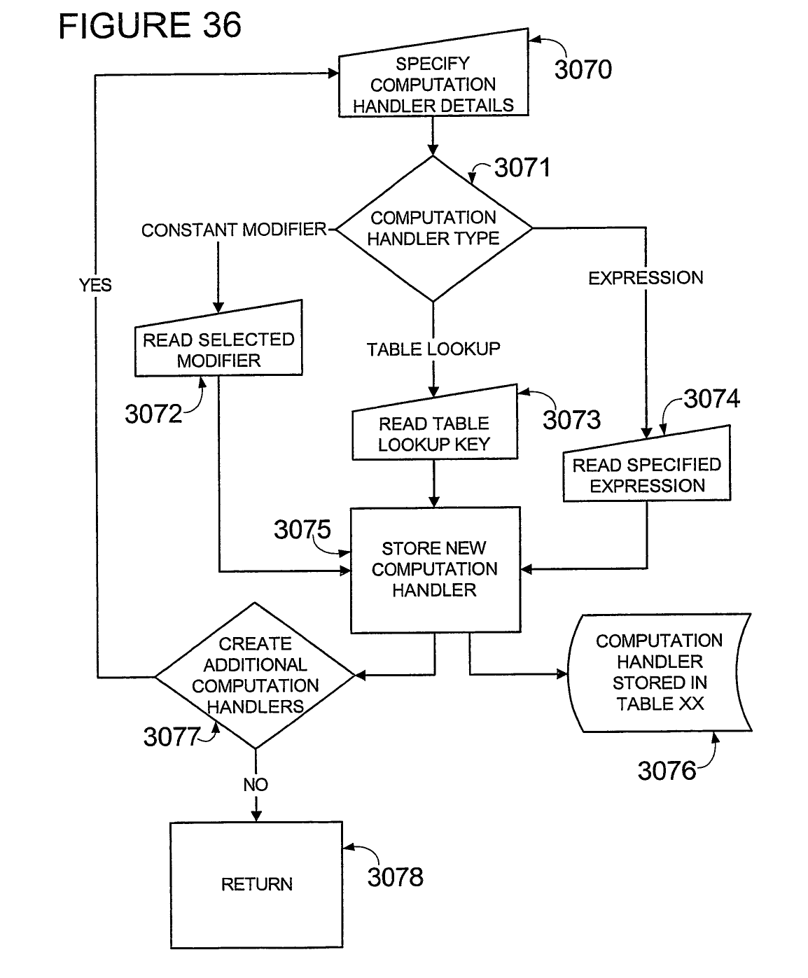

As seen in step 3040, if the pricing chain being modified desires a processor with a computation handler that does not exist at the time of modification, then a new computation handler may preferably be created to satisfy this need. In this case, a processing branch may be taken that enables the creation of new computation handlers. More details are shown in FIG. 36. If the price chain does not require any new computation handlers then the process proceeds to adding and removing processors.

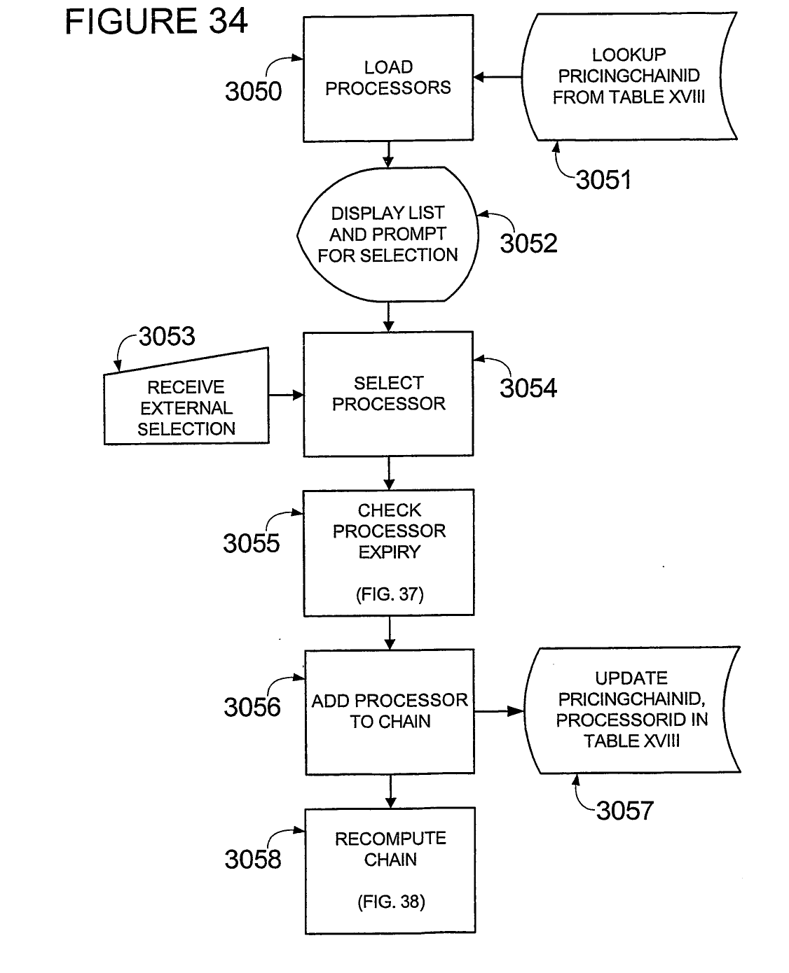

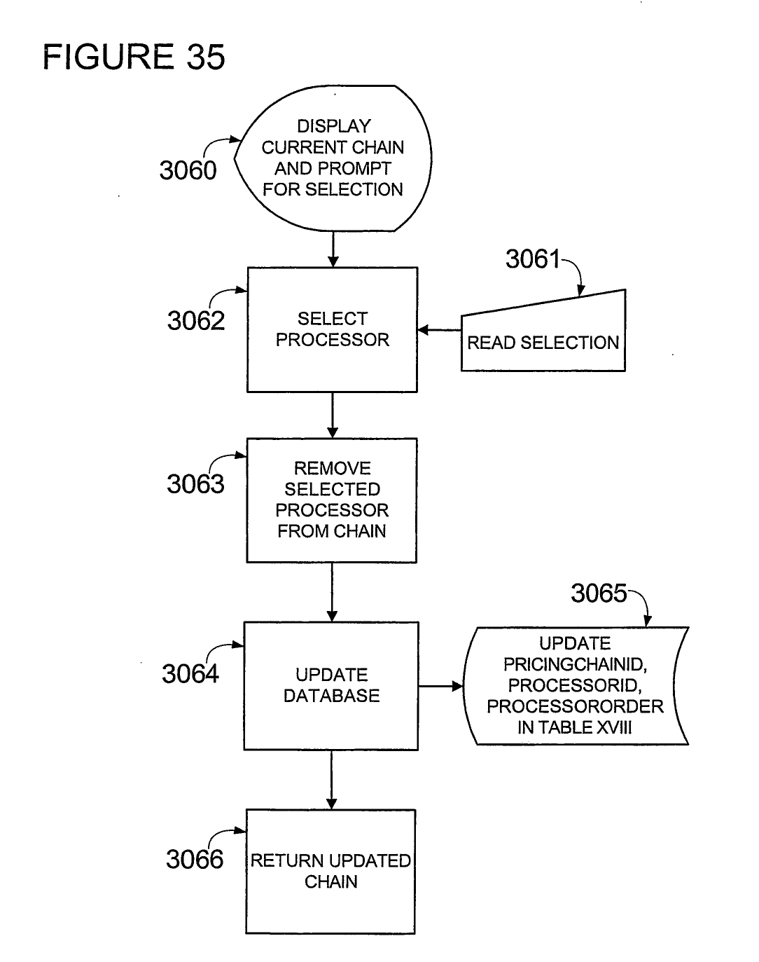

As seen in step 3041, new computation handlers can be created to perform functions that are not performed by any of the existing computation handlers. FIG. 36 shows more details. Step 3042 checks to see if the price chain has been completely updated, or if there are more processors to add or remove. Branch to the appropriate procedure based on the result of this check. Step 3043 chooses either to add a processor to the price chain or to remove one from the price chain. As seen in step 3044, a new processor can be chosen from the list of pre-existing processors to be added to the price chain. The details of this process are shown in FIG. 34. As seen in step 3045, one of the processors can be removed from the price chain, if it is not needed. The details of this process are shown in FIG. 35. As seen in step 3046, when a change is made to the price chain, either adding or deleting a processor, the price chain builder 3000 recomputes the result. The details of this operation are shown in FIG. 38.

As seen in step 3047, when the price chain has been completely updated and recomputed then the price chain builder 3000 may cease operation until it is needed to manipulate another price chain.

Reference is now made to FIG. 34, which is a simplified flowchart illustration of a preferred method for implementing step 3044 of FIG. 33. FIG. 34 shows the process for adding a Pricing Chain Processor to a pricing chain.

Step 3050 loads all the processors that are presently available for adding to the price chain from the processor database, as seen in step 3051. As seen in step 3051, the processors database contains all the processors currently available in the system. Step 3052 displays the processors that were loaded by step 3050, then awaits external input to make a selection. In step 3053, an external input is received by the trading system to select one of the processors to be added to the price chain. As seen in step 3054, a processor is selected from the list according to the external selection. Step 3055 uses the processor information as a lookup table key to determine if a processor is still valid. If the processor has expired then adding it to the price chain may affect the status of the computation result. This process is shown in greater detail in FIG. 37. As seen in step 3056, once the processor expiry has been checked the processor may preferably be added to the price chain. It preferably remains part of the price chain unless it is removed. As seen in step 3057, the pricing chain Table XVIII is updated with the new data to reflect the addition of the processor to the selected chain by writing the PricingChainID and ProcessorID fields. As seen in step 3058, after a processor has been added to the price chain the result of the price chain is recomputed. Further details of this computation are shown in FIG. 38.

Reference is now made to FIG. 35, which is a simplified flowchart illustration of a preferred method for implementing step 3045 of FIG. 33. FIG. 35 shows the process for removing a Pricing Chain Processor from a pricing chain.

As seen in step 3060, all the processors in the chain are displayed. The external trading system operator can choose whichever processor may be removed. In step 3061, a selection is received to determine which processor may be removed from the chain. In step 3062, the particular processor to be removed from the chain is selected. As seen in step 3063, the links to the selected processor are broken and the processors on either side of it are connected together. As seen in step 3064, the newly updated chain is saved by step 3065. In step 3065, the link between a pricing chain and its processors is stored in Table XVIII, along with the order of processors within that chain by updating the PricingChainID, ProcessorID and Processor Order fields. In step 3066, the price chain builder 3000 proceeds to the next step of the process.

Reference is now made to FIG. 36, which is a simplified flowchart illustration of a preferred method for implementing step 3041 of FIG. 33. FIG. 36 depicts the functionality that is executed when a new computation handler is created.

In step 3070, a new computation handler may be created with the name and details provided by an external source. As seen in step 3071, the process branches depending on the type of computation handler being created. In step 3072, a “constant modifier” type of computation handler may be created. The modifier may be read from an external input. This type of handler performs a constant modification to its value, such as adding five, dividing by 3, etc. In step 3073, a “lookup table” type of computation handler may be created. This type of handler assumes the value of the database value that it references. In step 3074, an “expression” type of computation handler may be created. This type of handler assumes the value of a mathematical expression that is contained in the handler. In step 3075, the newly created computation handler is stored in Table XX. As seen in step 3076, the computation handler is stored along with the existing computation handlers and may be available for all present or future price chains that may be created.

As seen in step 3077, if more computation handlers need to be created the process begins again from the start. Otherwise the process continues to the next step, modification of the price chain.

As seen in step 3078, once all the computation handlers have been created then the process continues to the next step, where processors are added or removed from the price chain.

Reference is now made to FIG. 37, which is a simplified flowchart illustration of a preferred method for implementing step 3055 of FIG. 34. For a computation to be valid its processors must all be valid. If one of the processors has past its strict expiry then the price chain's result may be invalid. If one of the processors has past its lazy expiry then the price chain's result may be conditionally valid. In order to determine the status of a processor the price chain builder 3000 communicates with the data expiry handler 5000. If a processor has expired, the price chain builder 3000 sends information to the notification handler 4000 to produce a notification of this occurrence.

In step 3090, price chain builder 3000 sends a request to the data expiration handler 5000 to find out the expiry status of the data in question. As seen in step 3091, price chain builder 3000 waits until the response to the expiry status request arrives. In step 3092, a response is received from the data expiration handler 5000 providing the expiry status requested.

In step 3093, branching occurs based on the result of the expiry check. If the result is valid, then the process continues with step 3094. If the result is lazy expiry, then the process continues to step 3095. Otherwise, if the result is strict expiry, then the process continues to step 3096.

As seen in step 3094, if the price chain builder 3000 had computed a valid price then the result remains valid.

As seen in step 3095, if the computed price was valid it becomes conditionally valid. If it was conditionally valid, it remains as such. If the price was already invalid it also remains as such.

As seen in step 3096, the result becomes invalid whether it was valid, conditionally valid or invalid.

In step 3097, a notification is generated by sending a notification request to the notification handler 4000. The notification request preferably notifies a role or user that it is time to update this processor's data. Step 3098 returns the result of the updated price chain.

Reference is now made to FIG. 38, which is a simplified flowchart illustration of a preferred method for implementing step 3058 of FIG. 34. FIG. 38 depicts the evaluation of a given chain's processors to come up with a value for the entire chain by enumerating all of its processors in order and applying the output value of a given processor as the input value for the next.

Step 3110 loads the next processor's information from the processor database, as seen in step 3111, by querying Table XVIII using PricingChainID as the lookup key. In step 3112, depending of the type of computation handler that is assigned to processor, branching occurs to three steps.

Step 3113 reads the relevant modifier from the Modifier field that may be applied to the current price.

Step 3114 does a lookup, from a table referenced in the Parameter field of Table XX, of the value of that may be applied to the current price.

Step 3115 loads the programmatic expression contained in the Parameter field of Table XX that may be applied to the current price.

Step 3116 applies the function determined in the previous step to the current price.

As seen in step 3117, if processors remain to be applied then the process loops back to step 3110. Otherwise, the computation is complete and the process continues to step 3118. As seen in step 3118, once the value has been determined it may be displayed. Depending on the status of the result, valid, conditionally valid, or invalid, it may be displayed in a different color.

Reference is now made to FIG. 39, which is a simplified flowchart illustration of a preferred method of operation for the notification handler 4000 of FIG. 1. The notification handler 4000 works closely with the price chain builder 3000, queue manager 1000 and the data expiration handler 5000. It is an internal process to the trading system and cannot, in the present implementation, be accessed through any external interface.

As seen in step 4000, notification handler 4000 is an internal functional block that facilitates the process of generating notifications. It executes processes shown in steps 4001, 4002, and 4003.

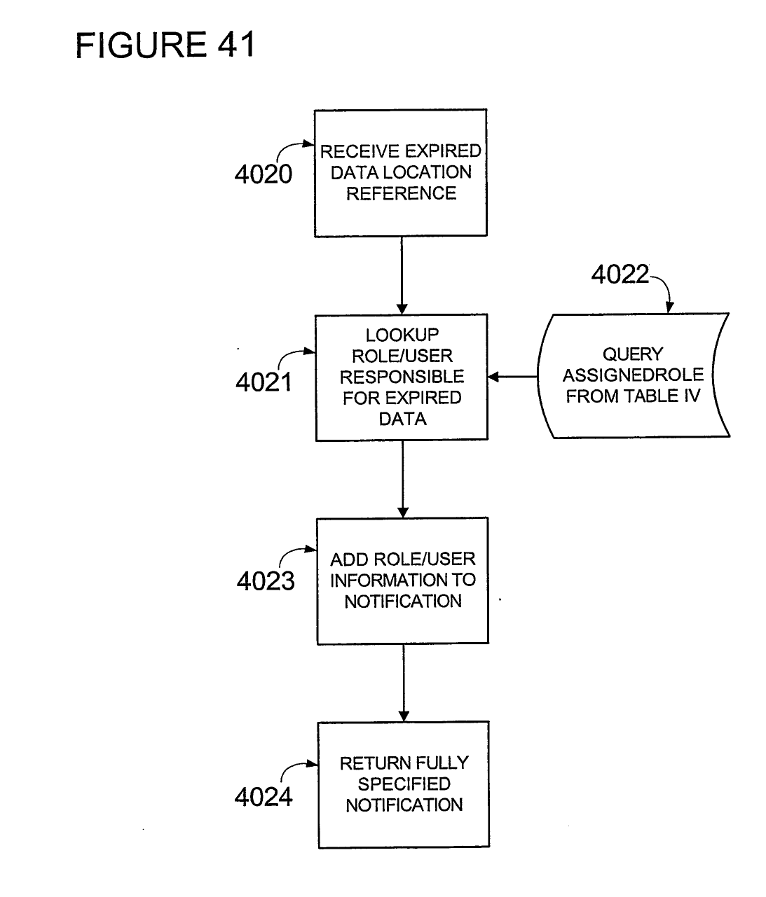

In step 4001, notification handler 4000 generates a notification queue entry that is sent to the queue manager 1000. The details of the process are shown in FIGS. 40 and 41.

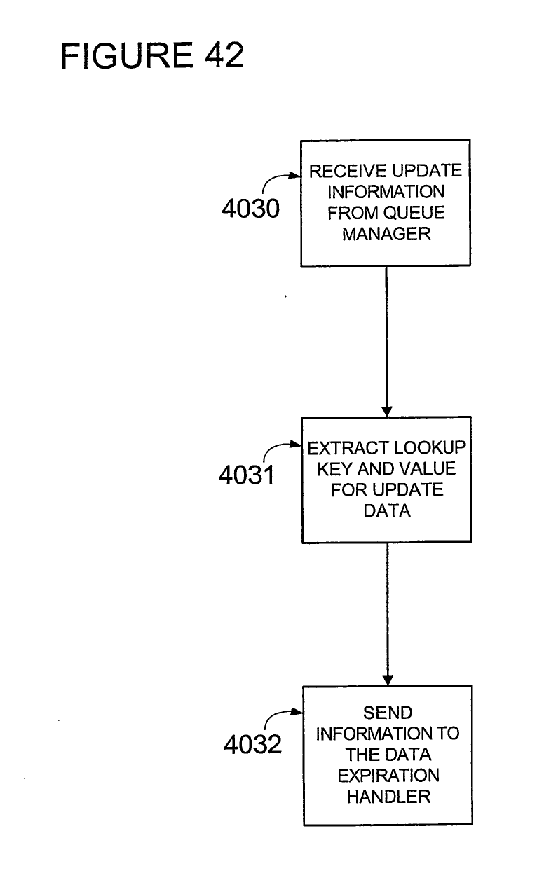

In step 4002, notification handler 4000 propagates the updated information to the data expiration handler 5000. The details of this process are shown in FIG. 42.

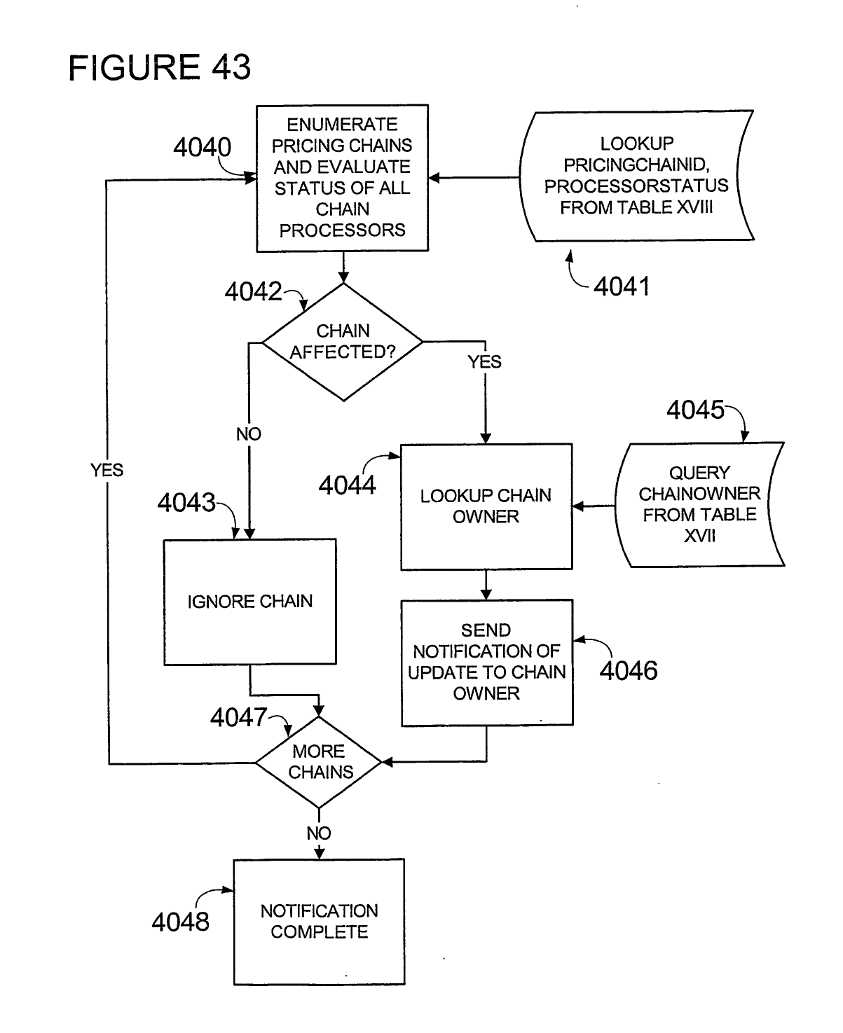

In step 4003, notification handler 4000 preferably creates notification queue items for items that were affected by a particular update. The price chains that contain the updated item may be updated and the owners of these price chains may be informed. FIGS. 40 and 43 show the details.

Reference is now made to FIG. 40, which is a simplified flowchart illustration of a preferred method for implementing step 4001 of FIG. 39. FIG. 40 shows how notification handler 4000 forms a notification that may subsequently be sent to the queue manager 1000. The completed notification informs the system user or operator of exactly what data needs to be updated.

In step 4010, notification handler 4000 receives a request from either data expiration handler 5000 or price chain builder 3000 for a notification to be generated. In step 4011, notification handler 4000 bundles the information together to form a notification queue item. FIG. 43 shows a preferred embodiment of this process in detail. As seen in step 4012, once completed, the notification request is sent to the queue manager 1000. The queue manager 1000 maintains the notification until a response is received. As seen in step 4013, while the notification resides in the notification queue notification handler 4000 is either idle or processing other notification requests or updates.

As seen in step 4014, once the queue manager 1000 sends a response to the notification handler 4000, the notification handler 4000 replaces the value in the appropriate data table with the value it has just received. As seen in step 4015, a message is sent to data expiration handler 5000 to alert it to the update. The data expiration handler 5000 may then update its expiry information. More details are shown in FIG. 42.

As seen in step 4016, when an item is updated it may affect multiple roles or users. They may be informed of the update and can thus take any appropriate actions that may be necessary.

Reference is now made to FIG. 41, which is a simplified flowchart illustration of a preferred method for implementing step 4011 of FIG. 40. When an outstanding request is serviced by a system user the data expiration information may be reset to reflect the update. The notification handler 4000 forwards the necessary information to the data expiration handler 5000 for updating its expiration tables.

Step 4020 receives a reference informing the notification handler 4000 where the newly expired data is located. Along with this information comes a description of the expired data that may be presented to the external trading system operator. In step 4021, a lookup is done to see who is responsible for the expired data. This person may be the addressee of the notification queue item. As seen in step 4022, the AssignedRole field of the Table IV is queried for the reference to the role or user ID that is responsible for the selected data item. In step 4023, the role or user information is added to the notification queue item. As seen in step 4024, the fully specified item is then submitted to the notification queue.

Reference is now made to FIG. 42, which is a simplified flowchart illustration of a preferred method for implementing step 4015 of FIG. 40. FIG. 42 depicts a high-level flow of how expiration information is processed.

As seen in step 4030, once the queue item has received a response, the queue manager 1000 propagates this information to the notification handler 4000. In step 4031, notification handler 4000 extracts the data lookup key and the updated value from the queue item response, respectively, from the QItemValueLoc and QitemValue fields of Table XXIII. In step 4032, notification handler 4000 forwards the information to the data expiration handler 5000 for it to update its data expiry tables.

Reference is now made to FIG. 43, which is a simplified flowchart illustration of a preferred method for implementing step 4016 of FIG. 40. When a computation handler of a price chain is updated it is necessary to check the other price chains to determine if they link to a processor that is based on this computation handler. If they have it then a notification is sent to the price chain's owner to inform them of the update.

When a processor is updated many chains may be affected as they may contain this processor. In this case, it is necessary to inform the Roles/Users responsible for the affected chains. Notifications are sent to all users/roles responsible for the chains that are affected by the expiry information update.

The notification handler 4000 searches through all the chains and checks to see if any of them contain the processor that was updated. If they do the User/Role responsible for the particular chain is notified of the change.

Step 4040 reads the next price chain to see if it is affected. As seen in step 4041, the chains are stored in the PricingChains database. As seen in step 4042, branching occurs based on if the current chain contains the computation handler that was updated. If it does, then branch to step 4044. If not, then branch to step 4043.

As seen in step 4043, the current price chain is ignored, as it is not affected by the update. In step 4044, since the price chain is affected, the owner is looked up in the table to determine who the owner of the price chain is. In step 4045, the chain owner is stored in the ChainOwner field of the PricingChains database, along with the rest of the chain information. In step 4046, a notification is sent to the owner of the chain to inform that role or user of the change to the computation handler and thus to the price chain.

As seen in step 4047, if there are more chains to check, then branch back to step 4040. Otherwise, continue to step 4048. As seen in step 4048, the notification process has completed and the notification handler 4000 returns to a ready state.

Reference is now made to FIG. 44, which is a simplified flowchart illustration of a preferred method of operation of the data expiration handler 5000 of FIG. 1. The data expiration handler 5000 is not visible at the trading system's interface to the outside world.

Data expiration handler 5000 tracks the expiry information for all data items in the trading system. Data expiration handler 5000 is operative to execute processes in steps 5001, 5002 and 5003.

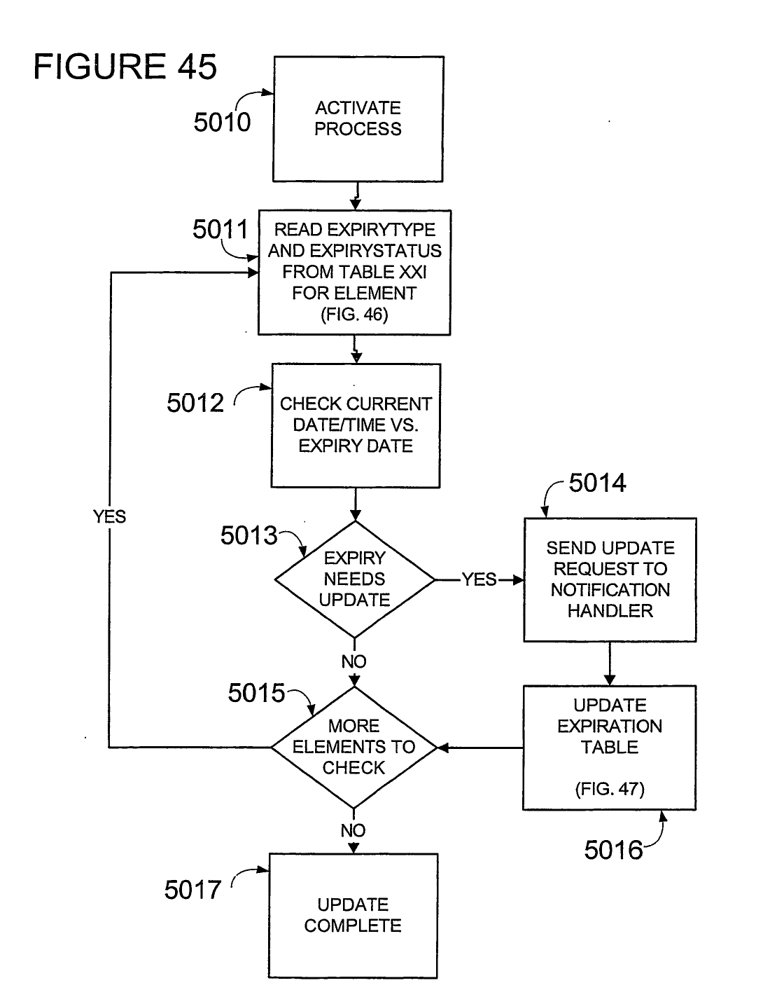

As seen in step 5001, the information in the data expiration handler 5000 tables must be updated periodically. At those times the process shown in FIG. 45 is executed.

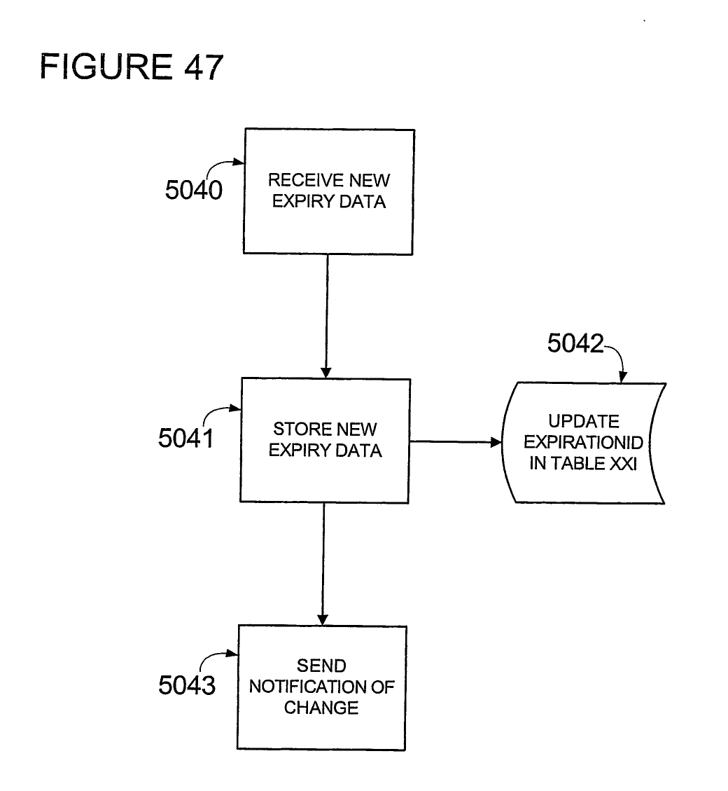

As seen in step 5002, when a particular data item is updated then its expiry entry must be updated, also. FIG. 47 shows the details of the process.

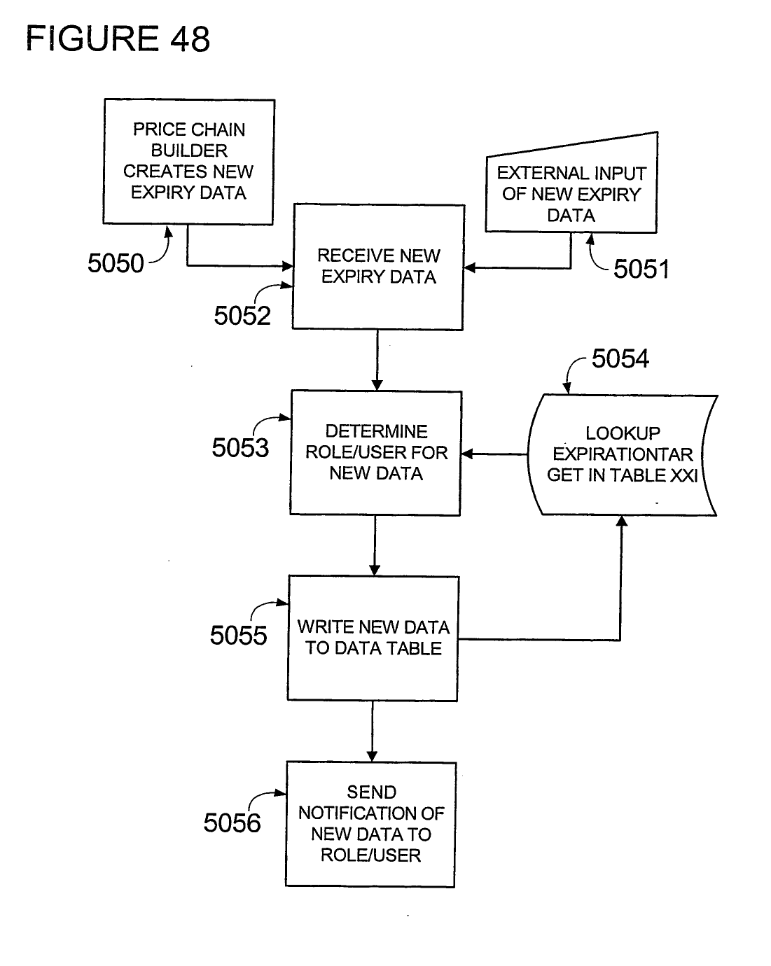

As seen in step 5003, when a new data item is added to the system, a new expiry entry for it is preferably created. FIG. 48 shows the details of the process of adding a new expiry entry.

Reference is now made to FIG. 45, which is a simplified flowchart illustration of a preferred method for implementing step 5001 of FIG. 44 in which a potentially expired data element is queried. Based on an external reference, for example from the operating system, on a periodic basis each data expiry element is check to see if its status is still correct. If the element's status is no longer correct the necessary steps are taken to update it, including sending a notification and changing the element's status field value.

As seen in step 5010, the process is activated at periodic intervals by an external source such as the operating system. As seen in step 5011, for the next expiry record the lazy and strict expiry times are read from the table along with the current status. As seen in step 5011, the expiry records are stored in a series of tables. In step 5012, a check is made to see if the current expiry status of the record remains correct at this new moment in time. In step 5013, branching occurs according to the result of the expiry status check.

In step 5014, a notification request is generated for the item if its expiry status has changed. The request is sent to the notification handler 4000 to obtain an updated value for the record. The request contains a reference that identifies it.

As seen in step 5015, if there are more data elements to check, the method branches back to step 5011. Otherwise, the method continues to step 5017.

As seen in step 5016, if a change to the expiry status of a record is necessary, then this change may be made and the new expiry status recorded in the table, and processing preferably resumes at step 5015.

Step 5017 denotes the termination of the current invocation of the process and the return of execution control to the calling process.

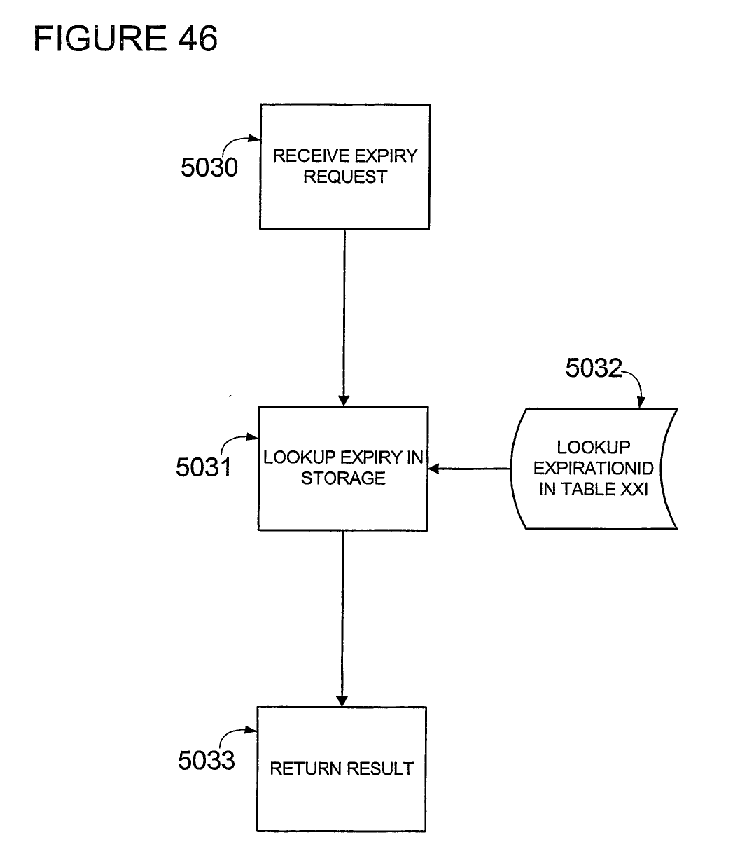

Reference is now made to FIG. 46, which is a simplified flowchart illustration of a preferred method for implementing step 5011 of FIG. 45. When a price chain is being built, the expiry status of the processors that may be used in the price chain must be checked. The price chain builder 3000 sends an identifier for the processor to the data expiration handler 5000. This identifier is then used by the data expiration handler 5000 as a lookup table key.

As seen in step 5030, data expiration handler 5000 receives an expiry status request from another part of the system, such as price chain builder 3000. The request contains the database reference to identify the particular field that is to be checked.

As seen in step 5031, data expiration handler 5000 reads the expiry status requested, using the information in the request as a lookup key. As seen in step 5032, the data expiry storage holds the expiry status of all data in the trading system. In step 5033, data expiration handler 5000 returns the expiry status to the requester.

Reference is now made to FIG. 47, which is a simplified flowchart illustration of a preferred method for implementing step 5016 of FIG. 45. When an item that had expired is updated the notification handler 4000 sends a message to the data expiration handler 5000 to update its expiry status.

Step 5040 receives a reference that identifies the newly updated item. Step 5041 uses the reference to write the updated expiry status information to the expiry storage. As seen in step 5042, the expiry storage holds the expiry information so that it can be read and updated whenever necessary.

In step 5043, data expiration handler 5000 sends a notification request to the notification handler 4000 to inform the users or roles affected by this change in expiry status of a particular data item.

Reference is now made to FIG. 48, which is a simplified flowchart illustration of a preferred method for implementing step 5003 of FIG. 44. Two sources may create new expiry table entries, either the price chain builder 3000 or an external source.

As seen in step 5050, price chain builder 3000 creates a new expiration entry when a new computation handler is created, as depicted in FIG. 36.

As seen in step 5051, an external source, such as a system operator, may create a new expiry entry.

In step 5052, data expiration handler 5000 receives the new expiry entry from whichever source. In step 5053, the new entry may preferably be assigned to a particular user or role, as determined by a query to the NotificationTarget field of Table XXI. The user or role is preferably responsible for updating the data when it expires. As seen in step 5054, the user or role to be assigned responsibility is preferably determined using a lookup table.

In step 5055, the new entry is written to Table XXI. As seen in step 5055, the expiry storage adds a new entry.

In step 5056, the role or user assigned responsibility, as determined by a query to the NotificationTarget field of Table XXI, for the new entry may be sent a notification.

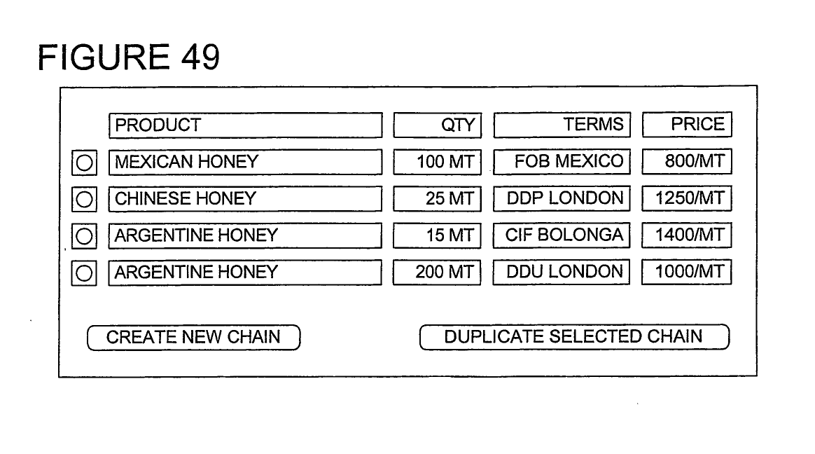

FIG. 49 is a simplified screenshot depicting a possible display of candidate pricing chains produced by the process outlined in FIG. 31 and displayed by step 3026 therein.

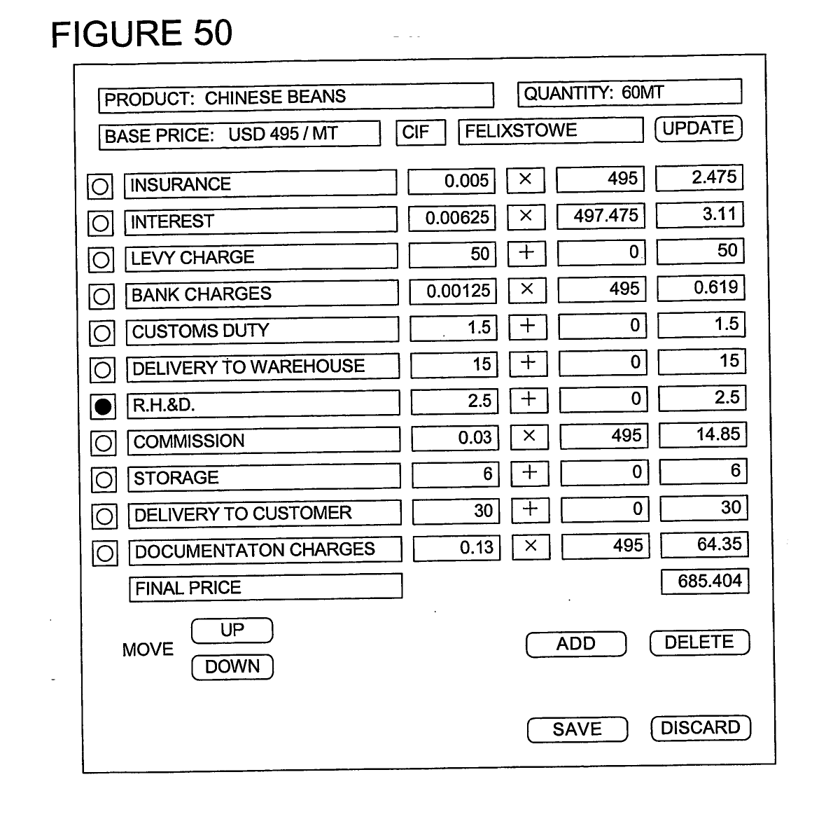

FIG. 50 is a simplified screenshot depicting a possible display (by step 3052 of FIG. 34) of a pricing chain related to a transaction of 60 tons of Chinese Beans and incorporating a plurality of processors.

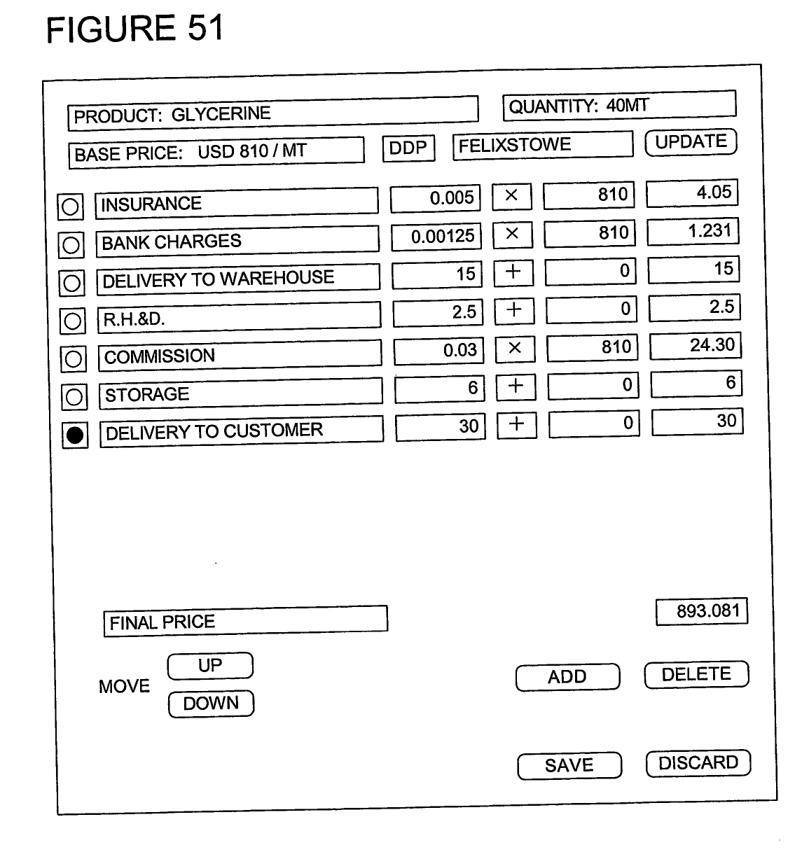

FIG. 51 is a simplified screenshot depicting a possible display (by step 3052 of FIG. 34) of a pricing chain related to a transaction of 40 tons of glycerin and incorporating a plurality of processors.

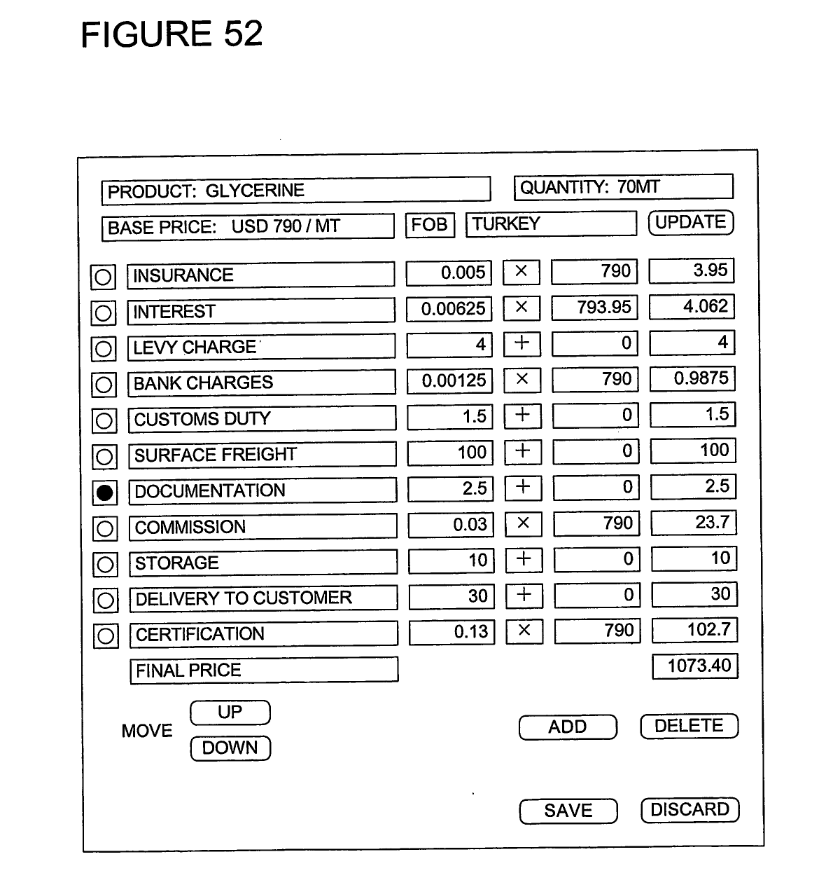

FIG. 52 is a simplified screenshot depicting a possible display (by step 3052 of FIG. 34) of a pricing chain related to a transaction of 40 tons of glycerin and incorporating a plurality of processors. In contrast to FIG. 51, the list of processors is different because the INCO term and location are different, thus requiring different operations by entities in the trading house, even though the transaction is for the same product.

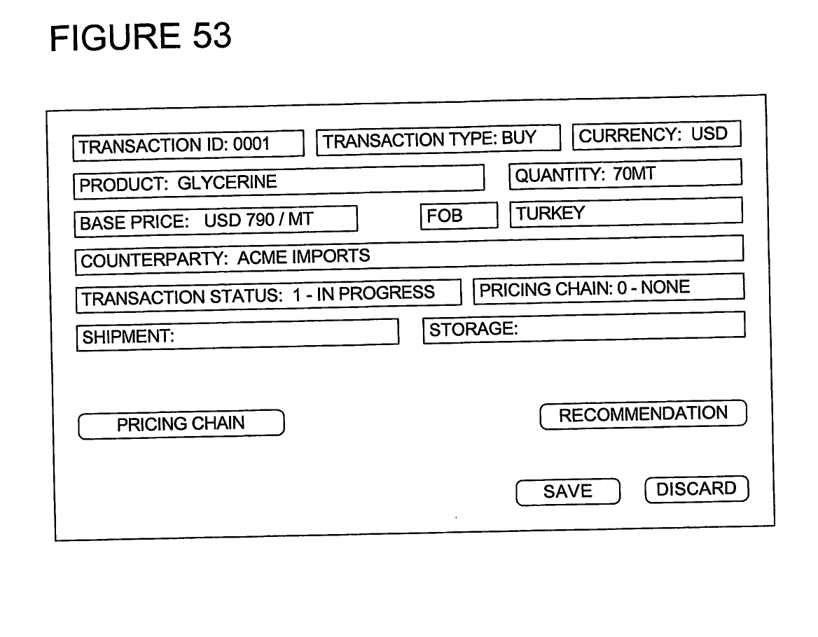

FIG. 53 is a simplified screenshot depicting a possible display of a transaction, as managed by the transaction handler 107 of FIG. 1 and whose data is stored in Table I. The user is provided with an option to attach a pricing chain, in which case step 3001 of FIG. 29 is executed, and to request a recommendation based on the current data displayed, in which case step 2001 of FIG. 16 is executed.

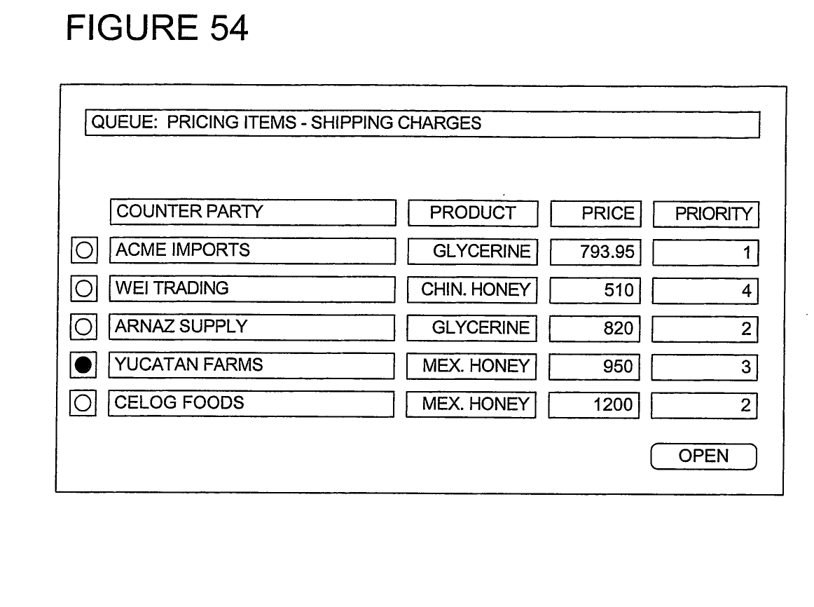

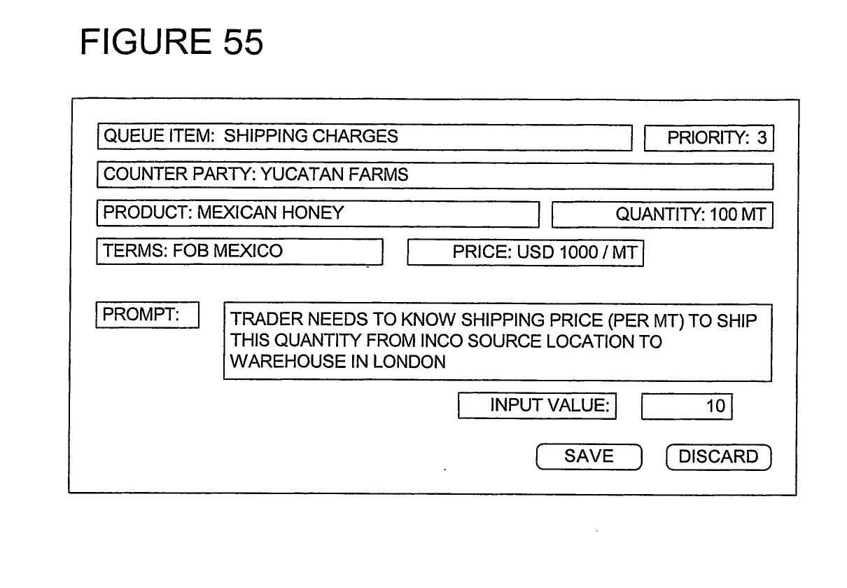

FIG. 54 is a simplified screenshot depicting a possible display of a notification queue pertaining to the prices of various shipping charge queries awaiting input by the user. Upon selection of an item, FIG. 55 may be displayed.

FIG. 55 is a simplified screenshot depicting a possible display of an interaction between the user and the notification queue. In this case, the user is prompted for information, with the prompt text stored in QitemPrompt of Table XXIII. Upon input by the user, the entered data value is preferably stored in the QitemValue field of Table XXIII.

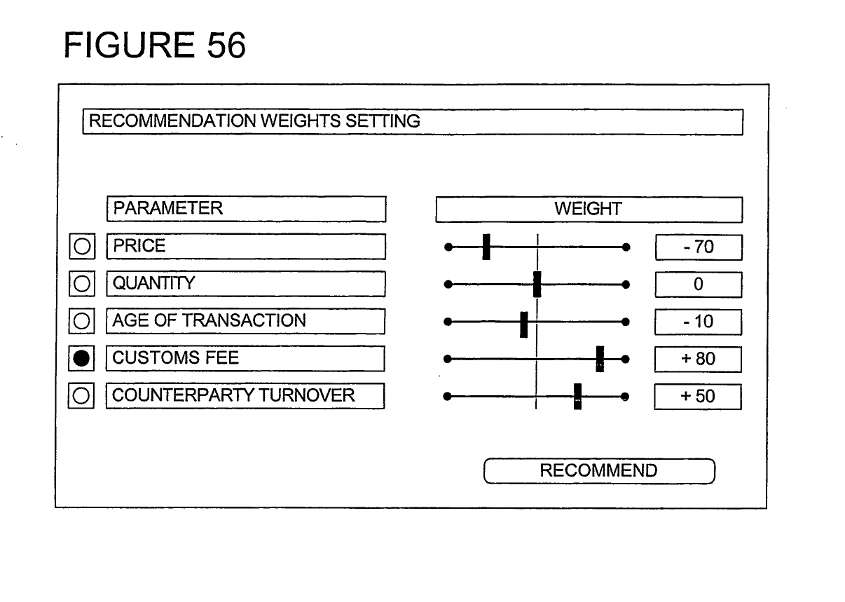

FIG. 56 is a simplified screenshot depicting a possible display (depicted in step 2034 of FIG. 19) of an interaction between the user and the PCTB 2000, wherein the user enters the recommendation weights for a set of parameters.

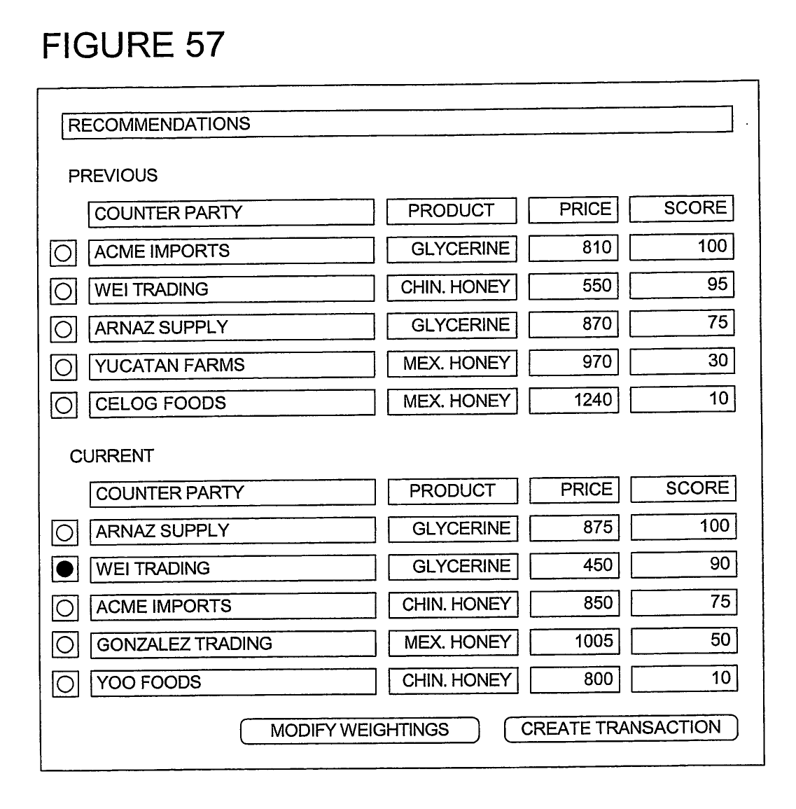

FIG. 57 is a simplified screenshot depicting a possible display (depicted in step 2024 of FIG. 18) in which the recommendations generated by the PCTB 2000 are displayed to the user for possible acceptance, modification, or dismissal.

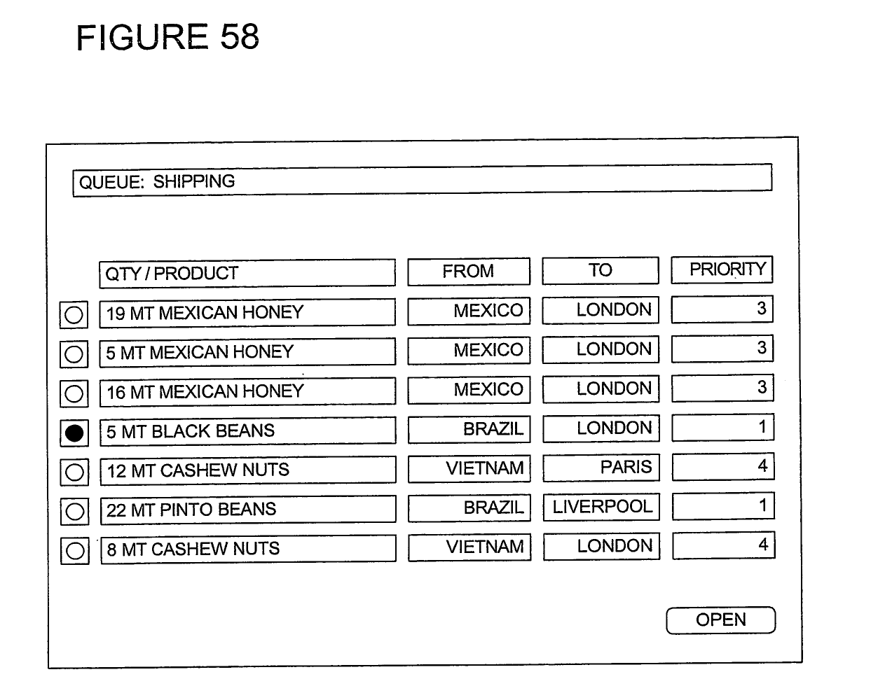

FIG. 58 is a simplified screenshot depicting a possible display of a queue pertaining to shipments of products as may be handled by the shipment handler 111 of FIG. 1, and before any amalgamation operations were run on this queue.

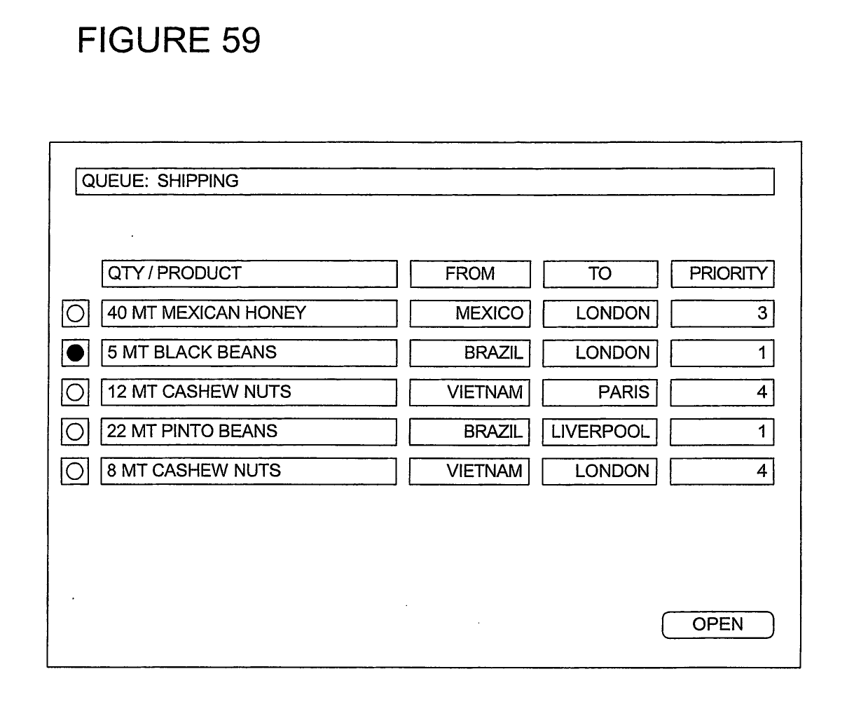

FIG. 59 is a simplified screenshot depicting a possible display of a queue pertaining to shipments of products as may be handled by the shipment handler 111 of FIG. 1, after example A hereinbelow was executed, causing a reduction in the number of queue items and the amalgamation of the three queue items pertaining to the shipment of multiple amounts of Mexican Honey from Mexico to London.

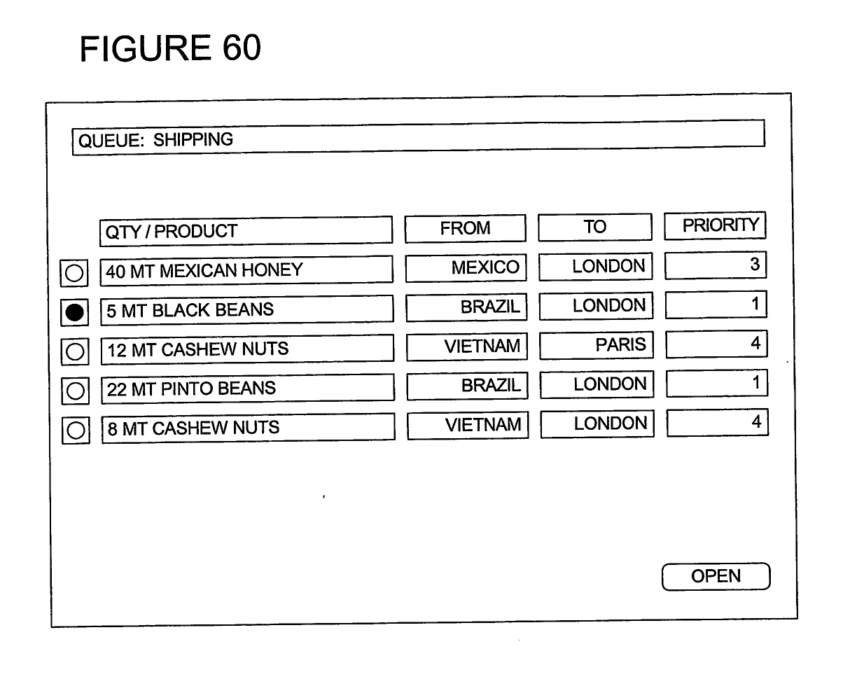

FIG. 60 is a simplified screenshot depicting a possible display of a queue pertaining to shipments of products as may be handled by the shipment handler 111 of FIG. 1, after execution of Example B hereinbelow on the queue shown in FIG. 59.

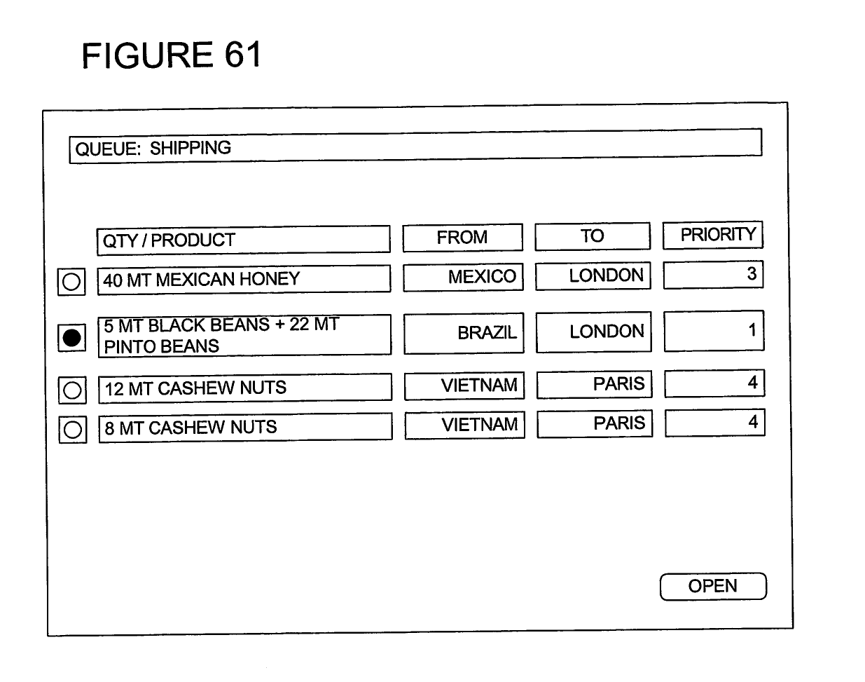

FIG. 61 is a simplified screenshot depicting a possible display of a queue pertaining to shipments of products as may be handled by the shipment handler 111 of FIG. 1, after execution of Example C hereinbelow on the queue shown in FIG. 60.

Further reference is now made to FIGS. 58, 59, 60 and 61 which are simplified screenshots depicting possible displays presented to a user during the amalgamation process of FIG. 9.

In FIG. 2, step 1005, described hereinabove, the queue manager 1000 enumerates all queue items and applies the process of FIG. 9 to each. For example, a “Shipping” queue might have 5 entries (referenced as QueueItem[1] through QueueItem[5]) at the time step 1070 of FIG. 9 is invoked. In such case, the queue manager may preferably enumerate each item as follows:

Pass 1:

Execute step 1071 of FIG. 9 on QueueItem[1] and QueueItem[2]

Execute step 1071 of FIG. 9 on QueueItem[1] and QueueItem[3]

Execute step 1071 of FIG. 9 on QueueItem[1] and QueueItem[4]

Execute step 1071 of FIG. 9 on QueueItem[1] and QueueItem[5]

Pass 2:

Execute step 1071 of FIG. 9 on QueueItem[2] and QueueItem[3]

Execute step 1071 of FIG. 9 on QueueItem[2] and QueueItem[4]

Execute step 1071 of FIG. 9 on QueueItem[2] and QueueItem[5]

Pass 3:

Execute step 1071 of FIG. 9 on QueueItem[3] and QueueItem[4]

Execute step 1071 of FIG. 9 on QueueItem[3] and QueueItem[5]

Pass 4:

Execute step 1071 of FIG. 9 on QueueItem[4] and QueueItem[5]

It is appreciated that the queue manager 1000 may not enumerate items that have been removed from the queue due to successful amalgamation processes, e.g. if QueueItem[2] is amalgamated with QueueItem[1].

As seen in the example of FIG. 58, QueueItem[1], QueueItem[2] and QueueItem[3] are queue items related to a shipment of Mexican honey from Mexico to London.

The following description assumes the business logic procedure of Example A below.

When step 1071 of FIG. 9 is invoked, the above-mentioned queue items may be amalgamated into a single queue item comprised of the sum of the product quantities of the three items, producing the output of FIG. 59.

As seen in the resulting FIG. 59, QueueItem[2] and QueueItem[4] are queue items related to shipments of beans from Brazil to London and to Liverpool, respectively. Since both are located in England, the queue items would be amalgamated by the business logic procedure depicted in Example B hereinbelow, and the output of FIG. 60 would be produced.

Further referring to FIG. 60, assuming QueueItem[2] and QueueItem[4] are queue items related to a shipments of beans from Brazil to Liverpool and to London in England, the queue items would be amalgamated by the business logic procedure depicted in Example C hereinbelow, which is an example of amalgamating by product group for shipment. FIG. 61 depicts the result of the above-mentioned operation.

### EXAMPLE A

### Business Logic Performing Amalgamation

| 1. | if | (QueueItem[1].QItemPromptVariable.Product== | |
|---|---|---|---|
| | | QueueItem[2].QItemPromptVariable.Product) | and |
| | | (QueueItem[1].QItemPromptVariable.From== | |
| | | QueueItem[2].QItemPromptVariable.From) | and |
| | | (QueueItem[1].QItemPromptVariable.To == | |
| | | QueueItem[2].QItemPromptVariable.To) | and |
| | then | | |
| 2. | QueueItem[1].QItemPromptVariable.QTY= | | |
| | | QueueItem[1].QItemPromptVariable .QTY | + |

| | | QueueItem[2].QItemPromptVariable .QTY |
|---|---|---|
| 3. | QueueItem[1].QItemPrompt = “QueueItem[1].QItemPrompt” + | |
| | | “QueueItem[2].QItemPrompt” |

| | |
|---|---|
| 4. | QueueItem[2].QItemStatus=2 |
| 5. | QueueItem[2].QItemBaseAmalgamationQID= |
| | QueueItem[1].QueueItemID |
| 6. | return |

In this example, it is assumed that a shipment queue is being evaluated for amalgamation opportunities, wherein the value of each queue item is compared such that multiple shipments of similar items are amalgamated into a single shipment.

Line 1 contains an evaluative expression to determine if an amalgamation opportunity exists between the reference QueueItem, in this example QueueItem[1], and the enumerated item, in this case QueueItem[2]. The “TO,” “FROM” and “PRODUCT” fields of the queue items are evaluated. If they match, the amalgamation takes place by summing the “QTY” fields of the amalgamated queue items.

Line 2 is executed if the result of the above expression is true. The variables (in this case, the quantity of product to ship) of the first and second queue items are summed.

Line 3 shows how the textual prompts, referenced in FIG. 55, can be amalgamated together as well for ease of reference of the user.

Line 4 sets the queue item's status to “Amalgamated” (ref. the QItemStatus field in Table XXIII).

Line 5 sets a reference pointer in QueueItem[2] to reference the base queue item, QueueItem[1], such that a link is created between the two queue items.

Line 6 returns processing to the calling procedure, which may be 1013 as shown in FIG. 3.

### EXAMPLE B

### Business Logic Performing Amalgamation

| | | |
|---|---|---|
| 1. | if | (QueueItem[2].QItemPromptVariable.Product== |

QueueItem[4].QItemPromptVariable.Product) and
(QueueItem[2].QItemPromptVariable.From==
QueueItem[4].QItemPromptVariable.From) and
(QueueItem[2].QItemPromptVariable.To == “LONDON”) and
((QueueItem[4].QItemPromptVariable.To == “LIVERPOOL”)
or
(QueueItem[4].QItemPromptVariable.To == “CAMBRIDGE”)
or
(QueueItem[4].QItemPromptVariable.To ==
“FELIXSTOWE”))

| | then | |
|---|---|---|
| 2. | QueueItem[4].QItemPromptVariable.To == “LONDON”) | |
| 3. | QueueItem[2].QItemPromptVariable.QTY | = |

| | |
|---|---|
| QueueItem[2].QItemPromptVariable.QTY | + |
| QueueItem[4].QItemPromptVariable.QTY | |

| | |
|---|---|
| 4. | QueueItem[2].QItemPrompt = “QueueItem[2].QItemPrompt” + |

“QueueItem[4].QItemPrompt”

| 5. | QueueItem[4].QItemStatus=2 |
|---|---|
| 6. | QueueItem[4].QItemBaseAmalgamationQID= |
| | QueueItem[2].QueueItemID |
| 7. | return |

In this example, it is assumed that a shipment queue is being evaluated for amalgamation opportunities, wherein the value of each queue item is compared such that multiple shipments of identical products shipped from the same location to geographically close destinations are amalgamated into a single shipment.

Line 1 contains an evaluative expression to determine if an amalgamation opportunity exists between the reference QueueItem, QueueItem[2], and the enumerated item, in this case QueueItem[4]. The “FROM” and “TO” fields of the queue items are evaluated, and if the FROM fields are identical and the TO fields are pre-specified to be geographically equivalent, as determined by the business logic, either by manual entry (i.e. “convert city X to city Y” as in the example) or by any other external process then amalgamation takes place by summing the “QTY” fields of the amalgamated queue items and setting the TO field of the amalgamated item to the same as the base queue item.

Line 2 is executed if the result of the above expression is true. The Variables (in this case, the destination of the shipment) of the first and second queue items are set to identical values.

Line 3 sums the quantities of the shipments.

Line 4 shows how the textual prompts, referenced in FIG. 55, can be amalgamated together as well for ease of reference of the user.

Line 5 sets the queue item's status to “Amalgamated” (ref. the QItemStatus field in Table XXIII).

Line 6 sets a reference pointer in QueueItem[4] to reference the base queue item, QueueItem[2], such that a link is created between the two queue items.

Line 7 returns processing to the calling procedure.

### EXAMPLE C

### Business Logic Performing Amalgamation

| | | |
|---|---|---|
| 1. | if | (QueueItem[2].QItemPromptVariable.ProductGroup== |

| QueueItem[4].QItemPromptVariable.ProductGroup) and | |
|---|---|
| (QueueItem[2].QItemPromptVariable.From== | |
| QueueItem[4].QItemPromptVariable.From) | and |

(QueueItem[2].QItemPromptVariable.To==
QueueItem[4].QItemPromptVariable.To Then

| | |
|---|---|
| 2. | QueueItem[2].QItemPromptVariable.Product= |

| | |
|---|---|
| QueueItem[2].QItemPromptVariable.Product | + |

QueueItem[4].QItemPromptVariable.Product

| | | |
|---|---|---|
| 3. | QueueItem[2].QItemPromptVariabIe.QTY | = |

| | |
|---|---|
| QueueItem[2].QItemPromptVariable.QTY | + |

QueueItem[4].QItemPromptVariable.QTY

| | |
|---|---|
| 4. | QueueItem[2].QItemPrompt = “QueueItem[2].QItemPrompt” + |

“QueueItem[4].QItemPrompt”

| 5. | QueueItem[4].QItemStatus=2 |
|---|---|
| 6. | QueueItem[4].QItemBaseAmalgamationQID= |
| | QueueItem[2].QueueItemID |
| 7. | return |

In this example, it is assumed that a shipment queue is being evaluated for amalgamation opportunities, wherein the value of each queue item is compared such that multiple shipments of products belonging to the same product group and traveling from identical destinations to identical destinations are amalgamated into a single shipment.

Line 1 contains an evaluative expression to determine if an amalgamation opportunity exists between the reference QueueItem, QueueItem[2], and the enumerated item, in this case QueueItem[4]. The “FROM” and “TO” fields of the queue items are evaluated, and if the FROM fields are identical and the TO fields are deemed to be geographically close then the amalgamation takes place by summing the “QTY” fields of the amalgamated queue items and setting the TO field of the amalgamated item to the same as the base queue item.

Line 2 is executed if the result of the above expression is true. The shipment contents (in this case, the products to be shipped) of the first (base) queue item QueueItem[2] is set to both the original product of QueueItem[4]. Line 3 sums the quantities of the shipments.

Line 4 shows how the textual prompts, referenced in FIG. 55, can be amalgamated together as well for ease of reference of the user.

Line 5 sets the queue item's status to “Amalgamated” (ref. QItemStatus field in Table XXIII).

Line 6 sets a reference pointer in QueueItem[4] to reference the base queue item, QueueItem[2], such that a link is created between the two queue items.

Line 7 returns processing to the calling procedure.

### EXAMPLE D

### Business Logic Performing Amalgamation

| 1. | if | (QueueItem[1].QItemPromptVariable.ProductGroup== |
|---|---|---|
| | | QueueItem[2].QItemPromptVariable.ProductGroup) and |
| | | (QueueItem[1].QItemPromptVariable.From== |
| | | QueueItem[2].QItemPromptVariable.From) and |
| | | (QueueItem[1].QItemPromptVariable.To == |
| | | QueueItem[2].QItemPromptVariable.To) then |
| 2. | if | ABS(Days(QueueItem[1].QItemPromptVariable.ShipDate)− |

Days(QueueItem[2].QItemPromptVariable.ShipDate)) < 14 then

| | |
|---|---|
| 3. | QueueItem[1].QItemPromptVariable.QTY= |

QueueItem[1].QItemPromptVariable.QTY +
QueueItem[2].QItemPromptVariable.QTY

| | |
|---|---|
| 4. | QueueItem[1].QItemPrompt = “QueueItem[1].QItemPrompt” + |

“QueueItem[2].QItemPrompt”

| 5. | QueueItem[2].QItemStatus=2 | |
|---|---|---|
| 6. | QueueItem[2].QItemBaseAmalgamationQID | = |

| | QueueItem[1].QueueItemID |
|---|---|
| 7. | NewQueueItem(STORAGE, |

QueueItem[1].QItemPromptVariable.ShipDate,
QueueItem[2].QItemPromptVariable.ShipDate,
QueueItem[1].QueueItemID)

| | |
|---|---|
| 8. | return |

In this example, it is assumed that a shipment queue is being evaluated for amalgamation opportunities, wherein the products of the same product group that are designed to be shipped from identical source locations to identical destinations within a specified time frame are compared. This business logic example seeks amalgamation opportunities where multiple shipments may be amalgamated into a single shipment, especially if one of the shipment dates is already determined to be particularly applicable due to the sailing of a vessel on a specified date. When amalgamation is possible, storage of the shipped items may be required for the duration of time than between the originally scheduled shipment and the new shipment date, and is addressed by adding a new queue item in the storage queue. A person skilled in the art will appreciate that similar processes can happen between any number of queues.

Line 1 contains an evaluative expression to determine if an amalgamation opportunity exists between the reference QueueItem, QueueItem[1] in this example, and the enumerated item, QueueItem[2] in this example. The “TO,” “FROM” and “PRODUCT” fields of the queue items are evaluated. If they match, then line 2 is evaluated.

Line 2 evaluates the time frame between shipments, such that shipments within a specific time frame, 14 days in this example, are amalgamated. The expression evaluates the absolute value of the difference of the number of days between the shipments.

Line 3 is executed if the results of the above two expressions are true. The variables, the quantity of product to ship in this example, of the first and second queue items as summed, such that amalgamation takes place by summing the “QTY” fields of the amalgamated queue items.

Line 4 shows how the textual prompts, referenced in FIG. 55, can be amalgamated together as well for ease of reference of the user.

Line 5 sets the queue item's status to “Amalgamated” (ref. the QitemStatus field in Table XXIII).

Line 6 sets a reference pointer in QueueItem[2] to reference the base queue item, QueueItem[1], such that a link is created between the two queue items.

Line 7 creates a new queue item in a different queue (the storage queue in this example) to address the new requirement to store a quantity of product until the date the amalgamated shipment can be shipped. This procedure calls step 1010 of FIG. 3 for the destination queue, the storage queue in this example, supplying it with the required queue-specific parameters, in this case the start and end storage dates and a reference to the parent queue item.

Line 8 returns processing to the calling procedure, which may be step 1013 of FIG. 3.

### EXAMPLE E

### Business Logic Performing Prioritization

This example checks the age of items in a queue and raises the priority of older items in order to ensure that they are promptly handled.

| 1. | if | (Days(CurrentDate( )) −(Days(QueueItem[1].QItemDate)) >= 20 |
|---|---|---|
| | then | |
| 2. | | QueueItem[1].Priority = (QueueItem[1].Priority)+1 |
| 3. | | return |

Line 1 is an evaluative expression that determines if more than 20 days have elapsed since the queue item was created.

Line 2 is executed if line 1 is true, and increments the priority of the queue item by one. Care must be taken to ensure that the incrementation does not happen each time the queue is evaluated.

Line 3 returns processing to the calling function.

### EXAMPLE F

### Business Logic Performing Prioritization

This example depicts an evaluation of the number of items in two distinct queues (as returned by the Count( ) function) and a decrement of the priority of the items in the first queue if certain conditions are met.

Assuming that the SHIPMENTS queue is being enumerated:

| | | |
|---|---|---|
| 1. | if | (Count(QueueID[CURRENCY_BOOKINGS]) > 5 and |
| | | Count(QueueID[SHIPMENTS]) > 10 then |
| 2. | | QueueItem[1].Priority = (QueueItem[1].Priority)−1 |
| 3. | | return |

Line 1 is an evaluative expression, operative on the SHIPMENTS queue, that determines if more than 10 items exist in the SHIPMENTS queue and more than 5 items exist in a different queue, in this case the CURRENCY_BOOKINGS queue.

If line 1 is true, line 2 is executed and decrements the priority of the queue item by one. Care must be taken to ensure that the decrementation does not happen each time the queue is evaluated.

Line 3 returns processing to the calling function.

Business logic may also be customized to generate priorities based on world events or other business situations. For example:

### EXAMPLE G

### Business Logic Performing Prioritization

This example assumes that banks give a certain discount for currency bookings that are placed early in the morning:

| 1. If | ((Hours(TimeNow( )) > 7) and (Hours(TimeNow( )) < 12) then |
|---|---|
| 2. | QueueItem[1].Priority = (QueueItem[1].Priority)+1 |
| 3. | return |

In this example, it is assumed that the currency bookings queue is being prioritized.

Line 1 is an evaluative expression that determines if the current time is after 7 am and before 12 pm. Line 2 is executed if line 1 is true, and increments the priority of the queue item, in this case items in the Currency Booking queue, by one. In this case, it may be preferable to increase the priority once a day even for items that already exist in the queue. Line 3 returns processing to the calling function.

### EXAMPLE H

### Business Logic Performing Prioritization

This example illustrates the modification of queue item priorities in multiple queues as a result of world events, for example political instability in a certain country, which may make it desirable for a trading house, using a computerized system constructed and operative in accordance with a preferred embodiment of the present invention, to accelerate closure of all business relating to that country.

This example of business logic may be referenced by any queue.

1. if (QueueItem[1].QItemPromptVariable.Location == “ARGENTINA””)
then

| | |
|---|---|
| 2. | QueueItem[1].Priority = QueueItem[1].Priority + 10; |
| 3. | return |

Line 1 is an evaluative expression that determines if the location associated with the queue item's variables is “Argentina”, in which it has been learned that there is political unrest. Line 2 is executed if line 1 is true, and increases the priority of the queue item by a larger amount, in this case, 10. Line 3 returns processing to the calling function.

It is appreciated that the business logic of Examples A-H is merely exemplary of possible business logics, and that business logics may be combined in any suitable manner. For example, an item's priority may be increased by both of the processes detailed in Examples G and H above.

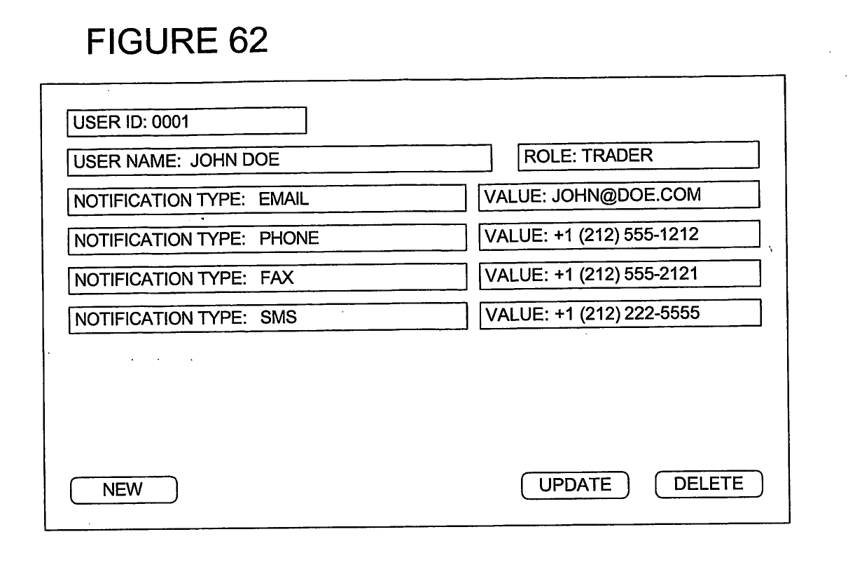

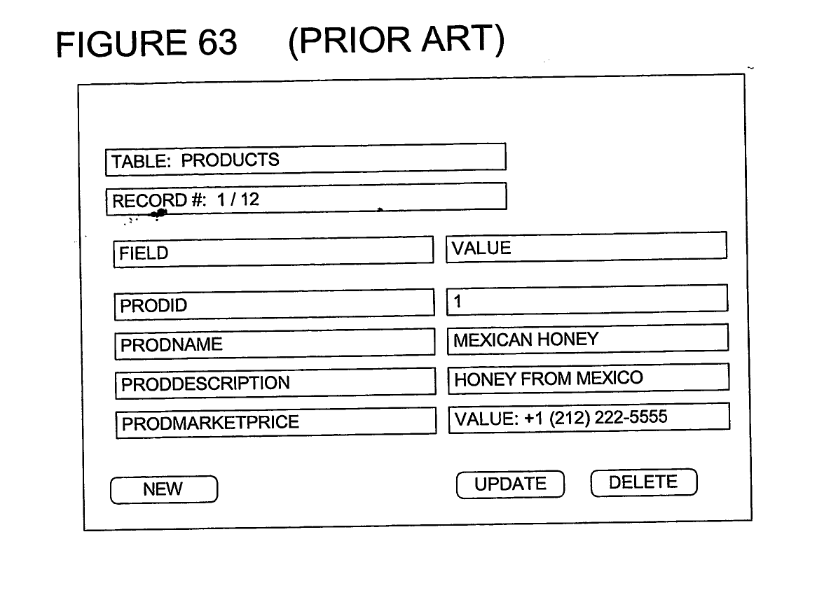

FIG. 62 is a simplified screenshot depicting a possible display of a data edit screen for maintaining notification preferences for each user, as are stored in Table FIG. 63 is a simplified screenshot depicting a possible display of a data edit screen for maintaining information about database records and fields, as stored by the database management system 200 of FIG. 1.

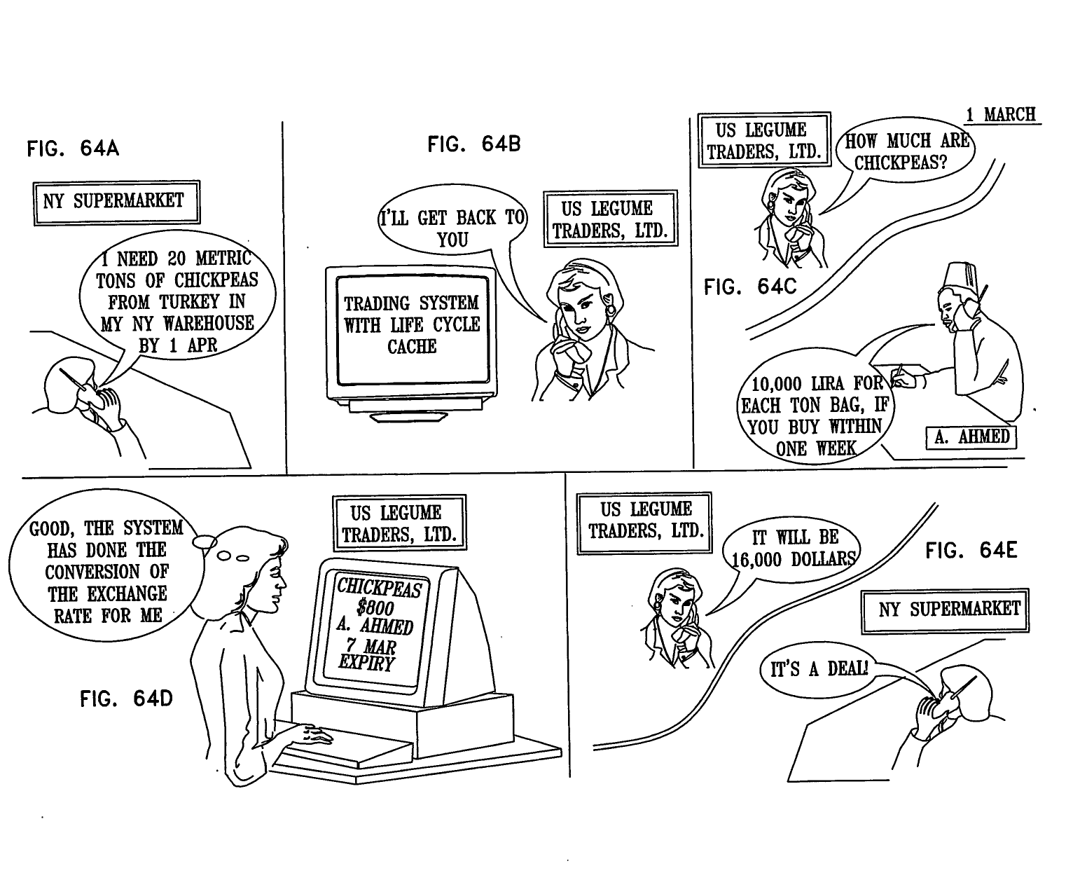

FIGS. 64A-64E, taken together, are a pictorial illustration of a trader using a computerized trading system constructed and operative in accordance with a preferred embodiment of the present invention in which price information items including expiry information therewithin are automatically converted into a system format for storage in the system. As shown, the trader preferably is able to input information in a foreign currency, and in natural language (e.g.: expiry can be indicated to be “within one week”), and the system automatically converts information into a desired uniform currency, such as dollars, and converts “within one week”, using its knowledge of the current date, into a date one week hence.

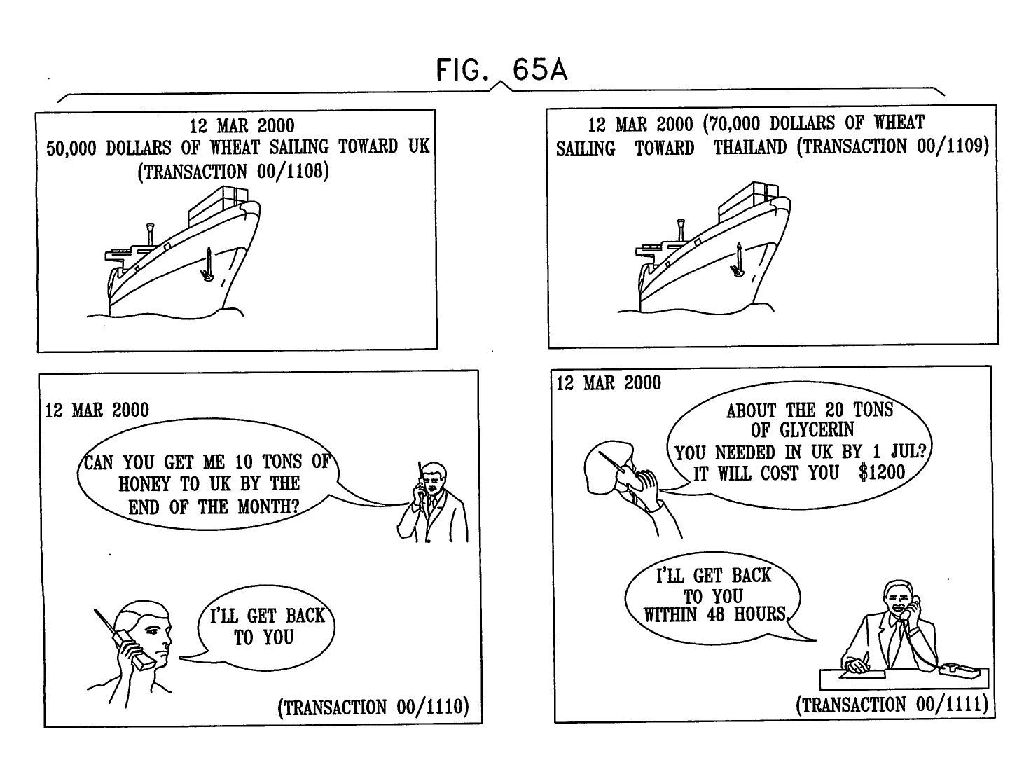

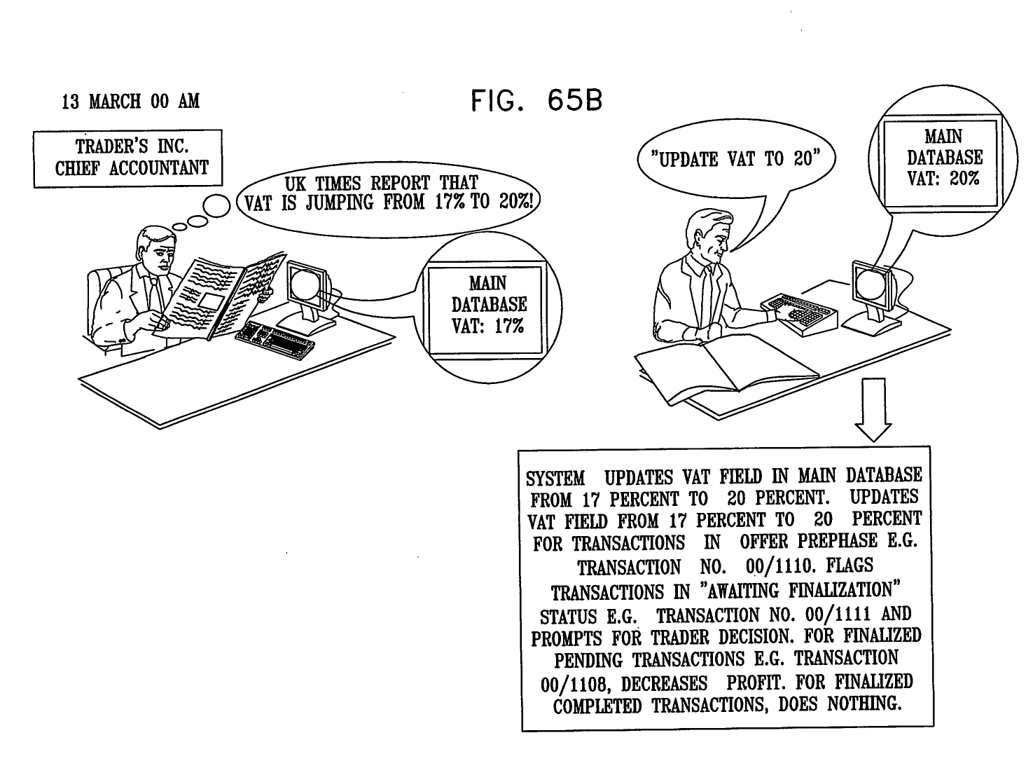

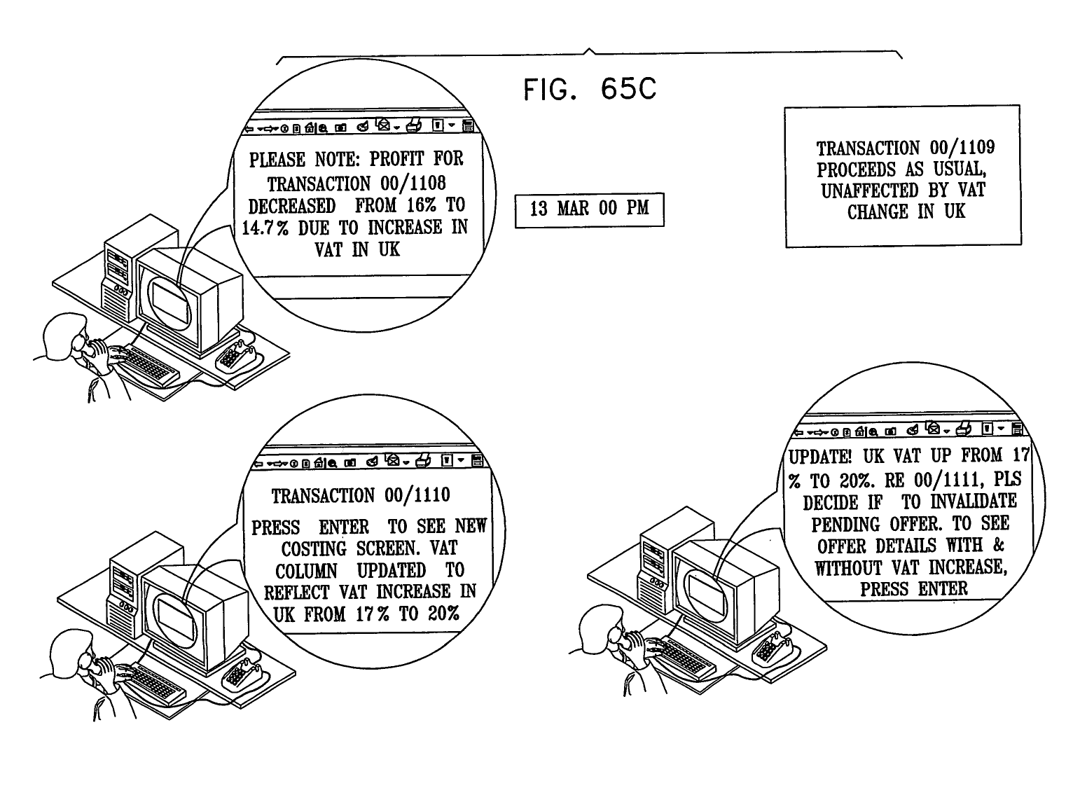

FIG. 65A is a pictorial illustration of four transactions stored in a computerized trading system constructed and operative in accordance with a preferred embodiment of the present invention, the transactions being in various states of implementation. Three of the four transactions involve trade incoming to the United Kingdom. As shown, transactions 00/1108 and 00/1109 are in the implementation stage, i.e. they are already agreed upon and are in the process of being fulfilled. Transaction 00/1110 is still in the offer-construction stage. For transaction 00/1111, an offer has been constructed and presented to client, but has not yet been accepted. More generally, transactions normally proceed through system-defined stages, e.g. the following:

a. transaction initiation (by trader or potential client) as in 00/1110;

b. offer construction;

c. offer presentation, culminating in client approval (or unsuccessful termination); and

d. implementation (transaction in process), culminating in successful termination.

FIG. 65B is a pictorial illustration of an event, affecting three of the four transactions in FIG. 65A In the illustrated embodiment, the event is an increase in VAT in the United Kingdom. This can be expected to affect all transactions that involve entry into the United Kingdom. Preferably, a trading house executive inputs the information defining the increase in the UK VAT parameter into the system and the system automatically identifies and processes all affected transactions, using predefined business logic.

FIG. 65C is a pictorial illustration showing the effect of the event of FIG. 65B on the transactions of FIG. 65A, as automatically implemented by the computerized trading system storing the transactions of FIG. 65A. As shown, the information affects three of the four transactions, however each transaction is typically affected differently because the statuses of each of the three transactions are different.

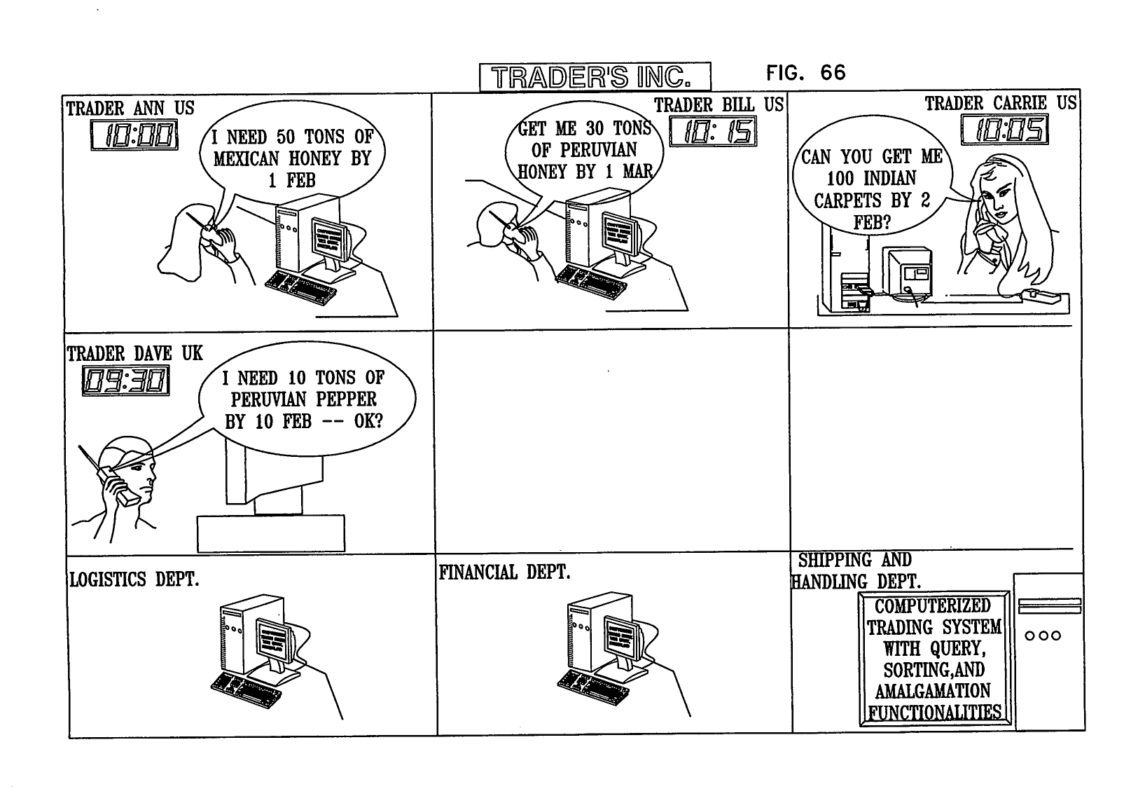

FIG. 66 is a pictorial illustration of traders and facilitative information providing departments, which may interact via a computerized trading system constructed and operative in accordance with a preferred embodiment of the present invention. In the illustrated embodiment, for simplicity, only four traders interact with only three information providing departments. Preferably, each information providing department has a queue of incoming queries which it processes. The queue may be resorted and/or amalgamated periodically, such as twice a day, or upon request by a management level operator.

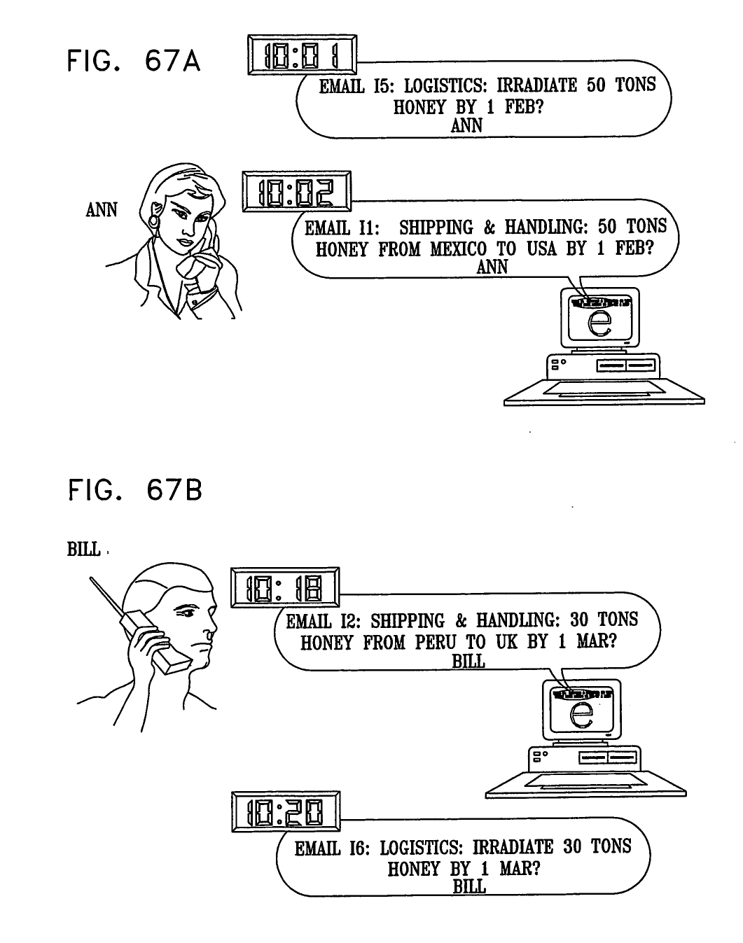

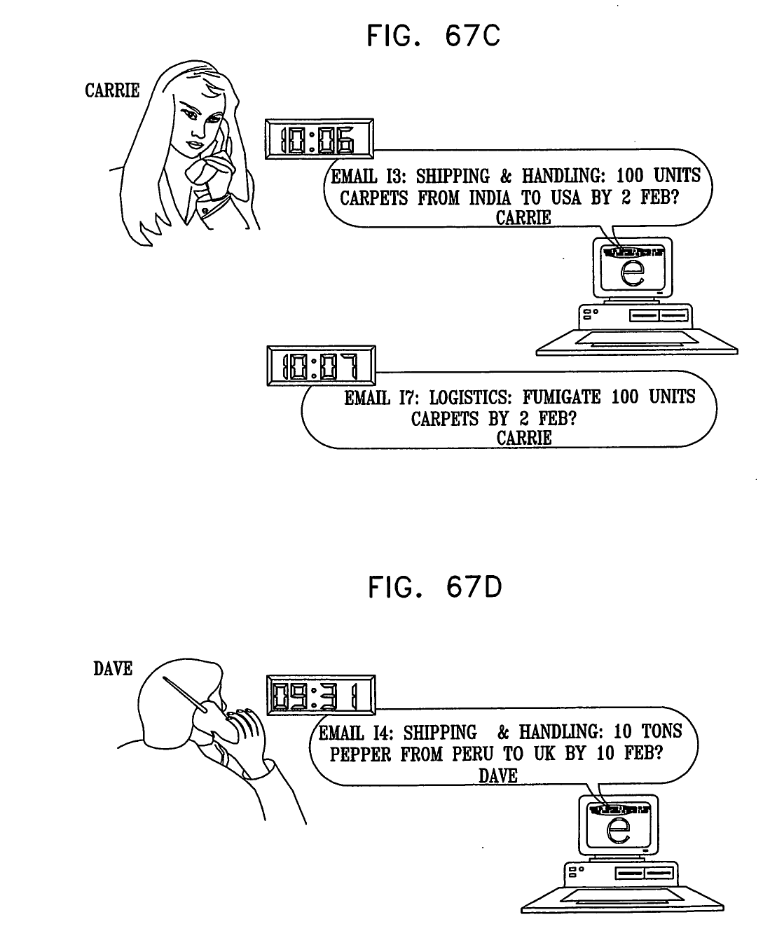

FIG. 67A is a pictorial illustration of email messages being generated by a first trader, Ann, in FIG. 66. FIG. 67B is a pictorial illustration of email messages being generated by a second trader, Bill, in FIG. 66. FIG. 67C is a pictorial illustration of email messages being generated by a third trader, Carrie, in FIG. 66. FIG. 67D is a pictorial illustration of email messages being generated by a fourth trader, Dave, in FIG. 66. The traders have sent emails (queries) requesting information to the logistics department and to the shipping and handling department. It is appreciated that some of the queries have common features and therefore are preferably grouped. For example, two queries (I5 and I6) pertain to irradiation of honey. Also, two queries (I4 and I2) pertain to shipping from Peru to UK.

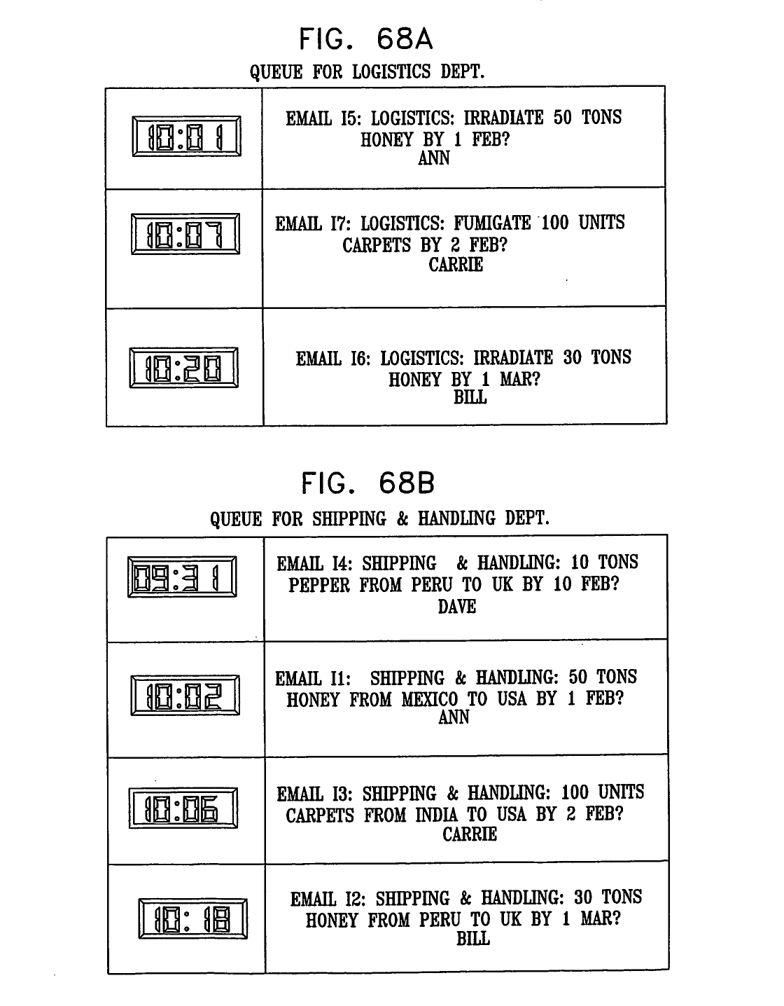

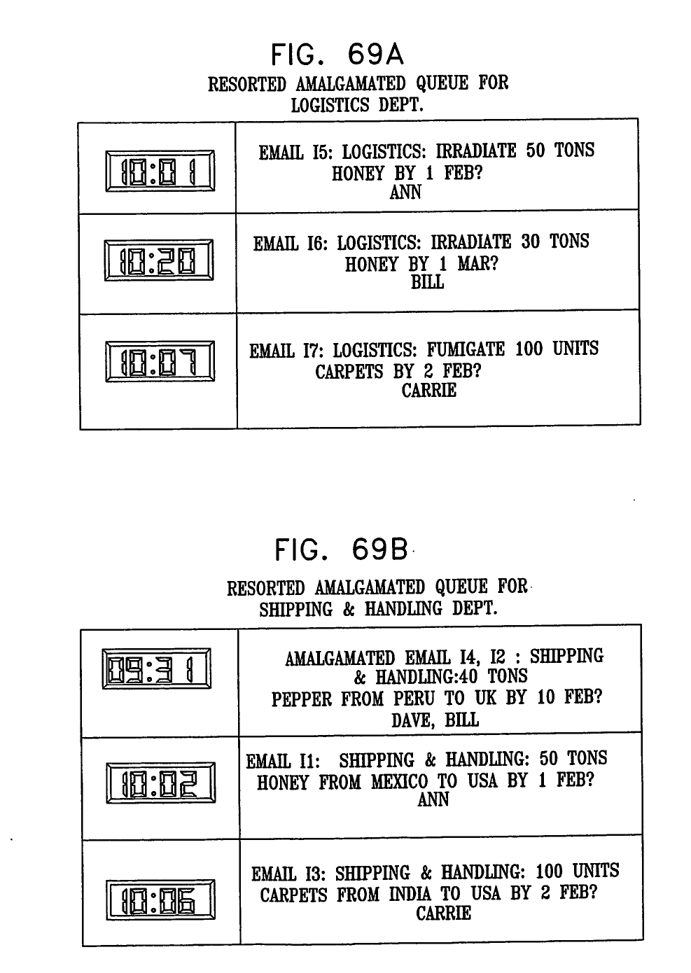

FIG. 68A is a pictorial illustration of a computerized email queue generated from those email messages in FIGS. 67A-67D which are addressed to the logistics department in FIG. 66. FIG. 69A is a pictorial illustration of the computerized email queue of FIG. 68A, resorted and amalgamated. It is appreciated that the two queries pertaining to irradiation of honey have been grouped together.

FIG. 68B is a pictorial illustration of a computerized email queue generated from those email messages in FIGS. 67A-67D which are addressed to the shipping and handling department in FIG. 66. FIG. 69B is a pictorial illustration of the computerized email queue of FIG. 68B, resorted and amalgamated. It is appreciated that the two queries pertaining to shipping from Peru to UK have been amalgamated.

The following are examples of email exchanges that may be facilitated by the system of the present invention.

In email exchange No. 1, John uses the Pricing Chain to compute an offer of Chinese Beans for Sarah. Once he finishes the computations he puts together an Offer and sends it out by email. The Pricing Chain computation ensures that John is quoting a price which promises a good profit.

Email exchange No. 1:

email I from JLewis@traderco.co.uk on 30/04/2002 09:52:56:

“To: <Sarah@thefoods.com>

Subject: Chinese Beans

Dear Sarah, Further to our brief conversation last week, we are still able to offer 3 FCLs (about 60 MT) of Chinese Beans at USD 685.00/MT for May/June shipment. The price is subject to our final confirmation and is to be understood per metric ton net, CIF Felixstow. Prices are in a general upward trend, so we will not be able to hold this offer for much longer. Please return to us as soon as possible with your position on this matter. We thank you in advance for your time and reply. Best Regards, John”

email II from Sarah 30/04/02 10:04:26

“John, Thank you for the offer but I am not in a position to confirm at such high levels. Thanks, Sarah”

email III from John:

“Sarah, Many thanks for your prompt reply. I understand your position, however, please note that prices are continuing to go up and deals are being concluded at these levels. In any case, the offer will remain valid for a few more hours until the Chinese go home, so should you change your mind please contact me as soon as possible this afternoon. If you want, you can give me a firm bid and I will try my best to get the goods, but I cannot guarantee too much improvement on the current price with the market the way it is today. Best Regards, John”

In email exchange No. 2, Tom looks in his message queue and sees that he has an offer, which came from India, for refined glycerin. At first, he does not recall the conversation he had with Lisbeth the previous week and that she was looking for glycerin, so he goes into the PCTB and asks for a system recommendation. From there he gets the idea of offering the goods to Lisbeth, and he also recalls his last talk with Lisbeth. He opens up the Pricing Chain and computes an offer, which he sends her by email.

Email Exchange No. 2:

email I from TDaniel@tradeco.com:

“Dear Lisbeth, We currently have some Indian Refined Glycerin 99% purity—vegetable and Kosher grade on offer, please tell me if you are interested in any quantities for February shipments? Best Regards, Tom”

email II from Lisbeth@manindustries.com:

“Hello Tom, What is your price idea DDP Felixstowe? Lisbeth”

email III from Tom:

“Hi Lisbeth, The price as it now stands is 2 FCL at USD 895.00/MT DDP Felixstowe for February shipment and payment is cash against documents. All prices subject to our final confirmation. I await your feedback, as we are interested in pursuing this opportunity further. Thanks, Tom”

email IV from Lisbeth:

“Well, Tom—at that price I prefer to buy Malaysian material, even though prices are also high there now—but still more competitive than the European—and though Indian glycerin is a fine quality, we have not used it in our production, so we are not going to switch to a new source at this stage, especially at these price levels. Lisbeth”

email V from Tom:

“Lisbeth, I very much understand your position and I appreciate your feedback. Many thanks, Tom”

In email exchange No. 3, Elise has 70.00/MT of glycerin in her warehouse which she wants to sell. The PCTB recommends that she offer it to David. Using the Pricing Chain she computes the best offer, taking into account all her costs and ensuring a good profit.

Email Exchange No. 3:

email I from Elise@soapworld.com 26/01/01 16:41:14

“David, Further to our chat on the phone earlier today, I can offer about 70 MT of Turkish origin glycerin (98% purity—non Kosher material) at US $1,075.00/mt FOB Mersin, Turkey. Firm until Monday end of your day. Good luck with your customer and have a good weekend. Elise”

In email exchange No. 4, Michael checks his Stock Management module and realizes that he soon needs to replenish his glycerin stock levels. Since over the past few weeks he has been seeing the offers and requests coming in through the system indicating rising prices, Michael is determined to buy some goods before prices go up further. Therefore, he puts together a Request for Ken to supply the required glycerin based on a firm bid, so if accepted a transaction will follow.

Email Exchange No. 4:

email I from Michael@universetrade.com:

“Dear Ken, Many thanks for your call this morning. I had a word with Nick and we are interested in a serious Turkish glycerin offer. Therefore, we can give you the following firm bid:

Product: Turkish Refined Glycerin (min. 99.5%)

Grade: Vegetable and Kosher Certified

Quantity: About 70 MT

Price: USD 790.00/MT FOB Turkish Port

Shipment: Prompt

Packaging: 290 kg Drums

Payment: Cash Against Documents

We look forward to receiving your position on the above—Michael.

In email exchange No. 5, Claire wants to send an Offer to a customer in Belgium, based on a recommendation she received from the PCTB. In fact, she barely does business with this company and had it not been for the PCTB recommendation, she would have not remembered that customer. Since she has not done any significant business with them, she has no shipping rates from Mexico to Belgium. Jack receives a notification of the request in his queue, but the priority is not a high one because the system correctly rates the other business more important. In any case, Claire is pressing Jack to get her the shipping rate so she can send the Offer out as soon as possible.

Email Exchange No. 5:

email I from Claire@yourhoney.com:

“Jack, Further to our conversation this morning, I really need an updated shipping charge for the Mexican honey coming from Yucatan Farms (USD 950.00/MT) to Antwerp. I know it is a rather low priority compared to the other items in the queue, but my customer needs an offer this afternoon. I would appreciate your prompt attention and I will owe you a drink if you have it jump the queue! See you in the pub, Claire”

email II from Jack@yourhoney.com:

“Hi Claire, the shipping charge on International Shipping Lines is USD 45.00/MT to Antwerp. They are the most competitive I have found. I hope you get the business and you owe me a drink! Jack.”

In email exchange No. 6, Donald, a shipping clerk in the trading company, receives a request for a shipping rate in his queue. He contacts Jan, who is a shipping broker, to get the relevant rate. Upon receiving the relevant rate, Donald replies to the message in his queue by incorporating the rate, which is then available to the trader to use in the Pricing Chain. Ultimately, the trader will be able to make an Offer to the customer.

Email Exchange No. 6:

email I from Donald@intercommerce.com:

“Dear Jan, We have to ship 100 MT of Mexican honey, in 300 kg drums, from Veracruz to UK Mainport and then deliver it to our warehouse in Duckshire. We need to ship all 5 FCLS (about 20 MT each—and 66 drums) next month. Your prompt reply is very much appreciated. Best Regards, Don.

email II from Jan@shipbrokers.com:

“Dear Don, We can ship all 5 FCLs as per your request next month at USD 55.00/MT. The goods would arrive in Thamesport in first-half of May. I will come back to you with the haulage charge to Duckshire. Take care, Jan.

Particular advantages of preferred embodiments of the trading system shown and described herein may be appreciated by comparing the following example trading scenarios:

### EXAMPLE 1A

### Trading Scenario Using Only Conventional Software to Facilitate Trading

Rogue trader hides a losing position comprising a transaction that resulted in stock that is now, at current market prices, worth less than what the stock was bought for. For example, the rogue trader may have bought a large quantity of honey at a high price and the prices have since fallen. The trader has no customers for the honey at present that will pay the price he wants, but he needs to avoid a loss. The trader would like the price to come up again so he can sell without a loss. Prices keep falling and the trader faces more losses. Management finds out about the above situation only after the trader has left the company for another job. Management assesses the situation and decides to sell the position in order to avoid more losses.

### EXAMPLE IB

### Trading Scenario Using a Preferred Embodiment of the Present Invention

A trader has honey in stock bought at prices higher than market price. In accordance with a preferred embodiment of the present invention, management views, such as a position sheet view, are provided such that management is aware of the position from the system. Therefore, Management instructs trader to sell the position and to cut losses before market prices may fall further. Management may also put a constraint on the trader, via the system, not to buy more honey until the old stock has been sold. The trader can only sell old stock. Management holds a meeting with the trader. Together, they query the system, asking the system to evaluate sell options for the old stock. The system (PCTB) generates 20 recommendations. The trader succeeds in selling the old stock to 5 customers. Management is satisfied that losses have been arrested. The trader is relieved and is not under pressure to hide the position. Management can now remove the constraint on the trader so he can buy new stock once again.

### EXAMPLE 2A

### Trading Scenario Using Only Conventional Software to Facilitate Trading

A trader gets a message from Buyer Y requesting 20 Metric Tons (MT) of honey from Mexico. The trader wonders: from whom can Y buy and at what price? The trader rummages inefficiently through papers, emails, faxes, and Microsoft Excel spreadsheets, trying to find suitable suppliers for honey. The trader calls, emails, and faxes around to supplier companies to try to find honey. Prices, responses, etc. are widely varied and trader has a hard time identifying the best offer. The trader selects 5 suppliers, sends out requests, receives 3 replies and closes a deal with one. The trader approximates the cost price to Y of 20 MT honey just bought. The trader wants to maximize profit. He asks the shipping and handling department for a shipping price. The shipping clerk gets a request, talks to 3 shipping companies and comes back with a price 5% cheaper.

### EXAMPLE 2B

### Trading Scenario Using a Preferred Embodiment of the Present Invention

A trader gets a message from Buyer Y requesting 20 MT of honey from Mexico. The trader asks himself: from whom can Y buy and at what price? The system shows the trader a computation based on history and parameters such as past price, and number of transactions. The trader receives 10 recommendations from the system, selects 5, and sends out requests. The trader receives 3 replies and closes a deal with one. The trader computes cost price to Y of 20 MT honey just bought. The trader wants to maximize profit. He asks the system for a shipping price. The system displays the currently stored price, but also (because the pricing chain has a Shipment&Handling processor with a data expiration setting attached) sends an inquiry to the shipping and handling (S&H) department for an updated price. The shipping clerk gets the request, talks to 3 shipping providers and comes back with a price 5% cheaper. The system automatically updates the pricing chain to reflect this, and automatically stores the new cheaper price in the price information cache. The trader is able to make more profit and the buyer is relieved to receive the goods on time.

### EXAMPLE 3A

### Trading Scenario Using Only Conventional Software to Facilitate Trading

A clerk gets an inquiry from a trader about a shipping rate. The clerk calls around, finds rates and informs the trader, taking 2 days to respond. Two days later, the clerk gets an inquiry from a different trader about a shipping rate. The clerk calls around, finds rates, and informs the trader, taking 3 days to respond. One day later, the clerk gets an inquiry from a different trader about a shipping rate. The clerk starts calling around but gets distracted and doesn't respond to the trader in time for the trader to make a deal. The three requested rates were in fact for similar routes, but the clerk did not notice or did not succeed in organizing the information s/he had already assembled for computation of the first rate, in order to compute the second or third rates. Therefore, the clerk is burdened with many telephone calls. The traders are not happy because they do not obtain a quick reply, and sometimes fail to close the deal on time. Management is not happy because a deal was dropped.

### EXAMPLE 3B

### Trading Scenario Using a Preferred Embodiment of the Present Invention

A clerk gets 3 inquiries, within a few days, from 3 different traders for shipping rates (because each of these traders created or used existing pricing chains that contained processors related to shipping rates, and further because these processors were controlled by the data expiration handler). The three requested rates are for similar routes. A shipping and handling clerk determines the rate for the first inquiry and inputs the rate into the system. For the second and third inquiries, the system provides stored rates directly to the trader without bothering the shipping clerk. The shipping clerk has an easier time. The trader is happy because he obtains quick replies and can close deals on time. The buyer is happy to obtain a favorable and quick response from the trader. The trading company benefits from a new deal.

It is appreciated that the software components of the present invention may, if desired, be implemented in ROM (read-only memory) form. The software components may, generally, be implemented in hardware, if desired, using conventional techniques.

It is appreciated that various features of the invention, which are, for clarity, described in the contexts of separate embodiments, may also be provided in combination in a single embodiment. Conversely, various features of the invention, which are, for brevity, described in the context of a single embodiment, may also be provided separately or in any suitable subcombination.

It will be appreciated by persons skilled in the art that the present invention is not limited to what has been particularly shown and described hereinabove. Rather, the scope of the present invention is defined only by the claims that follow:

1. A computerized trading system comprising:
a price information cache including a multiplicity of price information items originating from more than one transaction queries posed by more than one trader from among a population of traders, each of said price information items having a cached life cycle; and
a trading query processor operative to receive trading queries from said population of traders and to employ said price information cache in responding thereto.

2. A computerized trading system according to claim 1 and wherein said trading query processor is operative to send subqueries which relate to price information items not available in the price information cache.

3. A computerized trading system according to claim 1 wherein said cached life cycle includes an indication of time-points defining at least one time periods.

4. A computerized trading system according to claim 3 wherein said cached life cycle includes an indication of time-points defining a plurality of time periods.

5. A computerized trading system comprising:
a price information cache including a multiplicity of price information items originating from more than one transaction queries posed by more than one trader from among a population of traders; and
a trading query processor operative to receive trading queries from said population of traders and to process said trading queries not necessarily in FIFO order in order to enhance the efficiency of responding thereto.

6. A computerized trading system according to claim 5 wherein similar trading queries are grouped together.

7. A computerized trading system according to claim 5 wherein said trading queries include at least one query to a human-operated workstation.

8. A computerized trading system according to claim 5 wherein said trading queries include at least one query to an automatic computer-based information provider.

9. A computerized trading system comprising:
a shared price information cache subsystem including a multiplicity of price information items originating from more than one transaction queries posed by more than one trader from among a population of competing traders; and
a shared price information updating subsystem operative to update said shared price information cache subsystem based on information received in the context of a query and similarities between that query and other queries.

10. A computerized trading system comprising:
a price information cache including a multiplicity of price information items originating from more than one transaction queries posed by more than one trader from among a population of traders; and
a trading query processor operative to receive trading queries from said population of traders and to employ said price information cache in responding thereto, said trading query processor employing inquiry templates built on earlier inquiries and information received in response thereto.

11. A computerized trading system according to claim 10 and wherein the templates are selected based on similarities between inquiry templates built on earlier inquiries and a current inquiry.

12. A computerized trading system according to claim 11 wherein templates are displayed in an order depending on extent of similarity to a current inquiry.

13. A computerized trading system according to claim 10 wherein said trading query processor is operative to identify in said inquiry templates built on earlier inquiries, information irrelevant to the current inquiry, to generate a reproduction of the inquiry template and to delete therefrom said information.

14. A computerized transaction analysis method comprising:
accessing at least one relevant previous transaction, wherein relevance is a function of at least one user-defined parameter defining a proposed transaction;
analyzing at least one parameter of the at least one relevant previous transaction, said at least one parameter being selected to match the at least one user-defined parameter; and
generating at least one recommendations for the proposed transaction including an evaluation of the suitability of each of the at least one recommendations in view of at least one user-defined parameter.

15. A computerized transaction analysis method according to claim 14 wherein said step of generating comprises generating at least one recommendation by combining a plurality of relevant previous transactions.

16. A computerized transaction analysis method according to claim 14 wherein said step of generating comprises adjusting for at least one parameter external to all relevant previous transactions under consideration.

17. A computerized trading system according to claim 1 wherein at least one cached life cycle includes:
a cached time period in which an associated price information item is valid;
a cached time period in which an associated price information is invalid; and
a cached time period in which an associated price information may be valid and may not be valid.

18. A computerized trading system comprising:
a price information cache including a multiplicity of price information items originating from more than one transaction queries posed by more than one trader from among a population of traders, each of said price information items having a cached life cycle; and
a trading query processor operative to receive trading queries from the population of traders including accessing the price information cache to respond as fully as possible to each trading query and sending out subqueries which relate to price information items not present in the price information cache.

19. A computerized trading system comprising:
a price information cache including a multiplicity of price information items originating from more than one transaction queries posed by more than one trader from among a population of traders; and
a trading query processor operative to receive a sequence of trading queries from said population of traders and to amalgamate at least one pair of queries from among said sequence of trading queries in order to enhance the efficiency of responding thereto.

20. A computerized trading method comprising:
providing a price information cache including a multiplicity of price information items originating from more than one transaction queries posed by more than one trader from among a population of traders, each of said price information items having a cached life cycle;
receiving trading queries from said population of traders; and
employing said price information cache in responding to said trading queries received.

21. A computerized trading method comprising:
providing a price information cache including a multiplicity of price information items originating from more than one transaction queries posed by more than one trader from among a population of traders;
receiving trading queries from said population of traders; and
processing said trading queries received not necessarily in FIFO order in order to enhance the efficiency of responding thereto.

22. A computerized trading method comprising:
providing a shared price information cache subsystem including a multiplicity of price information items originating from more than one transaction queries posed by more than one trader from among a population of competing traders; and
updating said shared price information cache subsystem based on information received in the context of a query and similarities between that query and other queries.

23. A computerized trading method comprising:
providing a price information cache including a multiplicity of price information items originating from more than one transaction queries posed by more than one trader from among a population of traders;
receiving trading queries from said population of traders;
employing said price information cache in responding to said trading queries received; and
employing inquiry templates built on earlier inquiries and information received in response to said trading queries received.

24. A computerized transaction analysis system comprising:
a processor operative to access at least one relevant previous transaction, wherein relevance is a function of at least one user-defined parameter defining a proposed transaction; and
a transaction analyzer operative to analyze at least one parameter of the at least one relevant previous transaction, said at least one parameter being selected to match the at least one user-defined parameter and to generate at least one recommendations for the proposed transaction including an evaluation of the suitability of each of the at least one recommendations in view of at least one user-defined parameter.

25. A computerized trading method comprising:
providing a price information cache including a multiplicity of price information items originating from more than one transaction queries posed by more than one trader from among a population of traders, each of said price information items having a cached life cycle;
receiving trading queries from the population of traders;
accessing the price information cache to respond as fully as possible to each trading query; and
sending out subqueries which relate to price information items not present in the price information cache.

26. A computerized trading method comprising:
providing a price information cache including a multiplicity of price information items originating from more than one transaction queries posed by more than one trader from among a population of traders;
receiving a sequence of trading queries from said population of traders; and
amalgamating at least one pair of queries from among said sequence of trading queries in order to enhance the efficiency of responding thereto.
